(19) United States
(12) Patent Application Publication
(10) Pub. No.: US 2024/0303524 A1
(43) Pub. Date: Sep. 12, 2024

(54) Opposite Anharmonicity Coupler For Gates In Quantum Computers

(71) Applicants: The Trustees of Princeton University, Princeton, NJ (US); SOCPRA Sciences et Génie S.E.C., Sherbrooke (CA)

(72) Inventors: Andrew Houck, Princeton, NJ (US); Pranav Mundada, Princeton, NJ (US); Andrei Vrajitoarea, Chicago, IL (US); Sara Sussman, Princeton, NJ (US); Alexandre Blais, Sherbrooke (CA); Tudur-Alexandru Petrescu, Sherbrooke (CA); Catherine Leroux, Sainte-Julie (CA); Agustin Di Paolo, Cambridge, MA (US); Camille Le Calonnec, Saint-Cast-le-Guildo (FR); Charles Guinn, Princeton, NJ (US)

(21) Appl. No.: 18/551,114

(22) PCT Filed: Mar. 16, 2022
(86) PCT No.: PCT/US2022/020554

§ 371 Date: Sep. 18, 2023

Related U.S. Application Data
(60) Provisional application No. 63/162,961, filed on Mar. 18, 2021.

(51) Int. Cl. G06N 10/40

(52) U.S. Cl. CPC G06N 10/40

(57) ABSTRACT

Disclosed herein are methods, systems, and devices including a tunable coupler design that harnesses interference due to higher energy levels to achieve zero static ZZ coupling between the two qubits. Biasing to zero ZZ interaction, a fast perfect entangler is realized with parametric flux modulation in less than 20 ns. The disclosed coupler provides very fast gates between far-detuned fixed frequency qubits, and is a crucial building block in scaled quantum computers.

### CROSS-REFERENCE TO RELATED APPLICATIONS

This application claims priority to U.S. Patent Application No. 63/162,961 filed Mar. 18, 2021, which is hereby incorporated by reference for any and all purposes.

### GOVERNMENT RIGHTS

This invention was made with government support under Grant Nos. W911NF-19-1-0016 and W911NF-18-1-0411 awarded by the U.S. Army/Army Research Office, Grant No. CCF-1730082 awarded by the National Science Foundation, and Grant No. DE-SC0012704 awarded by the Department of Energy. The government has certain rights in the invention.

### BACKGROUND

The ability to perform fast, high-fidelity entangling gates is an important requirement for a viable quantum processor. In practice, achieving fast gates often comes with the penalty of strong-drive effects that are not captured by the rotating-wave approximation. These effects can be analyzed in simulations of the gate protocol, but those are computationally costly and often hide the physics at play.

With considerable advances in state preparation, gate operation, measurement fidelity, and coherence time, superconducting qubits have become one of the leading platforms for quantum information processing [1-3]. Systems consisting of up to a few dozen qubits have been recently deployed by a number of research groups [4-6]. As these architectures are scaled up, an important challenge is to engineer two-qubit interactions to realize gates that are fast enough compared to the decoherence times of the qubits, while at the same time obtaining operation fidelities that are sufficiently high to satisfy a threshold for quantum error correction [7, 8]. To realize fast and high-fidelity two-qubit gates, precise modeling of the dynamics of small multi-qubit systems is necessary, but becomes computationally difficult as the number of degrees of freedom increases. Moreover, to achieve fast gates, drives that are strong in the sense of the rotating-wave approximation (RWA) are necessary, in which case beyond-RWA corrections become important.

A dominant source of infidelity in gate operation includes of cross-Kerr interactions, or the ZZ terms in Pauli matrix notation. These terms are either static due to the connectivity of qubits, or dynamically generated by control drives. In the case of many two- and single-qubit gates, ZZ terms produce spurious entanglement that cannot be mitigated by local single-qubit operations. There are some experimental efforts to reduce the effect of ZZ interactions [9-14], but improvement is needed to reduce the effects of these interactions, as presence of nonlocal ZZ interactions, and of higher-order cross-Kerr terms, can indicate the onset of quantum chaotic behavior in systems of many coupled qubits [15].

### SUMMARY

Described herein are methods, devices, and systems for quantum computing, and coupling qubits. The present disclosure relates to improvements in quantum computing, and couplers for gates used in quantum computing.

An example apparatus may comprise at least two qubit structures for storing quantum states, and a coupler having opposite anharmonicity to the at least two qubit structures and configured to couple the at least two qubit structures.

An example method may comprise tuning, by applying a flux bias, a coupler to suppress ZZ crosstalk between at least two qubit structures. The coupler may have opposite anharmonicity to the at least two qubit structures and is configured to couple the least two qubit structures. The method may comprise varying in time an external flux applied to the tuned coupler to cause gate operations based on quantum entanglement between the at least two qubit structures.

An example apparatus comprises a coupler having opposite anharmonicity to couple two qubits. An example system comprises a quantum processor comprising a first transmon and a second transmon having an opposite anharmonicity; and a flux qubit coupling the first transmon and the second transmon. An example method comprises coupling two qubits having opposite anharmonicity using a coupler comprising four shunting Josephson junctions.

In embodiments, systems, methods, and apparatuses define anharmonicity as a difference between an energy difference of the 0 and 1 states and an energy difference of the 1 and 2 states (e.g., 0, 1, and 2 being successive states, such as energy levels, with 0 being the lowest state, followed by the 1 state and then the 2 state). The coupler can enable two qubit gates between two qubits. In other embodiments, the coupler enables gates between qubits that are far detuned in frequency while suppressing unwanted crosstalk. The qubits can have fixed frequencies, and some embodiments further comprise a readout cavity and qubits to maximize coherence and minimize state preparation and measurement errors.

In various systems, methods, and apparatuses, each transmon can be a fixed frequency transmon detuned by about 2 GHz from the other transmon. The flux qubit can comprise four shunting Josephson junctions, and can suppress crosstalk by varying DC flux bias.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1A illustrates a graphical representation of a model coupler, in accordance with aspects of the present disclosure. The three bare modes have mutual capacitive couplings (i.e., light gray edges), and mode c is parametrically driven.

FIG. 1B illustrates a superconducting circuit implementation. Modes a and b are transmon qubits, and the coupler mode c is implemented as a generalized capacitively shunted flux qubit.

FIG. 2A illustrates a static cross-Kerr interaction χ_{ab} (ω_{c}), from first (black) and second-order RWA (blue), and from the full diagonalization of Sec. V Floquet Numerics) (light blue points) for: ωₐ/2π=4.0, ω_{b}/2π=5.5, αₐ/2π=−0.3, α_{b}/2π=−0.2, α_{c}/2π=0.25, g_{ab}/2π=0.12, g_{bc}/2n=−0.12, all in GHz, and g_{ca}/2π=0.

FIG. 2B illustrates an analogue of FIG. 2A for dynamical cross-Kerr interaction at δ/2π=0.3 GHz.

FIG. 2C illustrates the same as FIG. 2B for the gate interaction rate J_{ab}(ω_{c}). Inset: J_{ab}(δ) at ω_{c}/2π=4.25 GHz.

FIG. 3 illustrates coupling constants in the effective Hamiltonian for the full circuit as a function of external DC flux φ̅ₑₓₜ. Dots (lines) represent Floquet two-tone spectroscopy data with Hilbert space dimension 10 per mode (second-order RWA calculations). Color (see legend) encodes parametric drive amplitude δ_{φ}/2π. Parameter choices: Cₐ=134.205 fF, C_{b}=134.218 fF, C_{c}=75.987 fF, C_{ac}=11.11 fF, C_{bc}=11.22 fF, C_{ab}=0, E_{Ja}/2π=37 GHz, E_{Jb}/2π=27 GHz, E_{Jc}/2π=50 GHz, α=0.258, β=1, and N=3. Large discontinuities in the numerical curves can be attributed to state tracking errors near avoided crossings (see Sec. Floquet Numerics).

FIG. 4 illustrates quasienergies of the Floquet modes with maximum overlap with eigenstates |0ₐ1_{b}0 [symbol] and |1ₐ0_{b}0_{c} [symbol] , for the toy model. The light and dark blue dashed lines correspond to the eigenenergies of the uncoupled system. The inset shows the population of the Floquet states, Pₙ_{ₐ}ₙ_{_{b}}ₙ_{_{c}}(t)=|_{F} [symbol] nₐn_{b}n_{c}|ψ(t) [symbol] |², compared to the state populations of a two-level system (dots), driven resonantly with Rabi rate J_{ab}, where J_{ab} is the gate amplitude obtained from the avoided crossing in the Floquet spectrum.

FIG. 5A illustrates static χ_{ab} interaction at δ=0 for the toy model versus the coupler frequency for different values of the coupler anharmonicities, with remaining parameters ωₐ/2π=4.0, ω_{b}/2π=5.75, αₐ/2π=α_{b}/2π=−0.02, and g_{ac}/2π=−g_{bc}/2π=0.05 GHz.

FIG. 5B illustrates dynamical χ_{ab} versus bare coupler frequency for the parameters above and α_{c}/2π=0.12 GHz, for different values of the drive amplitude.

FIG. 5C illustrates gate amplitude J_{ab} for the parameters in FIG. 5B. The Hilbert space dimension for each mode is 5.

FIG. 6A illustrates gate amplitude J_{ab}.

FIG. 6B illustrates cross-Kerr χ_{ab} for different parameteric drive amplitudes δφ (encoded in curve color) and as a function of the static flux φ̅ₑₓₜ from Floquet simulations. Data has been excluded where deficient state-tracking in the vicinity of avoided crossings led to unphysical discontinuities in the quantities.

FIG. 6C illustrates for regions I, II, and III identified in panels 6A and 6B, wherein the common parameter φ̅ₑₓₜ and plot J_{ab}(χ_{ab}) are eliminated. This allows for identification of regimes in which the \sqrt{iSWAP} gate interaction can be turned on, while maintaining a vanishing dynamical χ_{ab}.

FIG. 7 illustrates a two-tone spectroscopy data from Floquet numerics. Each point corresponds to a possible transition and its size is weighed by the matrix element of the charge operator of bare qubit a, \hat{X}=\hat{n}ₐ. Parameters chosen as in FIG. 3 with δφ/2π=0.0 (black dots) and 0.03 (crosses). The subscripts α, β sweep over the subset of Floquet modes {|000 [symbol] _{F},|100 [symbol] _{F}, |010 [symbol] _{F}, |001 [symbol] _{F}}, whereas the drive photon number k takes integer values between −15 and 15.

FIG. 8 illustrates a circuit schematic and notations used in the derivation of the circuit Lagrangian in Additional Section B. The coupler consists of two branches of total capacitances C_{α} and C_{β} (not indicated in the figure). The α branch consists of a single Josephson junction, while the ‘β’ branch N junctions in series. The bare coupler and transmon modes are connected capacitively through coupling capacitances C_{ab,bc,ca}.

FIG. 9 illustrates a Floquet spectrum for a rotating-wave approximation Hamiltonian in which all photon-number nonconserving terms have been removed from the full circuit Hamiltonian analyzed herein. This figure is to be compared to the analogous result for the full Hamiltonian in FIG. 7.

FIG. 10 illustrates a fourth-order perturbation and an error schematic.

FIG. 11 illustrates a schematic of progress in crosstalk suppression through interference.

FIG. 12 illustrates a schematic of a tunable coupler with positive anharmonicity for far-detuned qubits.

FIG. 13 illustrates two-tone spectroscopy of Device 0 in accordance with embodiments of the present disclosure.

FIG. 14 illustrates a ZZ crosstalk measurement graph of Device 0.

FIG. 15 illustrates parametrically driven SWAP-like oscillations implemented on Device 0 in accordance with embodiments of the present disclosure.

FIG. 16 illustrates an 18 ns perfect entangler implemented on Device 0 in accordance with embodiments of the present disclosure.

FIG. 17 illustrates crosstalk suppression via coupler levels.

FIG. 18 illustrates a list of the most accessible gate Hamiltonians realizable with a parametric drive in the analyzed architecture.

FIGS. 19A-C illustrate examples of a Cartan coordinate gate trajectory of a perfect entangler implemented on Device 0.

FIG. 20 illustrates an example device energy spectrum in accordance with embodiments of the present disclosure.

FIG. 21 illustrates another example device spectrum in accordance with embodiments of the present disclosure.

FIG. 22 illustrates a ZZ coupling corresponding to the device spectrum of FIG. 21.

FIGS. 23A-B illustrate floquet simulations in accordance with embodiments of the present disclosure.

FIG. 24 illustrates an example device update for Device 1, in accordance with embodiments of the present disclosure.

FIG. 25 illustrates graphical schematics of a coupler frequency and difference for spectrally equivalent couplers, in accordance with embodiments of the present disclosure.

FIGS. 26A-B illustrate changing NJ, in accordance with embodiments of the present disclosure.

FIGS. 27A-B illustrate a device design that is more robust to fabrication intolerance, in accordance with embodiments of the present disclosure.

FIG. 28 illustrates a GFQ spectrum in accordance with embodiments of the present disclosure.

FIG. 29 illustrates a difference in first level with NJ=3, in accordance with embodiments of the present disclosure.

FIG. 30 illustrates the results of multiple junctions, in accordance with FIG. 29.

FIG. 31 illustrates an ideal device spectrum, a device spectrum near half flux, and a ZZ coupling for the ideal device spectrum.

FIGS. 32A-B illustrate a Device 1 device spectrum (32A) and ZZ coupling (32B), in accordance with embodiments of the present disclosure.

FIGS. 33A-B illustrate coherence and flux for Device 1 in accordance with embodiments of the present disclosure.

FIGS. 34A-B illustrate a Device 2 device spectrum (34A) and ZZ coupling (34B), in accordance with embodiments of the present disclosure.

FIG. 35A illustrates a ZZ coupling vs. flux graph for Device 2, in accordance with embodiments of the present disclosure.

FIG. 35B illustrates the corresponding qubit, Q1, Q2, data for Device 2 to FIG. 35A.

FIGS. 36A-B show goals, challenges, and Floquet theory details.

FIGS. 37A-G show graphs and other information illustrating application of Floquet theory to the present disclosure.

FIG. 38 shows details of an example toy model: Kerr Non-linear oscillators.

FIGS. 39A-E show details of the example toy model.

FIG. 40 shows details of a full device model.

FIG. 41 shows graphs associated to the full device model.

FIG. 42 shows details of Floquet theory and spectroscopy.

FIGS. 43A-G shows additional spectroscopy information.

FIGS. 44A-B illustrations additional spectroscopy information.

FIG. 45 shows graphs illustrating optical flux value based on a full device model with experimental parameters and without the rotating wave approximation.

FIGS. 46A-I illustrate spectator qubit effects.

FIG. 47 is a block diagram illustrating an example computing device.

### DETAILED DESCRIPTION OF ILLUSTRATIVE EMBODIMENTS

The present disclosure relates to an opposite anharmonicity coupler for gates in quantum computers. The disclosed systems, methods, devices, and components may be employed in quantum computers and is an improvement over existing couplers in quantum computers.

On-demand strong qubit-qubit interactions are crucial for the realization of a scalable quantum computer. Currently, the performance of high coherence transmons is limited by unwanted cross-Kerr or “ZZ” crosstalk. Using interference between two couplers has been previously shown to mitigate ZZ crosstalk. Disclosed herein is a tunable coupler design that harnesses interference due to the higher energy levels to achieve zero static ZZ coupling between the two qubits. Biasing to zero ZZ interaction, a fast perfect entangler is realized with parametric flux modulation in less than 20 ns. The disclosed coupler provides very fast gates between far-detuned fixed frequency qubits, and is a crucial building block in scaled quantum computers.

Present technologies require multiple coupling elements and close-frequency qubits to suppress crosstalk in two qubit gates. This leads to frequency crowding and reduces the yield of useful devices. Technology for suppressing crosstalk between tunable qubits exists but such tunable qubits have lower coherence times than fixed frequency qubits.

The disclosed architecture uses opposite sign anharmonicity components to couple two qubits. The disclosed solution works for far detuned fixed frequency qubits alleviating both the frequency crowding and coherence issues. Moreover, by systematic design one can achieve 13 ns (e.g., in a range from 10-20 ns, from 13-20 ns, from 13-18 ns, 10-18 ns) perfect entanglers which is more than 5-fold of speedup in such systems. The gate demonstrated is achieved by parametric driving of the magnetic field through the coupler loop, though other gates using this coupler will be possible.

More particularly, the disclosed approach provides a component for quantum computation, a coupler that has opposite anharmonicity from the qubits in the system. In this context, anharmonicity is defined as the difference between the energy difference of the 0 and 1 states and the energy difference of the 1 and 2 states.

The disclosed coupler enables two qubit gates between two qubits in the computer. Unlike most existing couplers, the disclosed coupler enables gates between qubits that are far detuned in frequency while suppressing unwanted crosstalk, supporting a fast perfect entangler while simultaneously suppressing unwanted crosstalk. This will enable many more qubit gates compared to traditional couplers, because it alleviates issues with spectral crowding.

Moreover, the coupler enables gates that are extremely fast. Gates that are less than 20 ns in duration have been demonstrated. This will increase the depth of circuits feasible in superconducting quantum processors, i.e., the number of gates that can be performed before the system is overwhelmed by errors, or “decoheres”.

This directly enhances the complexity of algorithms supported by the platform. It is expected that the family of gates natively available in this architecture will be expanded.

To implement the disclosed coupler, one fabricates the coupler and two qubits with fixed frequencies, as well as a readout cavity and other qubits to maximize coherence and minimize state preparation and measurement (SPAM) errors, and one designs a coupler with an anharmonicity opposite in sign to the anharmonicities of the qubits, with parameters that enable crosstalk suppression, which can occur if the coupler frequency is situated between two qubit frequencies. The properties of the circuit are verified via numerical simulation and experimental constructions.

While the gate fidelity could be limited due to leakage outside computational subspace, this can be overcome by optimal pulse shaping.

The architecture was modeled both analytically and numerically. A quantum processor was designed comprising two fixed frequency transmons detuned by about 2 GHz coupled by a generalized flux qubit with four shunting Josephson junctions. This device was fabricated by patterning Tantalum and Aluminum on Sapphire substrate. The crosstalk suppression was verified by varying the DC flux bias through the coupler. After biasing at the working point, one modulates the flux through the coupler at the qubit-qubit frequency detuning to achieve the entangling gate. It was demonstrated experimentally that an entangling gate can be achieved in less than 20 ns.

For entities employing couplers between qubits with the same anharmonicity as their qubits, the coupler disclosed herein would significantly enhance the speed of their gate operations enabling higher circuit depth, reduce spectral crowding issues which have posed a challenge for going beyond 65 qubits, and increase the yield of devices overall.

The invention provides a new component for quantum computation, a coupler that has opposite anharmonicity from the qubits in the system. In this context, anharmonicity is defined as the difference between the energy difference of the 0 and 1 states and the energy difference of the 1 and 2 states. Oppositive anharmonicity may include the coupler having an anharmonicity that has an opposite sign than an anharmonicity of the qubits of the system. For example, the coupler anharmonicity may be positive and the qubit anharmonicity may be negative (e.g., or vice versa). It should be understood that opposite anharmonicity may be a state of anharmonicity that applies to the conditions (or range of conditions) under which the device is operated. For example, different states of anharmonicity may be achieved with the same device if specific conditions are applied that are outside of typical operation of the disclosed device.

Embodiments can include efficiently extracting gate parameters by directly solving a Floquet eigenproblem using exact numerics and a perturbative analytical approach. An example application of this toolkit is the space of parametric gates generated between two fixed-frequency transmon qubits connected by a parametrically driven coupler. An analytical treatment, based on time-dependent Schrieffer-Wolff perturbation theory, yields closed-form expressions for gate frequencies and spurious interactions, and is valid for strong drives. These calculations identify optimal regimes of operation for different types of gates including iSWAP, controlled-Z, and CNOT.

These analytical results are supplemented by numerical Floquet computations from which drive-dependent gate parameters can be extracted. This approach has a considerable computational advantage over full simulations of time evolutions. More generally, the combined analytical and numerical strategy allows characterization of two-qubit gates involving parametrically driven interactions and can be applied to gate optimization and cross-talk mitigation such as the cancellation of unwanted ZZ interactions in multi-qubit architectures.

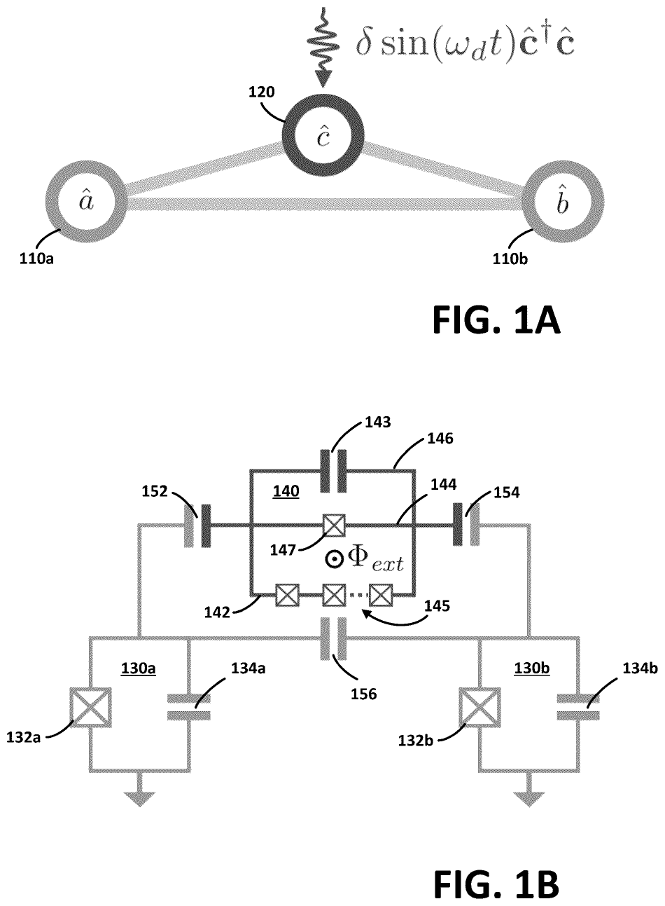

Embodiments of the present invention can be characterized through a computationally efficient set of analytical and numerical tools which facilitate the design of gate Hamiltonians. Flux-tunable parametric coupler architectures [16, 17], which are schematically illustrated in FIG. 1, and provide an example application of these tools. Two complementary approaches have been developed, both of which start from a treatment of the Floquet Hamiltonian, which can capture non-RWA effects exactly [18-20]. This analytical approach starts from the quantization of the driven superconducting circuit. More specifically, embodiments adopt a normal-mode picture such as in black-box quantization [21] or energy-participation-ratio approaches [22], the mode frequencies and impedances, and as a result self- and cross-Kerr interactions, depend on the strength of the drive. This dependence is accounted for in an expansion over the harmonics of the drive. From this, accurate expressions of ac-Stark shifted transition frequencies and interaction strengths can be obtained. Importantly, as compared to previous work, normal modes are defined here by taking into account drive-induced corrections [23] to the Josephson potential [24]. Due to its similarity to black-box quantization, this analytical technique can be easily generalized to circuits containing multiple qubits and couplers.

To obtain corrections to the effective interaction strengths, the approach relies on a time-dependent Schrieffer-Wolff perturbation theory [25-27], which consists of a hierarchy of unitary transformations applied to the time-dependent Floquet Hamiltonian [26, 28]. Embodiments specifically work in the transmon limit of small anharmonicity [29], expressed in terms of the/small dimensionless parameter \sqrt{8E_{C}/Eⱼ}, whereas drive effects are included in a series expansion over the harmonics of the drive frequency and then integrated into the exact treatment of the normal-mode Hamiltonian. This approach allows identification of the contribution of each driven normal mode to the different effective interaction constants.

Formalism is equally applicable to strong anharmonicities, provided that the Hamiltonian is formulated in the energy eigenbasis. The cross-resonance gate [30, 31] has been accurately modeled [27] with such methods, with the notable difference that drive effects were included in the perturbative expansion, something which requires the calculation of higher-order corrections as the drive strength is increased. In contrast, the analysis demonstrates that by effectively performing a series resummation over drive-amplitude contributions, effects can be modeled, such as gate-rate saturation with drive power, which are frequently observed (see e.g., Refs. [31, 32]) without the need to evaluate high-order terms in perturbation theory.

On the other hand, with the numerical approach, gate parameters and, more precisely, the data from a two-tone spectroscopy experiment, can be extracted from a solution of the Floquet eigenproblem [18, 19]. This is efficient by comparison to the simulation of Hamiltonian dynamics over the full duration of the gate protocol: Floquet methods rely on integrating the dynamics over one period of the parametric drive, on the order of 1 ns, which is typically three orders of magnitude shorter than the gate duration. By construction, the parameters extracted from this approach account for renormalization by the drives. The convergence of the analytical approach can be benchmarked by direct comparison to the numerical result. In the context of superconducting circuit architectures, Floquet numerical methods have also been used to model instabilities in transmon qubits under strong drives [23], to obtain corrections beyond linear-response theory for the bilinear interaction between two cavities mediated by a driven ancilla [33], to accurately model a strongly-driven controlled-phase gate between transmon qubits [34], or to enhance the coherence of fluxonium qubits [35, 36].

The remainder of this paper is structured as follows. Sec. II introduces the circuit model, as well as a pedagogical toy model from which all qualitative features of the full theory can be extracted, and illustrate how to obtain the different gate Hamiltonians. Sec. III introduces the basic concepts for second-order RWA, based on a Schrieffer-Wolff transformation of the Floquet Hamiltonian. Section IV captures in more detail the complexity of the problem with an analysis of the three-mode theory derived from the full-circuit Hamiltonian. Sec. V, describes in detail a method to extract effective gate Hamiltonians from a Floquet analysis. Sec. V B, compares all previous approaches using simulations based on the numerical integration of the Schrödinger equation. Sec. VI provides a summary.

### II. Model Hamiltonian

Embodiments of the present invention provide a model for a parametric coupler consisting of three non-linear bosonic modes interacting capacitively [16], see FIG. 1A. The qubit modes â and \hat{b} (110a, 110b) are assumed to be far-detuned, making the beam-splitter (or iSWAP) qubit-qubit interactions negligible in the rotating-wave approximation. Those modes are capacitively coupled to a third mode, the coupler ĉ 120. The latter can be parametrically modulated in order to activate interactions between the two qubit modes, for example, an iSWAP-type gate.

### A. Superconducting Circuit

A possible realization of this three-mode system and/or device is shown in FIG. 1B. The device may comprise at least two qubit structures 130a, 130b for storing quantum states. The at least two qubit structures 130a,b may comprise a first qubit structure 130a and a second qubit structure 130b. One or more of the at least two qubit structures 130a,b may comprise a transmon qubit structure. The at least two qubit structures 130a, 130b may comprise one or more fixed-frequency transmons. The at least two qubit structures 130a,b may have fixed frequencies. The at least two qubit structures 130a,b may be detuned from each other in frequency by one or more of: at least about 1 GHz, in a range of about 0.5 GHZ to about 3 GHz, or in a range of about 1 GHz to about 2 GHz. One or more of at least two qubit structures 130a,b may comprise a junction (e.g., Josephson junction), a capacitor, or a combination thereof. For example, the first qubit structure 130a may comprise a junction 132a and a capacitor 134a. The second qubit structure 130b may comprise a junction 132b and a capacitor 134b.

The device may comprise a coupler 140. The at least two qubit structures 130a,b and the coupler 140 may be coupled together via couplings 152, 154, 156. The couplings 152, 154, 156 may comprise mutual capacitive couplings, galvanic couplings, circuit component (e.g., any circuit component) couplings, and/or the like.

The coupler 140 may be configured to couple the at least two qubit structures 130a,b. The coupler 140 and the at least two qubit structures 130a,b may interact via a coupler 140. The coupler 140 may have opposite anharmonicity to the at least two qubit structures 130a,b (e.g., to qubits implemented thereby). Opposite anharmonicity may comprise the coupler 140 having an anharmonicity of an opposite sign than a sign of an anharmonicity of the at least two qubit structures 130a,b. The coupler 140 may comprise a capacitively shunted flux qubit. The coupler 140 may comprises a flux tunable parametric coupler.

The coupler 140 may comprise a first circuit portion 142. The coupler 140 may comprise a second circuit portion 144. The coupler 140 may comprise a third coupler portion 146. The third coupler portion 146 may comprise a capacitor 143. The first coupler portion 142, the second coupler portion 144, and/or the third coupler portion 146 may be electrically in parallel with each other. The first coupler portion 142, the second coupler portion 144, and/or the third coupler portion 146 may be configured as an asymmetric loop.

The coupler 140 may comprise an asymmetric loop having components in a first portion (e.g., first coupler portion 142) of the asymmetric loop that are asymmetric to components in a second portion (e.g., second coupler portion 144) of the asymmetric loop opposite the first portion. The first circuit portion 142 may comprise a first number of junctions (e.g., Josephson junctions) 145. The second circuit portion 144 may comprise a second number of junctions (e.g., Josephson junctions) 147 different from the first number. The first number may be larger than the second number or vice versa. The first number may be, for example, 4-6, and the second number may be 1. However, it should be understood than any number of junctions may be used as long as the conditions for operation described further herein are satisfied.

A ratio between energies of the components of the first portion (e.g., first coupler portion 142) and energies of the components of the second portion (e.g., second coupler portion 144) and/or a relation between the number of components of the first portion and a number of components of the second portion may match a condition. The condition may be a condition for enabling tuning to achieve zero ZZ crosstalk or substantially zero ZZ crosstalk. The asymmetric loop may comprise a Superconducting Quantum Interference Device (SQUID) loop and the components comprise Josephson junctions.

The coupler 140 may suppress crosstalk based on controlling one or more of a flux bias or DC flux bias applied to the coupler. The coupler 140 may be one or more of tunable or tuned to achieve zero ZZ crosstalk or substantially zero ZZ crosstalk between the at least two qubit structures. The coupler 140 may be tuned using a magnetic field to achieve zero ZZ crosstalk or substantially zero ZZ crosstalk.

The coupler 140 may be controlled by one or more of modulation, parametric modulation, or a time-dependent control protocol. The coupler 140 may be controlled to provide gate operations based on quantum entanglement between the at least two qubit structures 130a,b. The at least two qubit structures 130a,b and/or the coupler 140 may enable gates that are less than 20 ns in duration. The at least two qubit structures 130a,b and/or coupler 140 may enable gates that are less than 20 ns in duration and are detuned from each other in frequency by one or more of: at least about 1 GHz, or in a range of about 1 GHz to about 2 GHz.

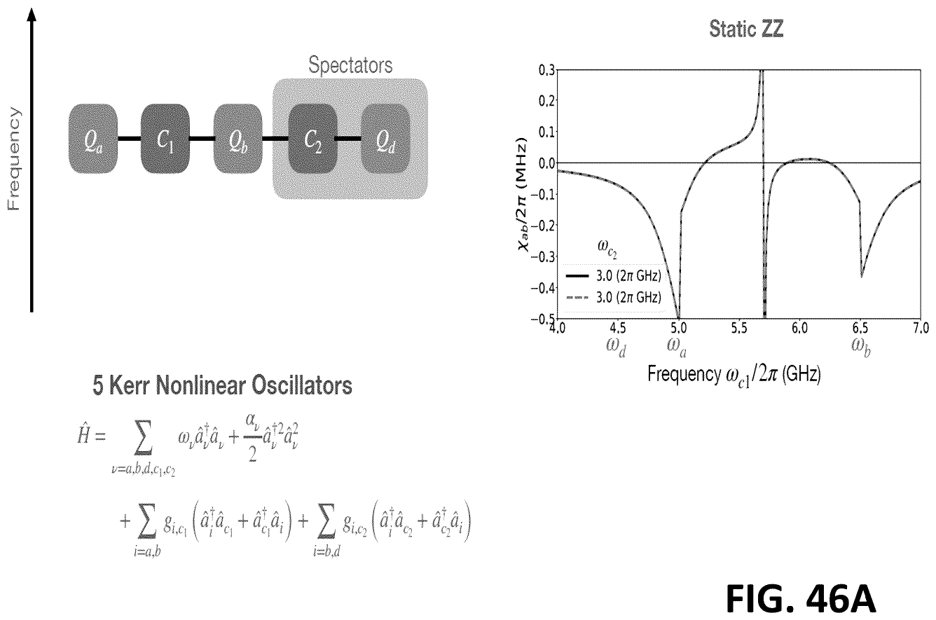

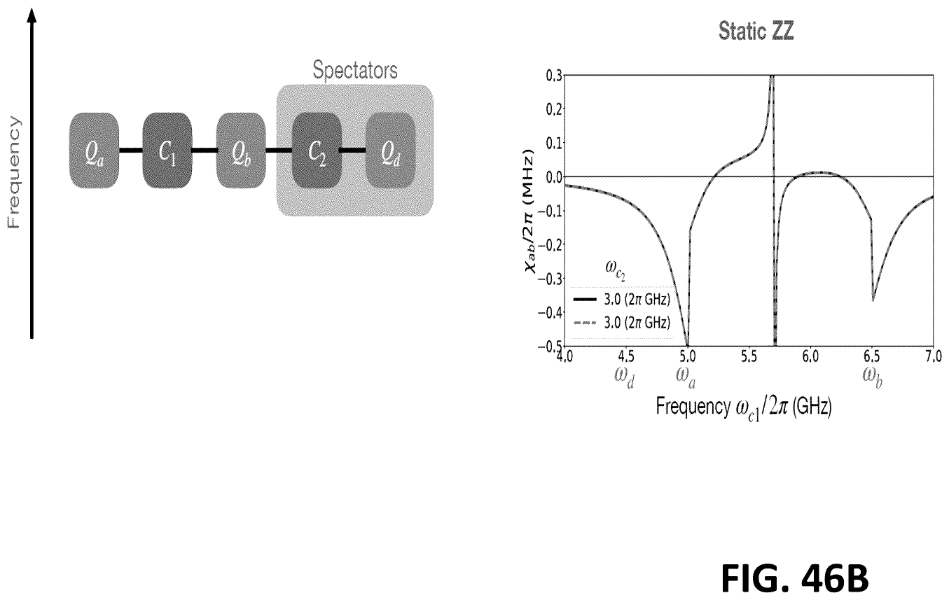

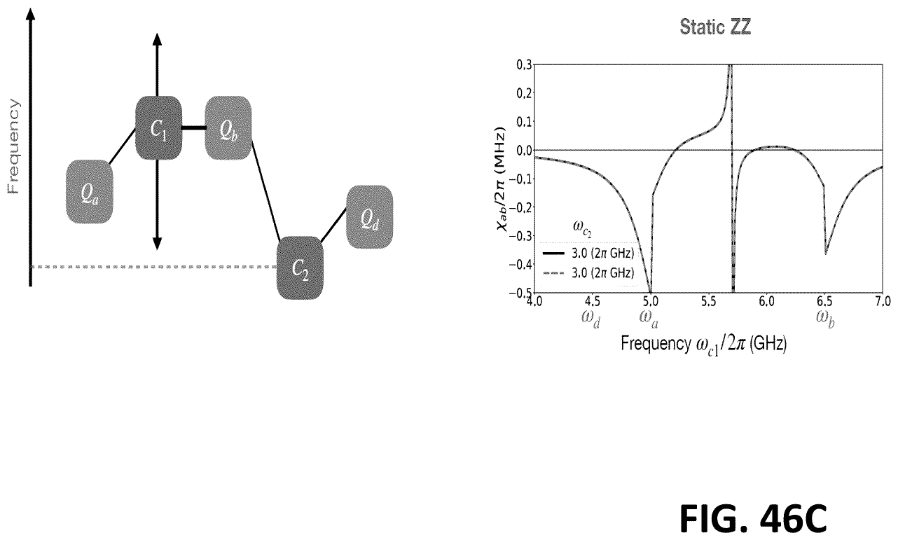

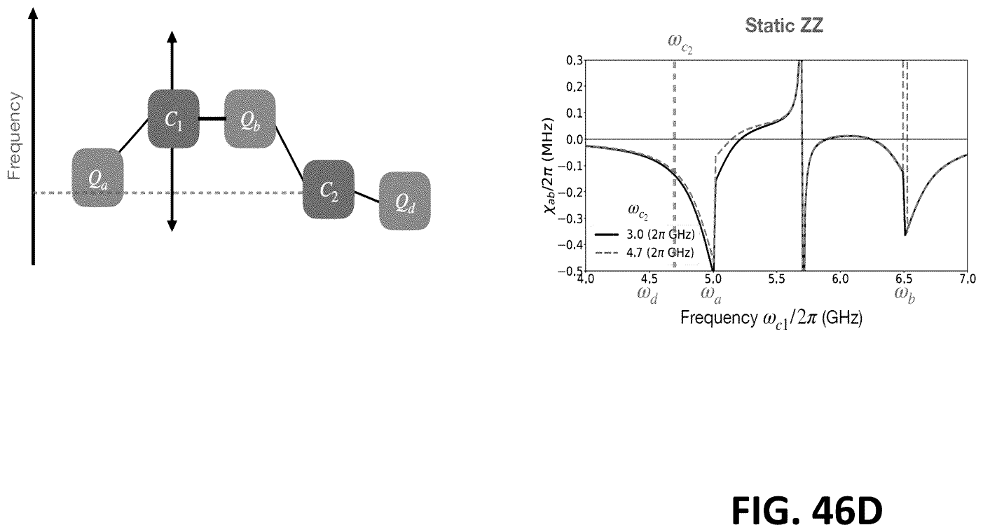

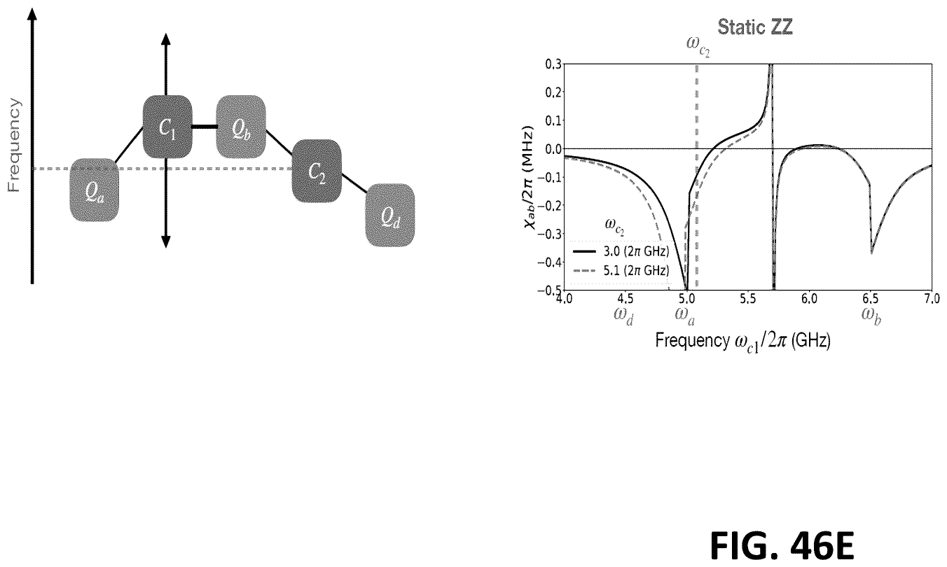

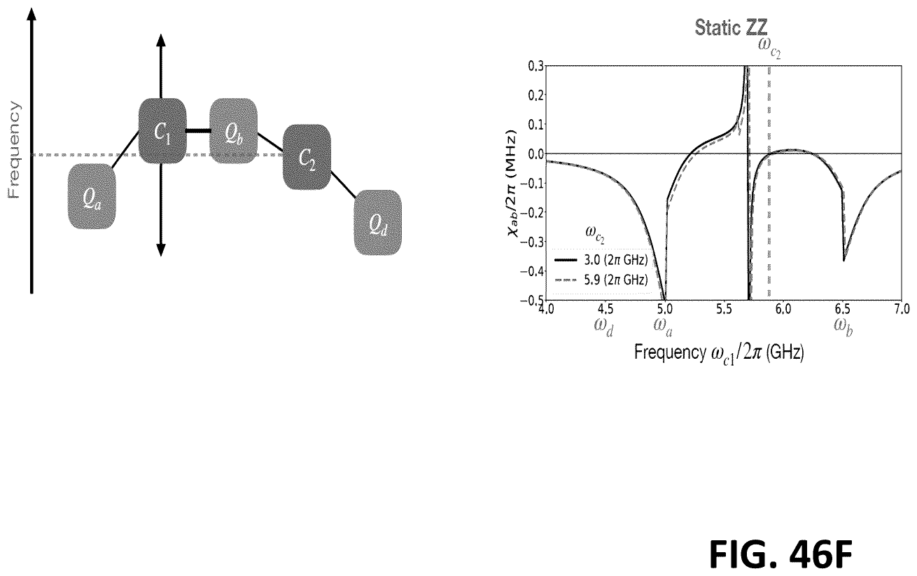

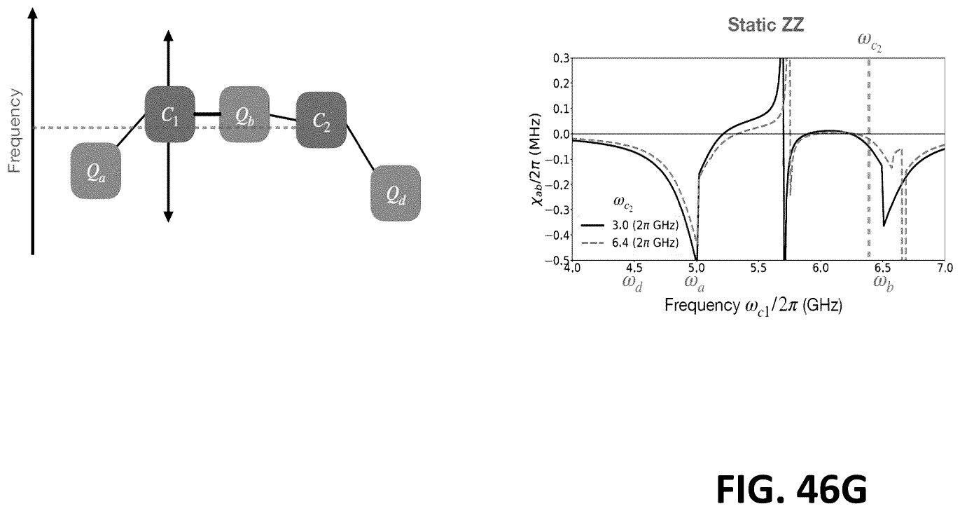

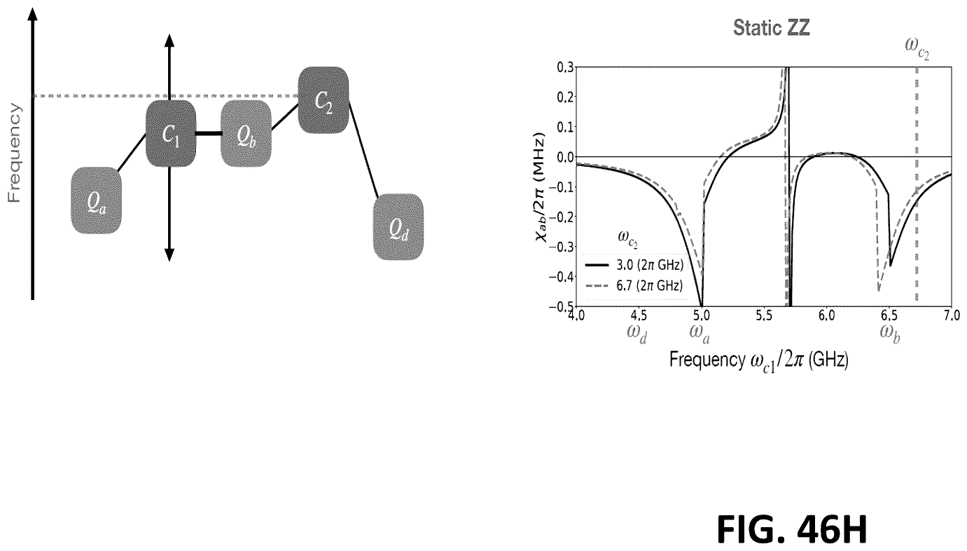

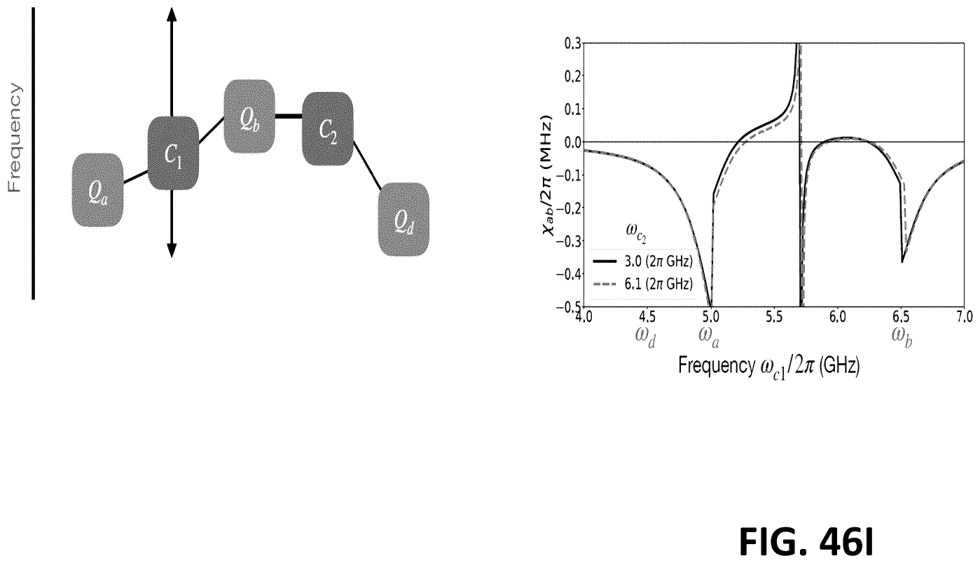

The device may further comprise a readout cavity and qubits to maximize coherence and minimize state preparation and measurement errors. In some scenarios (e.g., as shown in FIG. 46A-I), the device may comprise an additional coupler having the opposite anharmonicity to the at least two qubit structures 130a,b. The at least two qubit structures 130a,b for storing quantum states may comprise a third qubit structure. The additional coupler may have opposite anharmonicity to the third qubit structure. The additional coupler may couple the third qubit structure to one or more of the at least two qubit structures 130a,b. The device may be implemented in a system comprising a plurality of quantum structures. For example, a plurality of quantum logic gates may be formed using a number of couplers and qubit structures.

In a single-mode approximation, this generalized flux qubit (e.g., used another term for the coupler above, but the coupler is not so limited) plays the role of coupler mode and the parametric drive is realized by modulating the reduced external flux φₑₓₜ=2πΦₑₓₜ/Φₒ, with Φₑₓₜ the flux threading the coupler's loop and Φₒ the flux quantum. For certain values of the static external flux, the coupler has a positive anharmonicity, which is important in obtaining gates with a vanishing ZZ interaction [10, 14, 40, 41]. It will be appreciated that this specific circuit implementation is for illustration purposes only, and that the methods presented here apply beyond the weakly-anharmonic regime.

Quantizing the circuit of FIG. 1B using the standard approach [42, 43] yields the Hamiltonian (see Additional Section B for a detailed derivation)

$$\hat{H} ( t ) = {\hat{H}}_{a} + {\hat{H}}_{b} + {\hat{H}}_{c} ( t ) + {\hat{H}}_{g} \qquad ( 1 )$$

where the transmons and the coupler are described by

$${\hat{H}}_{j} = 4 {E}_{Cj} {\hat{n}}_{j}^{2} - {E}_{Jj} cos ( {\hat{φ}}_{j} ) , j = a , b , \qquad ( 2 )$$

$${\hat{H}}_{c} ( t ) = 4 {E}_{Cc} {\hat{n}}_{c}^{2} - α {E}_{Jc} cos [ {\hat{φ}}_{c} + {μ}_{α} {φ}_{ext} ( t ) ] - β {NE}_{Jc} cos [ \frac{{\hat{φ}}_{c}}{N} + {μ}_{β} {φ}_{ext} ( t ) ]$$

These expressions use pairs of canonically conjugate superconducting phase difference and Cooper pair number for the bare modes, [\hat{φ}ⱼ, \hat{n}ₖ]=iδⱼₖ for the mode indices j, k=a, b, or c, and throughout this document ℏ=1. The Josephson energies are denoted E_{Ja}, E_{Jb} for the transmon modes, whereas βE_{Jc} is the Josephson energy of one of N array junctions in the coupler, and α is a factor parametrizing the anisotropy between the two branches. The parameter β is a renormalization of the superinductance due to disorder in the junction array and finite zero-point fluctuations (see Additional Section B). Moreover, the parameter α accounts for a renormalization of the small junction energy due to hybridization with the modes in the junction array. Furthermore, E_{Ca}, E_{Cb} and E_{Cc} are charging energies. In the transmon regime, E_{Ja}/E_{Ca} and E_{Jb}/E_{Cb}≳50 [29].

The coupler loop is threaded by an external flux φₑₓₜ which can be modulated in time with a modulation amplitude δφ, taken to be small compared to the flux quantum

$${φ}_{ext} ( t ) = {\overline{φ}}_{ext} + δφ sin ( {ω}_{d} t ) , \qquad ( 3 )$$

As discussed by You et al. [44], quantization of the coupler loop under time-dependent flux imposes that the external flux be included in both branches of the potential energy in Ĥ_{c}(t), with weighting factors μ_{α,β} determined by the capacitive energies of the two branches (see Additional Section B for a detailed derivation). This subtlety is important, as the details of the flux modulation determine the parametric interactions between the two qubit modes.

Finally, the three bare modes interact through linear terms induced by the capacitive coupling

$${\hat{H}}_{g} = 4 {E}_{Cab} {\hat{n}}_{a} {\hat{n}}_{b} + 4 {E}_{Cca} {\hat{n}}_{c} {\hat{n}}_{a} . \qquad ( 4 )$$

The introduction of normal modes will eliminate this linear coupling Hamiltonian.

### B. Toy Model for Circuit Hamiltonian

In this subsection, the following simple model captures the essential qualitative features of the Hamiltonian of Eq. (1). The toy model consists of three linearly coupled Kerr-nonlinear oscillators and has the form given in Eq. (1) now with

$${\hat{H}}_{a} = {ω}_{a} {\hat{a}}^{†} \hat{a} + \frac{{α}_{a}}{2} {\hat{a}}^{†2} {\hat{a}}^{2} , \qquad ( 5 )$$

$${\hat{H}}_{b} = {ω}_{b} {\hat{b}}^{†} \hat{b} + \frac{{α}_{b}}{2} {\hat{b}}^{†2} {\hat{b}}^{2}$$

$${\hat{H}}_{c} ( t ) = {ω}_{c} ( t ) {\hat{c}}^{†} \hat{c} + \frac{{α}_{c}}{2} {\hat{c}}^{†2} {\hat{c}}^{2}$$

$${\hat{H}}_{g} = - {g}_{ab} {\hat{a}}^{†} \hat{b} - {g}_{bc} {b}^{†} \hat{c} - {g}_{ca} {\hat{c}}^{†} \hat{a} + H . c .$$

Comparing to the full-circuit model, note that ω_{a(b)}≈\sqrt{8E_{Ja(b)}E_{Ca(b)}}−E_{Ca(b)} whereas the anharmonicities of the transmon qubits are negative and amount to α_{a(b)}≈−E_{Ca(b)}. In an experimental implementation, the parameters defining the coupler—the anharmonicity α_{c} and the frequency ω_{c}(t)—can be varied by applying a time-dependent external flux to activate a chosen gate.

The parametric drive resulting from the flux modulation of Eq. (3) is modeled by a modulation of the coupler frequency at a frequency ω_{d}

$${ω}_{c} ( t ) = {ω}_{c} + δ sin ( {ω}_{d} t ) . \qquad ( 6 )$$

In a more detailed analysis of the coupler (see Sec. IV), the time dependence of the anharmonicity α_{c} is further considered.

In the embodiments and approaches discussed herein, the complexity of the problem has been reduced in the following ways: the Josephson expansion has been truncated to include only quartic terms. All photon number non-conserving terms have been dropped. Higher harmonics of the drive of Eq. (6) are neglected, and do not consider the ac-Stark shifts of the various coupling constants. All of these refinements are taken into account in the analysis of the full circuit Hamiltonian in Sec. IV. Thus the toy model is significantly simpler than the full circuit theory, but nonetheless still contains the necessary ingredients that allow an illustration of the general method introduced in this paper.

### III. Perturbative Expansion

This section discusses a perturbative expansion to obtain successive corrections to the effective Hamiltonian in the rotating-wave approximation. To simplify the discussion, a toy model is described. The next section will come back to the full circuit Hamiltonian. The present approach relies on a sequence of unitary transformations amounting to a time-dependent Schrieffer-Wolff treatment of the Floquet Hamiltonian in the normal-mode representation, an approach used before to derive corrections to the lifetime of driven transmon qubits [26, 28]. Time-dependent extensions of Schrieffer-Wolff transformations have been shown to be necessary to capture effects of drives in the dispersive regime of circuit QED [25], with quantitative agreement with experiment in the analysis of the cross-resonance gate [27]. A notable difference from prior work on microwave-activated two-qubit gates is that, in performing a normal-mode transformation, the disclosed analytical approach obtains good agreement with exact numerics already at second order in perturbation theory. For example, the calculation in Ref. [27] relies on an expansion in capacitive couplings and drive power, which would require, in the setup presented here, to go to higher order (fourth) in the calculation to obtain results comparable to the normal-mode approach.

### A. Formalism

The starting point is a decomposition of the system Hamiltonian into an unperturbed, exactly solvable part, and a perturbation:

$$\hat{H} = {\hat{H}}^{( 0 )} ( t ) + λ {\hat{H}}^{( 1 )} ( t ) . \qquad ( 7 )$$

The dimensionless power-counting parameter A is introduced to keep track of the order in perturbation theory, to be set at the end of the calculation to unity, λ→1. Then, the interaction picture can be considered with respect to Ĥ⁽⁰⁾. Letting Û₀(t)=Te^{-i∫}^{₀}^{^{t}}^{dtĤ}^{⁽⁰⁾}^{(t′)}, where T is the time-ordering operator, the interaction-picture Floquet Hamiltonian can be found by:

$$λ {\hat{H}}_{I}^{( 1 )} ( t ) - i {\partial }_{t} = {\hat{U}}_{0}^{†} ( t ) [ {\hat{H}}^{( 0 )} + λ {\hat{H}}^{( 1 )} ( t ) - i {\partial }_{t} ] {\hat{U}}_{0} ( t ) = {\hat{U}}_{0}^{†} ( t ) λ {\hat{H}}^{( 1 )} ( t ) {\hat{U}}_{0} ( t ) - i {\partial }_{t} . \qquad ( 8 )$$

In the above it is assumed that the unperturbed time-evolution operator Û₀(t) is known. Equation (8) can be seen as a unitary transformation between two Floquet Hamiltonians [19]. Thus, the Floquet quasienergies corresponding to λĤₗ⁽¹⁾(t)−i∂ₜ must be identical to those of Ĥ⁽⁰⁾+λĤ⁽¹⁾(t), while the eigenstates are related by Û₀(t).

In an iterative Schrieffer-Wolff approach, the operator λĤ⁽¹⁾(t) is treated as a small perturbation from which corrections to the known Floquet quasienergies of Ĥ⁽⁰⁾ can be derived [26, 28]. To this end, a unitary transformation on the interaction-picture Floquet Hamiltonian Ĥ₁(t)−i∂ₜ=λĤ⁽¹⁾(t)−i∂ₜ, is considered, and the corresponding Baker-Campbell-Hausdorff (BCH) expansion in powers of the generator of this unitary, that is

$${\hat{H}}_{I , eff} - i {\partial }_{t} ≡ {e}^{- {\hat{G}}_{I} ( t )} [ {\hat{H}}_{I} ( t ) - i {\partial }_{t} ] {e}^{- {\hat{G}}_{I} ( t )} = {\hat{H}}_{I} - i {\dot{\hat{G}}}_{I} + [ {\hat{H}}_{I} , {G}_{I} ] - \frac{i}{2} [ {\dot{\hat{G}}}_{I} , {\hat{G}}_{I} ] - i {\partial }_{t} + … \qquad ( 9 )$$

This equation defines the effective Hamiltonian, whose spectrum is equal (up to a desired precision in λ) to that of the original driven theory. The generator Ĝ₁(t) can be solved for iteratively in powers of λ (see Additional Section A), which allows performance of the rotating-wave approximation order by order

$${\hat{H}}_{I , eff} = λ {\overline{\hat{H}}}_{I}^{( 1 )} + {λ}^{2} {\overline{\hat{H}}}_{I}^{( 2 )} + … \qquad ( 10 )$$

where the terms on the right-hand side are defined below.

To obtain a lowest-order term of the effective Hamiltonian, λĤₗ⁽¹⁾, the interaction picture Hamiltonian are separated into oscillatory and non-oscillatory terms with the notation

$$λ {\hat{H}}_{I}^{( 1 )} ( t ) ≡ λ {\overline{\hat{H}}}_{I}^{( 1 )} + λ {\tilde{\hat{H}}}_{I}^{( 1 )} ( t ) . \qquad ( 11 )$$

where constant part of a time-dependent operator can be defined as Ô(t) by [45]

$$\overline{\hat{O}} ≡ {lim}_{T \to ∞} \frac{1}{T} {\int }_{0}^{T} dt \hat{O} ( t ) , \qquad ( 12 )$$

whereas the oscillatory part of the operator is

$$\tilde{\hat{O}} ( t ) = \hat{O} ( t ) - \overline{\hat{O}} . \qquad ( 13 )$$

Since the time-averaging operation removes all terms that are oscillatory in time, \hat{H̅}ₗ⁽¹⁾ is the first-order RWA Hamiltonian [45], whereas \hat{\tilde{H}}ₗ⁽¹⁾ is canceled by an appropriate choice of the corresponding term at order λ in the generator.

This procedure can be iterated at every order, collecting terms that are oscillatory and then canceling them. The second-order RWA Hamiltonian reads (for a derivation, see Additional Section A)

$${λ}^{2} {\overline{\hat{H}}}_{I}^{( 2 )} = \frac{1}{i} \overline{[ {\overline{\hat{H}}}_{I}^{( 1 )} , {\int }_{0}^{t} λ {\tilde{\hat{H}}}_{I}^{( 1 )} ( {t}^{′} ) {dt}^{′} ]} + \frac{1}{2 i} \overline{[ λ {\tilde{\hat{H}}}_{I}^{( 1 )} ( t ) , {\int }_{0}^{t} λ {\tilde{\hat{H}}}_{I}^{( 1 )} ( {t}^{′} ) {dt}^{′} ]} . \qquad ( 14 )$$

This form becomes analogous to the second term in the Magnus expansion [45, 46] when the perturbation has a vanishing mean, i.e. \hat{H̅}ₗ⁽¹⁾=0.

### B. Black-Box Quantization Approach to the Toy Model

Expressing the toy-model Hamiltonian as the sum of static quadratic terms, Ĥ⁽⁰⁾, and of time-dependent and Kerr terms, Ĥ⁽¹⁾(t), the first step in deriving parametrically activated interactions between the transmon modes is to diagonalize the former, which can be written as:

$${\hat{H}}^{( 0 )} = ( {\hat{a}}^{†} {\hat{b}}^{†} {\hat{c}}^{†} ) ( \begin{matrix}{ω}_{a} & {g}_{ab} & {g}_{ca} \\ {g}_{ab} & {ω}_{b} & {g}_{bc} \\ {g}_{ca} & {g}_{bc} & {ω}_{c}\end{matrix} ) ( \begin{matrix}\hat{a} \\ \hat{b} \\ \hat{c}\end{matrix} ) . \qquad ( 15 )$$

This diagonalization is achieved with an orthonormal transformation \hat{α}=Σ_{β=a,b,c} u_{αβ}\hat{β}, for α=a, b, c, and which is chosen such that Ĥ⁽⁰⁾ takes the form

$${\hat{H}}^{( 0 )} = {ω}_{a} {\hat{a}}^{†} \hat{a} + {ω}_{b} {\hat{b}}^{†} \hat{b} + {ω}_{c} {\hat{c}}^{†} \hat{c} , \qquad ( 16 )$$

where â, \hat{b} and ĉ are now the normal modes and ω_{a,b,c} the corresponding mode frequencies. The u_{αβ} are hybridization coefficients encoding the connectivity of the three modes through the capacitive couplings Ĥ_{g} entering in Ĥ⁽⁰⁾. In this normal-mode basis, the remainder of the Hamiltonian reads

$$λ {\hat{H}}^{( 1 )} ( t ) = {\sum }_{j = a , b , c} \frac{{α}_{j}}{2} {( {u}_{j a} \hat{a} + {u}_{j b} \hat{b} + {u}_{j c} \hat{c} )}^{† 2} {( {u}_{j a} \hat{a} + {u}_{j b} \hat{b} + {u}_{j c} \hat{c} )}^{2} + δsin ( {ω}_{d} t ) {( {u}_{c a} \hat{a} + {u}_{c b} \hat{b} + {u}_{c c} \hat{c} )}^{†} ( {u}_{c a} \hat{a} + {u}_{c b} \hat{b} + {u}_{c c} \hat{c} ) \qquad ( 17 )$$

The expression above illustrates that coupling between the normal modes arises from the nonlinearity and the parametric drive.

Our choice of unperturbed Hamiltonian Ĥ⁽⁰⁾ and perturbation λĤ⁽¹⁾ in Eqs. (16) and (17), respectively, is guided by black-box quantization [21]: the unperturbed Hamiltonian is linear and diagonal in the normal-mode basis, whereas the perturbation consists of Kerr-nonlinear terms, on the one hand, and quadratics appearing from the normal-mode expansion of the parametric drive, on the other hand. As shown below, while better choices are possible (see Sec. III C), this choice leads to a simple and intuitive form for the effective Hamiltonian.

As an example of the many common types of interactions that can be activated by a parametric drive [3], a SWAP interaction between the transmon modes arises if the modulation is set to be at the frequency difference between the two transmon modes

$${ω}_{d} = {ω}_{a} - {ω}_{b} , \qquad ( 18 )$$

This choice yields the first-order RWA Hamiltonian

$$λ {\overline{\hat{H}}}_{I}^{( 1 )} = {J}_{ab}^{( 1 )} ( - i {\hat{a}}^{†} \hat{b} + H . c . ) + \frac{{α}_{a}^{( 1 )}}{2} {\hat{a}}^{†2} {\hat{a}}^{2} + \frac{{α}_{b}^{( 1 )}}{2} {\hat{b}}^{†2} {\hat{b}}^{2} + \frac{{α}_{c}^{( 1 )}}{2} {\hat{c}}^{†2} {\hat{c}}^{2} + {χ}_{ab}^{( 1 )} {\hat{a}}^{†} \hat{a} {\hat{b}}^{†} \hat{b} + {χ}_{bc}^{( 1 )} {\hat{b}}^{†} \hat{b} {\hat{c}}^{†} \hat{c} + {χ}_{ca}^{( 1 )} {\hat{c}}^{†} \hat{c} {\hat{a}}^{†} \hat{a} \qquad ( 19 )$$

The first row of this equation contains the iSWAP interaction of amplitude J_{ab}⁽¹⁾. The second row contains the mode anharmonicities, and the third row contains cross-Kerr interactions, the first of which is the ZZ term. The coupling constants in the above effective Hamiltonian result from the normal-mode transformation of the quadratic part of the toy model and take the form

$${J}_{a b}^{( 1 )} = {u}_{c a} {u}_{cb} \frac{δ}{2} , \qquad ( 20 )$$

$${a}_{j}^{( 1 )} = {\sum }_{i = a , b , c} {u}_{i j}^{4} {α}_{i} ,$$

$${χ}_{j k}^{( 1 )} = {\sum }_{i = a , b , c} 2 {u}_{i j}^{2} {u}_{i k}^{2} {α}_{i} ,$$

for all j, k=a, b, c, and j≠k. In practice, maximizing J_{ab}⁽¹⁾ can obtain a fast gate, while minimizing the cross-Kerr interactions χⱼₖ⁽¹⁾ can avoid the accumulation of coherent errors. Cross-Kerr interactions are a source of infidelity for a iSWAP-type gate, as well as in other gate implementations [10-14, 47]. In the first-order RWA Hamiltonian, to cancel the cross-Kerr interaction between the two transmons, embodiments can use a coupler with a positive anharmonicity [41] α_{c}>0, together with αₐ, α_{b}<0, which is distinct from using qubits of opposite anharmonicities [10, 40], or couplers with negative anharmonicity [14, 48]. Equation (20) forms the basis for the optimization of the gate parameters. Important corrections to the gate Hamiltonian can be derived from the oscillatory part of the Hamiltonian, \hat{\tilde{H}}ₗ⁽¹⁾(t) at second order in perturbation theory. Finally, note that the first-order term χⱼₖ⁽¹⁾ is only a static, i.e. δ-independent, cross-Kerr interaction.

At second order in perturbation theory, there is no correction to the iSWAP gate frequency J_{ab}⁽²⁾=0. In the regimes of interest, where the coupler frequency is close enough to the qubit frequencies for the interaction between the coupler and the qubits to be non-negligible, the dominant contribution to the second-order RWA correction to the cross-Kerr interaction χ_{ab}⁽²⁾ is

$${χ}_{a b}^{( 2 )} \approx 2 \frac{{( {Σ}_{j = a , b , c} {u}_{a j} {u}_{b j} {u}_{c j}^{2} {α}_{j} )}^{2}}{{ω}_{a} + {ω}_{b} - 2 {ω}_{c}} + δ \frac{{u}_{a c} {u}_{b c} [ {u}_{a a}^{3} {u}_{b a} {α}_{a} - {u}_{b b}^{3} {u}_{a b} {α}_{b} ]}{{ω}_{a} - {ω}_{b}} \qquad ( 21 )$$

The full expression for χ_{ab}⁽²⁾ can be found in Additional Section C. Inspecting the hybridization coefficients u_{αβ} and the denominators in Eq. (21), it is deduced that the second-order correction to the static cross-Kerr interaction, corresponding to the first term in Eq. (21), arises from a virtual two-photon excitation of the coupler (generated by the commutator [â\hat{b}ĉ^{†2}, â^{†}\hat{b}^{†}ĉ²]). This correction would not be present in a two-level approximation [16]. On the other hand, the second term in Eq. (21) is the lowest-order contribution to the dynamical cross-Kerr interaction.

### C. Improving the Starting Point of the Perturbation Theory

As mentioned in the previous subsection, other choices for Ĥ⁽⁰⁾ and λĤ⁽¹⁾ are possible which give better accuracy in comparisons with exact Floquet numerics. In this subsection, the unperturbed Hamiltonian Ĥ⁽⁰⁾(t) can consist of the Fock-space diagonal part of Ĥ(t), namely:

$${\hat{H}}^{( 0 )} ( t ) = {ω}_{a} {\hat{a}}^{†} \hat{a} + {ω}_{b} {\hat{b}}^{†} \hat{b} + {ω}_{c} {\hat{c}}^{†} \hat{c} + δ sin ( {ω}_{d} t ) [ {u}_{c a}^{2} {\hat{a}}^{†} \hat{a} + {u}_{c b}^{2} {\hat{b}}^{†} \hat{b} + {u}_{c c}^{2} {\hat{c}}^{†} \hat{c} ] + \frac{{α}_{a}^{0}}{2} {\hat{a}}^{†2} {\hat{a}}^{2} + \frac{{α}_{b}^{0}}{2} {\hat{b}}^{†2} {\hat{b}}^{2} + \frac{{α}_{c}^{0}}{2} {\hat{c}}^{†2} {\hat{c}}^{2} + {χ}_{ab}^{( 0 )} {\hat{a}}^{†} \hat{a} {\hat{b}}^{†} \hat{b} + {χ}_{a c}^{( 0 )} {\hat{a}}^{†} \hat{a} {\hat{c}}^{†} \hat{c} + {χ}_{bc}^{( 0 )} {\hat{b}}^{†} \hat{b} {\hat{c}}^{†} \hat{c} \qquad ( 22 )$$

where the quartic couplings in the last two rows are exactly those defined in Eq. (20), with the superscript now changed from 1 to 0 to reflect their presence in the unperturbed Hamiltonian.

This starting point, Eq. (22), is expected to lead to more precise results, for two reasons. Firstly, the perturbation Ĥ⁽¹⁾ is now off-diagonal in Fock-space. The effects of the anharmonicities of the modes are now included at the level of Ĥ⁽⁰⁾, and, in particular, a dressing of contributions corresponding to two-photon excitations can be expected, such as Eq. (21). Secondly, due to the second row of Eq. (22), the effect of harmonics of the drive frequency can be derived through a Fourier expansion of the time-evolution operator Û₀(t), defined below.

Following the steps of the previous subsections, the time evolution operator is evaluated with respect to the unperturbed Hamiltonian Ĥ⁽⁰⁾(t), that is

$${\hat{U}}_{0} ( t ) = {e}^{- i {\int }_{0}^{t} {dt}^{′} {\hat{H}}^{( 0 )} ( {t}^{′} )} , \qquad ( 23 )$$

with [Ĥ⁽⁰⁾(t), Ĥ⁽⁰⁾(t′)]. The time-dependence in the exponent is handled via the Jacobi-Anger identity [49]

$${e}^{i \hat{o} \frac{δ}{{ω}_{d}} cos {ω}_{d} t} = {J}_{0} ( \frac{\hat{O} δ}{{ω}_{d}} ) + 2 {\sum }_{n = 1}^{∞} {i}^{n} {J}_{n} ( \frac{\hat{O} δ}{{ω}_{d}} ) cos n {ω}_{d} t , \qquad ( 24 )$$

for any operator Ô, where Jₙ(z) is the n^{th} Bessel function of the first kind [49]. This expansion keeps track of all harmonics of the drive. In practice, since the modulation amplitude is small, δ/ω_{d}<<1, only a few terms will be necessary.

The first order (and truncating after the first Bessel function) can be obtained:

$${J}_{a b}^{( 1 )} = \frac{δ}{2} {u}_{c a} {u}_{c b} [ {J}_{0} ( \frac{δ {u}_{c a}^{2}}{{ω}_{d}} ) {J}_{0} ( \frac{δ {u}_{c b}^{2}}{{ω}_{d}} ) + 3 {J}_{1} ( \frac{δ {u}_{c a}^{2}}{{ω}_{d}} ) {J}_{1} ( \frac{δ {u}_{c b}^{2}}{{ω}_{d}} ) ] , \qquad ( 25 )$$

which agrees, up to linear terms in δ, with the expression in Eq. (20). On the other hand, the cross-Kerr interaction at this order is vanishing χ_{ab}⁽¹⁾=0.

To second order in perturbation theory, the dominant contributions to J_{ab}⁽²⁾ are

$${J}_{a b}^{( 2 )} = \frac{i {δ}^{2}}{2} {u}_{c a} {u}_{c b} {u}_{c c}^{2} ( \frac{1}{{ω}_{a} - {ω}_{c}} - \frac{1}{{ω}_{b} - {ω}_{c}} ) \times {J}_{1} ( \frac{δ {u}_{c c}^{2}}{{ω}_{d}} ) {Π}_{j = a , b , c} {J}_{0} ( \frac{δ {u}_{c j}^{2}}{{ω}_{d}} ) , \qquad ( 26 )$$

Although the full form containing 20 terms is not provided here, the second-order contribution χ_{ab}⁽²⁾ is non-vanishing, and contains approximately 450 terms in expanded form. Despite the complexity of these full expressions, they are easy to derive and manipulate with symbolic computation tools [50]. Focusing on the static cross-Kerr interaction, i.e., in the δ→0 limit, the dominant correction resulting from the above changes amounts Eq. (21), but replacing the denominator of the first term of that expression by a form that faithfully includes the contribution from the anharmonicities, as expected in the case of a virtual two-photon excitation of the coupler mode. That is, approximately

$${ω}_{α} + {ω}_{b} - 2 {ω}_{c} \to {ω}_{α} + {ω}_{b} - ( 2 {ω}_{c} + {u}_{c c}^{4} {α}_{c} ) \qquad ( 27 )$$

The full expression for the corrected static cross-Kerr interaction can be found in Additional Section C.

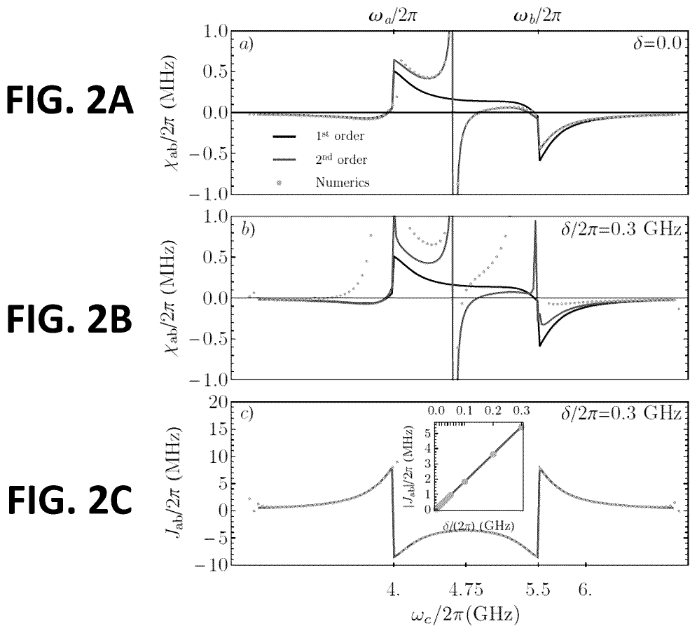

In FIG. 2 the analytical results are compared to numerical results obtained from exact diagonalization (at δ=0), or a solution of the Floquet eigenspectrum at δ≠0 (see Sec. V). The agreement between numerics and analytics is excellent for the gate interaction strength, as well as for the static δ=0 cross-Kerr interaction. However, second-order perturbation theory is insufficient to reproduce the effects of the drive on the cross-Kerr interaction, even for modest drive amplitudes. It is expected that higher-order perturbation theory should correctly capture the drive-amplitude dependence of the anharmonicities, but these contributions have been inaccessible in the study due to the large memory demands of the computer algebra manipulations.

### IV. Full Circuit Hamiltonian

Building on the previous results, the following describes an effective Hamiltonian for the full circuit Hamiltonian of Eq. (1) and Eq. (2). The full circuit model goes beyond the toy model in that it systematically includes the effects of the parametric drive on all of the coupling constants. Although the simplicity of the toy model is useful in developing an intuitive understanding of the effect of parametric drives on the system, the full circuit model can lead to more accurate comparisons with experimental data.

The full circuit theory is constructed with the following steps: Sec. IV A introduces the creation and annihilation operators for the bare circuit modes starting from the first-order RWA driven circuit Hamiltonian. Because the drive is taken into account at that level, the frequencies and zero-point fluctuations of these bare modes will be explicitly corrected by the drive. Sec. IV B performs a normal-mode transformation amounting to a driven black-box quantization approach. Sec. IV C then shows how a variety of quantum gates can be addressed by appropriate choices of the parametric drive frequency. Lastly, Sec. IV C finds corrections to the desired gate Hamiltonian using time-dependent Schrieffer-Wolff perturbation theory.

### A. Bare-Mode Hamiltonian

Normal-order expansion of the Hamiltonian specified by Eqs. (1) and (2) is performed over a set of creation and annihilation operators defined as follows

$${\hat{φ}}_{a} = \sqrt{\frac{{η}_{α}}{2}} ( \hat{a} + {\hat{a}}^{†} ) , {\hat{n}}_{a} = - i \sqrt{\frac{1}{2 {η}_{a}}} ( \hat{a} - {\hat{a}}^{†} ) \qquad ( 28 )$$

with analogous equations for modes \hat{b} and ĉ. The coefficients η_{a,b,c} are chosen such that terms proportional to â², \hat{b}², and ĉ² vanish in the time-averaged Hamiltonian. This amounts to three transcendental equations:

$$( {η}_{j} ) {η}_{j}^{2} = 8 {E}_{Cj} / {E}_{Jj} , \qquad ( 29 )$$

for j=a, b, c, with defined the form factors

$$( {η}_{a ( b )} ) ≡ {e}^{- \frac{{η}_{a ( b )}}{4}} , \qquad ( 30 )$$

$$( {η}_{c} ) ≡ α {e}^{- \frac{{η}_{c}}{4}} {J}_{0} ( δ ) cos ( {\overline{φ}}_{e x t} ) + β {e}^{- \frac{{η}_{c}}{4 {N}^{2}}} / N .$$

Two remarks are in order: First, in the transmon limit [symbol] (η_{α(b)})≈1 with the usual expression η_{α(b)}≈\sqrt{8E_{Ca/b/}E_{Ja/b}}. Second, the parameter η_{c} depends on the parametric drive amplitude δ, which indicates that the mode c impedance is drive-dependent. This has important consequences for the precision of the calculation of coupling constants dressed by the para-metric drives. In particular it allows capturing of the ac-Stark shift of the coupler mode at the lowest order in perturbation theory. In what follows, sine and cosine functions of the phase are normal-order expanded according to Eq. (D1) of Additional Section D. In turn, trigonometric functions of the flux modulation are expanded in Jacobi-Anger series over the harmonics of the frequency of the drive.

Using the above definitions, the transmon Hamiltonian Ha takes the familiar form

$${\hat{H}}_{α} = {ω}_{α} {\hat{a}}^{†} \hat{a} - {E}_{J α} ( cos {\hat{φ}}_{a} + {e}^{- \frac{{η}_{a}}{4}} \frac{{\hat{φ}}_{a}^{2}}{2} ) . \qquad ( 31 )$$

The second term on the right-hand side contains the non-linear part of the Josephson potential, i.e. the inductive part is subtracted. Up to quartic order, Ĥₐ takes the form

$${\hat{H}}_{a} = {ω}_{a} {\hat{a}}^{†} \hat{a} + \frac{{α}_{a}}{2} {\hat{a}}^{†2} {\hat{a}}^{2} + \frac{{α}_{a}}{12} ( {\hat{a}}^{4} + {\hat{a}}^{4} ) + \frac{{α}_{a}}{3} ( {\hat{a}}^{†} {\hat{a}}^{3} + {\hat{a}}^{†3} \hat{a} ) + … \qquad ( 32 )$$

The first row of this expression is a Kerr oscillator Hamiltonian as in the toy model of Sec. II, whereas the second row contains corrections from quartic counter-rotating terms. Here, the mode frequency and anharmonicity can take the following forms

$${ω}_{a} = \frac{4 {E}_{Ca}}{{η}_{a}} + \frac{1}{2} ℱ ( {η}_{a} ) {η}_{a} {E}_{Ja} \approx \sqrt{8 {E}_{Ca} {E}_{Ja}} - {E}_{Ca} , {α}_{a} = - {E}_{Ca} . \qquad ( 33 )$$

The equations for mode \hat{b} are obtained from the above with a change of subscripts and operators a→b.

The coupler Hamiltonian differs from that of the transmon modes in two fundamental ways: It breaks parity symmetry due to the external flux, and it is time-dependent. Following Eqs. (12) and (13), this time-dependent Hamiltonian is written as

$${\hat{H}}_{c} ( t ) = \overline{{\hat{H}}_{c}} ( t ) + \tilde{{\hat{H}}_{c}} ( t ) . \qquad ( 34 )$$

The creation and annihilation operators of the coupler mode can then be defined by extracting the quadratic part of the time-averaged coupler Hamiltonian. Using Eq. (28) where a→c together with

$$\overline{cos [ {\hat{φ}}_{c} + {μ}_{α} {φ}_{ext} ( t ) ]} = cos ( {μ}_{α} {\overline{φ}}_{ext} ) {J}_{0} ( {μ}_{α} δ ) cos ( {\hat{φ}}_{c} ) \qquad ( 35 )$$

and a similar relation for the second branch of the coupler [see Eq. (2)], finds in analogy to Eq. (31) for the Hamiltonian of the transmon mode

$${\overline{\hat{H}}}_{c} = {ω}_{c} {\hat{c}}^{†} \hat{c} - α {E}_{Jc} {J}_{0} ( {μ}_{α} δ ) cos ( {μ}_{α} {\overline{φ}}_{ext} ) ( cos {\hat{φ}}_{c} + {e}^{- \frac{{η}_{c}}{4}} \frac{{\hat{φ}}_{c}^{2}}{2} ) - β {NE}_{Jc} {J}_{0} ( {μ}_{α} δ ) cos ( {μ}_{α} {\overline{φ}}_{ext} ) ( cos \frac{{\hat{φ}}_{c}}{N} + {e}^{- \frac{{η}_{c}}{4 {N}^{2}}} \frac{{\hat{φ}}_{c}^{2}}{2 {N}^{2}} ) + α {E}_{Jc} {J}_{0} ( {μ}_{α} δ ) sin ( {μ}_{α} {\overline{φ}}_{ext} ) sin {\hat{φ}}_{c} + β {NE}_{Jc} {J}_{0} ( {μ}_{α} δ ) sin ( {μ}_{β} {\overline{φ}}_{ext} ) sin \frac{{\hat{φ}}_{c}}{N} . \qquad ( 36 )$$

Crucially, in this first-order rotating-wave approximation of the parametric drive, the Josephson energy is renormalized by the factor J₀(μ_{α,β}δφ), see also [23]. This is an effective reduction of the Josephson potential barrier, and consequently an increase of phase fluctuations, in the presence of drives. Moreover, the presence of the non-zero external flux results in the parity breaking sine terms in Eq. (36).

The second term of Ĥ_{c}(t) in Eq. (34), the oscillatory part, takes the form

$${\tilde{\hat{H}}}_{c} ( t ) = - α {E}_{jc} cos [ {\hat{φ}}_{c} {φ}_{ext} ( t ) ] - β {NE}_{jc} cos [ \frac{{\hat{φ}}_{c}}{N} {φ}_{ext} ( t ) ] , \qquad ( 37 )$$

which can be expanded in a Jacobi-Anger series in harmonics oscillating at the frequency nω_{d}, where n is an integer.

As above, the next step is to expand the coupler Hamiltonian up to quartic terms in the creation and annihilation operators. In contrast to the transmon Hamiltonian of Eq. (32), parity breaking leads to the appearance of monomials of odd order. The non-oscillatory part is

$${\hat{H}}_{c} = {ω}_{c} {\hat{c}}^{†} \hat{c} + \frac{{α}_{c}}{2} {\hat{c}}^{†2} {\hat{c}}^{2} + \frac{{α}_{c}}{12} ( {\hat{c}}^{4} + {\hat{c}}^{†4} ) + \frac{{α}_{c}}{3} + ( {\hat{c}}^{†} {\hat{c}}^{3} + {\hat{c}}^{†3} \hat{c} ) + {g}_{c , 3} ( {\hat{c}}^{3} + {\hat{c}}^{†3} + 3 {\hat{c}}^{†3} {\hat{c}}^{2} + 3 {\hat{c}}^{†2} \hat{c} ) + {g}_{c , 1} ( \hat{c} + {\hat{c}}^{†} ) + … . \qquad ( 38 )$$

The first row of the above expression takes the form of the coupler Hamiltonian in the approximation of the toy model of Sec. II, while the remaining rows contain counter-rotating terms to quartic order. Here, the parametric drive-dependent mode frequency and anharmonicity read

$$\begin{matrix}{ω}_{c} = \frac{4 {E}_{Cc}}{{η}_{c}} + \frac{1}{2} ℱ ( {η}_{c} ) {η}_{c} {E}_{Jc} , \\ {α}_{c} = - {E}_{Cc}\end{matrix} , \qquad ( 39 )$$

while the prefactors of the counter-rotating terms are

$${g}_{c , 3} = - αϵ {e}^{- \frac{{η}_{c}}{4}} {η}_{c}^{3 / 2} {J}_{0} ( {μ}_{α} δ ) sin ( {μ}_{α} {\overline{φ}}_{ext} ) {E}_{Jc} / ( 12 \sqrt{2} ) - \frac{β}{{N}^{2}} {e}^{- \frac{η c}{4 {N}^{2}}} {η}_{c}^{3 / 2} {J}_{0} ( {μ}_{β} δ ) sin ( {μ}_{β} {\overline{φ}}_{ext} ) {E}_{Jc} / ( 12 \sqrt{2} ) , \\ {g}_{c , 1} = αϵ {e}^{- \frac{{η}_{c}}{4}} {η}_{c}^{1 / 2} {J}_{0} ( {μ}_{α} δ ) sin ( {μ}_{α} {\overline{φ}}_{ext} ) {E}_{Jc} / \sqrt{2} + β {e}^{- \frac{{η}_{c}}{4 {N}^{2}}} {η}_{c}^{1 / 2} {J}_{0} ( {μ}_{β} δ ) sin ( {μ}_{β} {\overline{φ}}_{ext} ) {E}_{Jc} / \sqrt{2} . \qquad ( 40 )$$

The contribution from the oscillatory part \hat{\tilde{H}}_{c}(t) is too lengthy to be reproduced here, and is given up to the second harmonic of the parametric modulation frequency ω_{d} in Table IIA-B of Additional Section D.

Finally, the last term of the full circuit Hamiltonian to consider is the linear interaction induced by the capacitive coupling. Using Eq. (28), this Hamiltonian takes the form

$${\hat{H}}_{g} = - \frac{2 {E}_{Cab}}{\sqrt{{η}_{a} {η}_{b}}} ( \hat{a} - {\hat{a}}^{†} ) ( \hat{b} - {\hat{b}}^{†} ) + …$$

where the ellipsis represents two more terms corresponding to the cyclic permutations of the mode indices.

The Hamiltonian specified by Eqs. (32) and its equivalent for the b transmon mode, Eq. (38), the terms summarized in Table IIA-B of Additional Section D, and Eq. (41), form the basis of both the normal-mode analysis, and of the full-circuit numerical simulation performed in Sec. V.

### B. Black-Box Quantization Approach for Parametrically Activated Interactions

Building upon the above results, the procedure developed with the toy model in Sec. III B can be followed to obtain effective gate Hamiltonians under parametric modulations. Time-independent quadratic terms derived above are collected under Ĥ⁽⁰⁾. The linear coupling Ĥ_{g} of Eq. (41) from Ĥ⁽⁰⁾ is then eliminated through a normal-mode transformation

$$\begin{matrix}{\hat{H}}^{( 0 )} = {ω}_{a} {\hat{a}}^{†} \hat{a} + {ω}_{b} {\hat{b}}^{†} \hat{b} + {ω}_{c} {\hat{c}}^{†} \hat{c} + {\hat{H}}_{g} \\ ≡ {ω}_{α} {\hat{α}}^{†} \hat{α} + {ω}_{b} {\hat{b}}^{†} \hat{b} + {ω}_{c} {\hat{c}}^{†} \hat{c}\end{matrix} \qquad ( 42 )$$

The linear transformation is determined by a set of 18 hybridization coefficients that relate bare mode coordinates to normal mode coordinates (see Additional Section E for the procedure to compute these coefficients)

$${\hat{φ}}_{α} = {\sum }_{β = a , b , c} \frac{{u}_{α} β}{\sqrt{2}} ( \hat{β} + {\hat{β}}^{†} ) , \\ {\hat{n}}_{α} = {\sum }_{β = a , b , c} \frac{{u}_{α} β}{\sqrt{2}} ( \hat{β} - {\hat{β}}^{†} ) , \qquad ( 43 )$$

for α=a, b, c. The hybridization coefficients u_{αβ}, v_{αβ} depend on the amplitude of the parametric drive. As a result, drive effects such as the ac-Stark shift of the nonlinear oscillators are accounted for already at the level of the normal-mode decomposition of the circuit Hamiltonian.

In analogy with the treatment in Sec. II of the toy model, Ĥ⁽⁰⁾ is taken to be the unperturbed Hamiltonian with respect to which the interaction picture is defined. Primarily in order to keep the expressions more concise, the corrections analyzed in Sec. III C are neglected. With Ĥ⁽⁰⁾ the unperturbed Hamiltonian, the remaining interaction terms are λĤ⁽¹⁾(t)≡Ĥ−Ĥ⁽⁰⁾. Expressing these in the interaction picture with respect to Û₀=e^{-iĤ}^{⁽⁰⁾}^{t} as in Eq. (8):

$$λ {\hat{H}}_{I}^{( 1 )} ( t ) = {\hat{U}}_{0}^{†} ( t ) [ \hat{H} ( t ) - {\hat{H}}^{( 0 )} ] {\hat{U}}_{0} ( t ) , \qquad ( 44 )$$

which, as before, is decomposed into oscillatory and non-oscillatory parts.

As a first example, to realize a beam-splitter interaction, the first-order RWA Hamiltonian is obtained in the form of Eq. (19) for a modulation frequency that satisfies

$${ω}_{d} = {ω}_{b} - {ω}_{a} . \qquad ( 45 )$$

Importantly, as already mentioned, the right-hand side of the above definition depends implicitly on the drive frequency ω_{d}, since it is defined in terms of ac-Stark shifted normal-mode frequencies. Sec. V presents a numerical procedure to obtain the parametric drive frequency.

With this choice of modulation frequency, the effective Hamiltonian takes the form

$$λ {\hat{H}}_{I}^{( 1 )} = {J}_{ab}^{( 1 )} ( - i {\hat{a}}^{†} \hat{b} H . c . ) + \frac{{α}_{a}^{( 1 )}}{2} {\hat{a}}^{†2} {\hat{a}}^{2} + \frac{{α}_{b}^{( 1 )}}{2} {\hat{b}}^{†2} {\hat{b}}^{2} + \frac{{α}_{c}^{( 1 )}}{2} {\hat{c}}^{†2} {\hat{c}}^{2} + {X}_{ab}^{( 1 )} {\hat{a}}^{†} \hat{a} {\hat{b}}^{†} \hat{b} + {X}_{bc}^{( 1 )} {\hat{b}}^{†} \hat{b} {\hat{c}}^{†} \hat{c} + {X}_{ca}^{( 1 )} {\hat{c}}^{†} \hat{c} {\hat{a}}^{†} \hat{a} + {J}_{ab ; a}^{( 1 )} ( - i {\hat{a}}^{†} \hat{a} {\hat{a}}^{†} \hat{b} + H . c . ) + {J}_{ab ; b}^{( 1 )} ( - i {\hat{b}}^{†} \hat{b} {\hat{a}}^{†} \hat{b} + H . c . ) + {J}_{ab ; c}^{( 1 )} ( - i {\hat{c}}^{†} \hat{c} {\hat{a}}^{†} \hat{b} + H . c . ) + {K}_{ab}^{( 1 )} ( {\hat{a}}^{†2} {\hat{b}}^{2} + H . c . ) \qquad ( 46 )$$

In contrast to the effective gate Hamiltonian Eq. (19) obtained for the toy model, there are additional terms in the last four rows, namely photon-number-conditioned beam-splitter terms and a photon-pair beam-splitter term. The prefactors of the above Hamiltonian are

$${J}_{ab}^{( 1 )} = - \frac{{u}_{ca} {u}_{cb}}{\text{?}} αϵ {J}_{1} ( {μ}_{α} δ ) sin ( {μ}_{α} {\overline{φ}}_{ext} ) {E}_{Jc}^{( α )} \qquad ( 47 )$$

$${X}_{jk}^{( 1 )} = - \frac{1}{4} {\sum }_{i = a , b , c} {u}_{ij}^{2} {u}_{ik}^{2} {E}_{J , i}^{′} ,$$

$${J}_{ab ; j}^{( 1 )} = - \frac{{u}_{cj}^{2}}{4} {J}_{a , b}^{( 1 )} , for j = a , b , c ,$$

$${K}_{a , b}^{( 1 )} = - \frac{{u}_{ca}^{2} {u}_{cb}^{2}}{16} αϵ {J}_{2} ( {μ}_{α} δ ) cos ( {μ}_{α} {\overline{φ}}_{ext} ) {E}_{Jc}^{( α )} - \frac{{u}_{ca}^{2} {u}_{cb}^{2}}{16} \frac{β}{{N}^{3}} {J}_{2} ( {μ}_{β} δ ) cos ( {μ}_{β} {\overline{φ}}_{ext} ) {E}_{Jc}^{( β )}$$

$$wherein$$

$${E}_{Ja}^{′} ≡ {e}^{- \frac{{u}_{aa}^{2}}{4} - \frac{{u}_{ab}^{2}}{4} - \frac{{u}_{ac}^{2}}{4}} {E}_{Ja} , \qquad ( 48 )$$

$${E}_{Jb}^{′} ≡ {e}^{- \frac{{u}_{ba}^{2}}{4} - \frac{{u}_{bb}^{2}}{4} - \frac{{u}_{bc}^{2}}{4}} {E}_{Jb} ,$$

$${E}_{Jc}^{′} ≡ αϵ {J}_{0} ( {μ}_{α} δ ) cos ( {μ}_{α} {\overline{φ}}_{ext} ) {E}_{Jc}^{( α )} + ( \frac{β}{{N}^{3}} ) {J}_{0} ( {μ}_{β} δ ) cos ( {μ}_{β} {\overline{φ}}_{ext} ) {E}_{Jc}^{( β )}$$

$${E}_{Jc}^{( α )} ≡ {e}^{- \frac{{u}_{ca}^{2}}{4} - \frac{{u}_{cb}^{2}}{4} - \frac{{u}_{cc}^{2}}{4}} {E}_{Jc} ,$$

$${E}_{Jc}^{( β )} ≡ {e}^{- \frac{{u}_{ca}^{2}}{4 {N}^{2}} - \frac{{u}_{cb}^{2}}{4 {N}^{2}} - \frac{{u}_{cc}^{2}}{4 {N}^{2}}} {E}_{Jc}$$

$$\text{?} \text{indicates text missing or illegible when filed}$$

The above expressions depend on the drive both explicitly, through the Bessel functions, and implicitly, through the hybridization coefficients uⱼₖ. The first three lines of Eq. (47) are similar in form to those obtained for the toy model in Eqs. (20). Of the two additional classes of terms possible in the full circuit model at this order in perturbation theory, the photon-pair beam-splitter term, in the last row of Eq. (46), is generated by the second harmonic of the drive. However, since this term is fourth order in the hybridization coefficients, it can only become comparable to the beam-splitter interaction at vanishing external flux φ̅ₑₓₜ≈0, or if δ is set to cancel J_{ab}⁽¹⁾.

As in the case of the toy model, going to second order in perturbation theory using Eq. (14) corrections can be found to the coupling constants derived above to first order. To increase the accuracy of these calculations, the coupler phase variable is displaced by a canonical transformation \hat{φ}_{c}→\hat{φ}_{c}+φ_{c,cls}, where the time-independent real number φ_{c,cls} denotes the minimum of the static coupler potential in Eq. (2) resulting from

$$α {J}_{0} ( {μ}_{α} δϕ ) sin [ {φ}_{c , cls} + {μ}_{α} {\overline{φ}}_{ext} ] + β {J}_{0} ( {μ}_{β} δϕ ) sin [ \frac{{φ}_{c , cls}}{N} + {μ}_{β} {\overline{φ}}_{ext} ] = 0 \qquad ( 49 )$$

This displacement allows for the removal of all static terms which are linear in the coupler quadratures {\hat{φ}_{c}, \hat{n}_{c}}, before performing the normal-mode transformation. As such, these terms are accounted for exactly, and not as part of the perturbative expansion. Secondly, noting that parity-breaking terms significantly dress the coupler 0→1 transition frequency, this renormalization is absorbed into a reparametrization of the external flux φ̅ₑₓₜ→φ̅′ₑₓₜ(φ̅ₑₓₜ) such that ω_{c}(φ̅′ₑₓₜ)=ω_{c}⁽²⁾(φ̅ₑₓₜ), i.e., the corrections are observed to the coupler pole at second order in perturbation theory into a redefinition of the coupler normal mode, in a self-consistent approach that can be further validated with exact numerics.

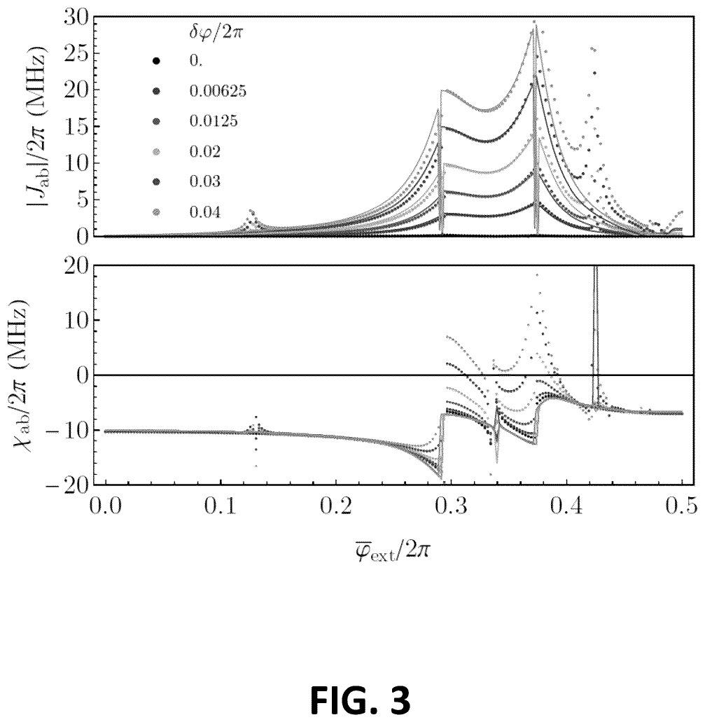

FIG. 3 shows a comparison between exact Floquet numerics (see Sec. V) and second-order perturbation theory for the full circuit model. The analytics reproduce with good accuracy the numerical results for the gate interaction rate J_{ab} in the region where the coupler 0→1 frequency lies between the two transmons: ωₐ<ω_{c}<ωₐ. There are poles in the numerical gate rate J_{ab} for ω_{c}<ωₐ or for ω_{b}<ω_{c} that are expected to capture only at third order in perturbation theory. The numerical cross-Kerr interaction, as in the case of the toy model, only agrees well with analytics in the static case δ_{φ}=0. Focusing attention on the curves obtained from Floquet numerics, with a typical set of parameters, gate rates as large as J_{ab}/2π˜20 MHz (equivalent to a 25 ns \sqrt{iSWAP} gate) can be achieved while maintaining a vanishing dynamical cross-Kerr interaction. The tools presented in this paper feed into a larger scale optimization of the circuit parameters, which forms the subject of a future study.

### Other Parametric Gates

The space of parametric gates is not limited to beam splitter-type, or red sideband, terms. Indeed, different interactions can be activated by appropriate choices of the frequency of the parametric drive [16, 51-57]. For example, if instead the modulation frequency targets the blue sideband,

$${ω}_{d} = {ω}_{a} + {ω}_{b} , \qquad ( 50 )$$

then the resulting interaction is a two-mode squeezing term. The effective gate Hamiltonian is formally the same as Eq. (46) with the simple modification

$${\hat{a}}^{†} \hat{b} \to {\hat{a}}^{†} {\hat{b}}^{†} , \qquad ( 51 )$$

in the first line and in the last four lines of Eq. (46). The coupling constants remain as in Eq. (47).

It is also possible to obtain a CNOT interaction induced by a parametric drive at ω_{d}=ωₐ, which makes the a transmon mode into the target mode of a cross-resonance protocol [30, 31]. Following the same procedure as in the preceding subsection, with this choice of modulation frequency the effective gate Hamiltonian is

$$λ {\overline{\hat{H}}}_{I}^{( 1 )} = - i {Ω}_{a ; b} ( \hat{a} - {\hat{a}}^{†} ) {\hat{b}}^{†} \hat{b} - i {Ω}_{a ; c} ( \hat{a} - {\hat{a}}^{†} ) {\hat{c}}^{†} \hat{c} - i {Ω}_{a} ( \hat{a} - {\hat{a}}^{†} ) - i {Ω}_{a ; a} ( {\hat{a}}^{†} \hat{a} \hat{a} - {\hat{a}}^{†} {\hat{a}}^{†} \hat{a} ) \qquad ( 52 )$$

The first term of above expression generates the cross-resonance gate, while the second term is a coupler-state conditional drive on mode a which is negligible for [symbol] ĉ^{†}ĉ [symbol] ≈0. On the other hand, the second row contains local operations on qubit a.

TABLE I
List of the most accessible gate Hamiltonians realizable
with a parametric drive in the analyzed architecture.

| | | | Dominant | |
|---|---|---|---|---|
| | Bosonic | Drive | unwanted | |
| Gate | operator | frequency | interaction | Equation |
| iSWAP/beam- | −iâ^{†}\hat{b} + | ωₐ + ω_{b} | â^{†}â\hat{b}^{†}\hat{b} | Eq. (46) |
| splitter | \hat{b}^{†}â | | | |
| Two-mode | −iâ^{†}\hat{b}^{†} + | ωₐ + ω_{b} | â^{†}â\hat{b}^{†}\hat{b} | Eqs. (46) |
| squeezing | \hat{b}â | | | and (51) |
| CZ/Ising-ZZ | a^{†}â\hat{b}^{†}\hat{b} | no drive | | Eq. (46) |
| CNOT | −i(â − | ωₐ | −i(â − | Eq. (52) |
| | â^{†})\hat{b}^{†}\hat{b} | | â^{†})â^{†}a | |
| CSWAP | −iĉ^{†}ĉ(â^{†}\hat{b} − | ωₐ − ω_{b} | −iâ^{†}\hat{b} + | Eq. (46) |
| | \hat{b}^{†}a) | | \hat{b}â | |

The coupling constants in Eq. (52) take the form

$${Ω}_{a} = {u}_{ca} {E}_{J , c}^{″} , {Ω}_{a ; a} = {u}_{ca}^{3} {E}_{J , c}^{″} / 2 \qquad ( 53 )$$

$${Ω}_{a ; b} = {u}_{ca} {u}_{cb}^{2} {E}_{J , c}^{′′′} , {Ω}_{a ; c} = {u}_{ca} {u}_{cc}^{2} {E}_{J , c}^{′′′} ,$$

$$wherein$$

$${E}_{J , c}^{″} = αϵ {J}_{1} ( {μ}_{α} δ ) cos ( {μ}_{α} {\overline{φ}}_{ext} ) {E}_{J , c}^{( α )} / \sqrt{2} \qquad ( 54 )$$

$${E}_{J , c}^{′′′} = - αϵ {J}_{1} ( {μ}_{α} δ ) cos ( {μ}_{α} {\overline{φ}}_{ext} ) {E}_{J , c}^{( α )} / \sqrt{2} - β {J}_{1} ( {μ}_{β} δ ) cos ( {μ}_{β} {\overline{φ}}_{ext} ) {E}_{J , c}^{( β )} / ( \sqrt{2} {N}^{2} )$$

While in the standard cross-resonance gate protocol the gate is activated by a microwave tone on one of the qubits [30, 31], here it is the coupler mode c that is parametrically driven. This protocol to achieve a CNOT gate is advantageous if the coupler mode is much more strongly coupled to the transmon modes a and b than their direct capacitive coupling. As in the standard cross-resonance protocol [31, 32], the CNOT gate rate Ω_{a;b} saturates as a function of the amplitude of the parametric drive, in this model due to the Bessel function dependence J₁(μ_{α,β}δ). Table I summarizes the different interactions that can be obtained for different choices of modulation frequencies.

### V. Floquet Numerics

Exact numerical Floquet methods can extract the effective gate Hamiltonian from quasienergy spectra. Floquet theory validates the results obtained using perturbation theory in Secs. III and IV C. On the other hand, this numerically exact method is applicable beyond the regime of validity of perturbation theory. This section first briefly introduce the method and the notation in Sec. V A and, as an example application, returns to the toy model to extract the cross-Kerr interaction χ_{ab} and the \sqrt{iSWAP} gate amplitude J_{ab}. These results show how to adjust the system parameters such as to cancel the dynamical cross-Kerr interaction during an \sqrt{iSWAP} gate. Then, in Sec. V B, the method is applied to the full circuit Hamiltonian. In particular, a numerical experiment is performed, which is analogous to two-tone spectroscopy for the parametrically driven circuit. For completeness, an introduction to Floquet theory is presented in Additional Section F.

A. Effective Hamiltonian from Floquet Spectra

The analysis starts from the observation that the effective Hamiltonian is unitarily equivalent to the Floquet Hamiltonian according to Eqs. (8) and (9), and therefore their quasienergy spectra (see Additional Section F) are identical. In the laboratory frame:

$${\hat{H}}_{eff} - i {\partial }_{t} = {e}^{- \hat{G} ( t )} [ \hat{H} ( t ) - i {\partial }_{t} ] {e}^{\hat{G} ( t )} \qquad ( 55 )$$

The perturbative expansion for e^{-Ĝ(t)}, and consequently that for Ĥ_{eff}, is therefore an iterative approach to finding the Floquet spectrum.

This section computes the Floquet spectrum exactly and shows how the parameters of the effective Hamiltonian can be extracted from it. Ac-Stark shifted normal mode frequencies, self- and cross-Kerr interactions, and gate amplitudes are formulated as linear combinations of appropriately identified eigenvalues of the Floquet Hamiltonian. For illustration, this subsection confines attention to the Floquet analysis of the toy model of Eq. (5).

To identify states in the Floquet quasienergy spectrum, eigenvectors are found that have a maximum overlap with a set of known, unperturbed states. The state |iₐi_{b}i_{c} [symbol] is be the eigenstate of the time-independent Schrödinger equation for the undriven Hamiltonian, that has maximum overlap with the Fock state |iₐ [symbol] |i_{b} [symbol] |i_{c} [symbol] , and its eigenenergy is denoted by Eᵢ_{ₐ}ᵢ_{_{b}}ᵢ_{_{c}}. Finally, |iₐi_{b}i_{c} [symbol] _{F} is defined as the Floquet eigenmode having maximum overlap with |iₐi_{b}i_{c} [symbol] , and its quasienergy is denoted with ∈ᵢ_{ₐ}ᵢ_{_{b}}ᵢ_{_{c}}. In what follows, sets are labeled by three integers as above, in the order a-b-c.

With these definitions, the gate amplitude Jab has a natural interpretation in the Floquet formalism. As shown above, the \sqrt{iSWAP} interaction arises in the toy model if

$${ω}_{d} = {ω}_{b} - {ω}_{a} ≡ {E}_{100} - {E}_{010} . \qquad ( 56 )$$

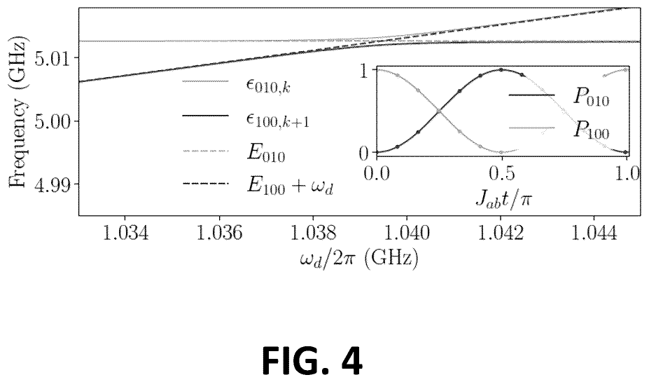

Since the parametric drive enters via a term proportional to ĉ^{†}ĉ, which couples the undriven eigenstates in the two-state manifold {|100 [symbol] , |010 [symbol] }, there is an avoided crossing between the Floquet modes |100; k=1 [symbol] _{F} and |010; k [symbol] _{F}, as shown in FIG. 4. Because the gate operation is analogous to Rabi oscillations in the two-state manifold {|100 [symbol] ,|010 [symbol] }, the size of the avoided crossing is twice the effective gate amplitude, 2J_{ab}. For example, if an excitation is originally prepared in the transmon b, then population dynamics would obey P₀₁₀(t)≡| [symbol] 010|ψ(t)|² [symbol] =sin²(J_{ab}t) and P₁₀₀=1−P₀₁₀, in full agreement with exact numerics (inset of FIG. 4). Away from the avoided crossing, the difference between the dressed states and the undriven states corresponds to the ac-Stark shift of the transmon normal modes due to the off-resonant drive.

Note that, in practice, the two-state manifold {|100 [symbol] , |010 [symbol] } is coupled by the drive to other levels. The resonant drive frequency ω_{d} is then slightly shifted from Eq. (56) due to the ac-Stark effect induced by these additional couplings, and the exact value can be determined numerically by minimizing the size of the anticrossing.

The dynamical cross-Kerr interaction χ_{ab} is written in terms of a Walsh transform [15] of the quasienergies

$${χ}_{ab} ( δ ) = {ϵ}_{110} - {ϵ}_{100} - {ϵ}_{010} + {ϵ}_{000} , \qquad ( 57 )$$

and reduces to the static cross-Kerr when the parametric drive is turned off:

$${χ}_{ab} ( 0 ) = {E}_{110} - {E}_{100} - {E}_{010} + {E}_{000} . \qquad ( 58 )$$

Along with J_{ab} and χ_{ab}, any ac-Stark-shifted quantity pertaining to the effective Hamiltonian can, in principle, be obtained by taking appropriate linear combinations of the quasienergies in the Floquet spectrum.

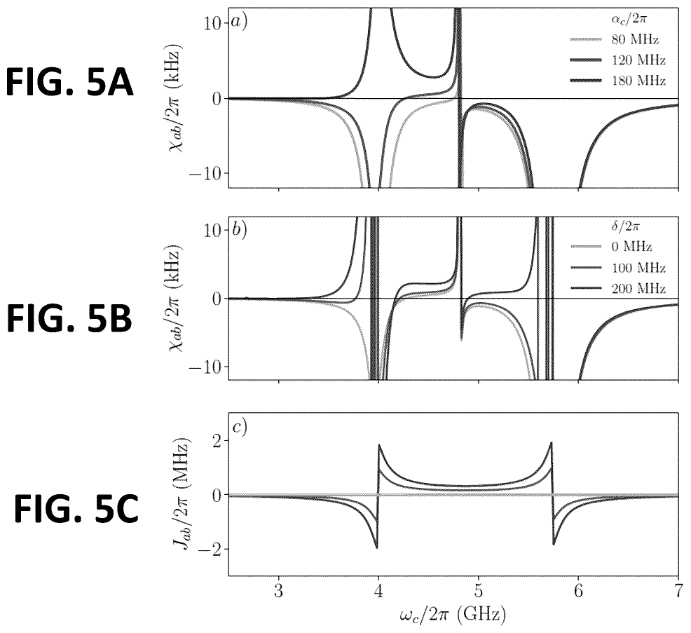

Since the Floquet quasienergy spectrum can be obtained from the propagator Û(2π/ω_{d}, 0) over one period of the drive (Additional Section F), the Floquet method is numerically efficient as compared to the simulation of the dynamics over the complete gate time. The period of the drive is on the order of 1 ns, which is between two and three orders of magnitude shorter than the gate times studied here. Due to its relatively small computational footprint, the Floquet method allows efficient searching for optimal gate parameters, e.g. a maximal J_{ab} with a minimal residual cross-Kerr interaction, χ_{ab}. As an example, FIG. 5 studies the behavior of J_{ab} and χ_{ab} as a function of the bare coupler frequency ω_{c} for different choices of drive amplitude, δ, and bare coupler anharmonicity, ac.

From these studies parameters can be found for which the cross-Kerr interaction χ_{ab} vanishes. As already mentioned, this is important to obtain high-fidelity two-qubit gates and relies on choosing a positive coupler anharmonicity, α_{c}. FIG. 5 shows that, while varying α_{c} does not affect J_{ab} to lowest order in perturbation theory, it has a considerable impact on χ_{ab}. Indeed, FIG. 5A shows the static χ_{ab} for multiple values of α_{c}, and illustrates that it is possible to fine-tune α_{c} to cancel χ_{ab}. It is observed empirically that whenever the bare anharmonicities obey αₐ⁻¹+α_{b}⁻¹+α_{c}⁻¹=0, one can find ω_{c} for which χ_{ab}=0.

For the dynamical cross-Kerr interaction χ_{ab} one observes complex variations with δ. The main resonances appear for ω_{c}≈ωₐ, ω_{b}, and (ωₐ+ω_{b})/2 but the slopes and the sign of χ_{ab} change and additional resonances appear away from the qubit frequencies, especially when the drive amplitude and coupling strengths g_{ab,ac} are sufficiently large. As illustrated in FIG. 5B by tuning the drive amplitude it is possible to find a bare coupler frequency, ω_{c}, for which the effective χ_{ab} (δ)=0. More-over, the cancellation of χ_{ab}(δ) can occur in the form of a ‘sweet spot’ where ∂χ_{ab}/∂δ≈0. On the other hand, as seen in FIG. 5C, the gate rate increases with δ without qualitative changes of its dependence on ω_{c}. Therefore, as the gate is turned on or off by varying δ, one can adjust the bare coupler frequency ω_{c}, to maintain the instantaneous χ_{ab} (δ)=0. This defines a cross-Kerr-free curve in the parameter space (ω_{c}, δ) connecting the ‘off’ point δ=0, χ_{ab}(0)=0, J_{ab} (0)=0 to the ‘on’ point δ≠0, χ_{ab}(δ)=0, J_{ab} (δ)≠0. This is studied in detail on the realistic full circuit model in Sec. V B.

### B. Full Circuit Simulation

In this section, the Floquet numerical method is applied to the full circuit Hamiltonian of Sec. IV A. The dependence of the coupling constants is studied in the effective gate Hamiltonian versus DC flux and as a function of the drive amplitude.

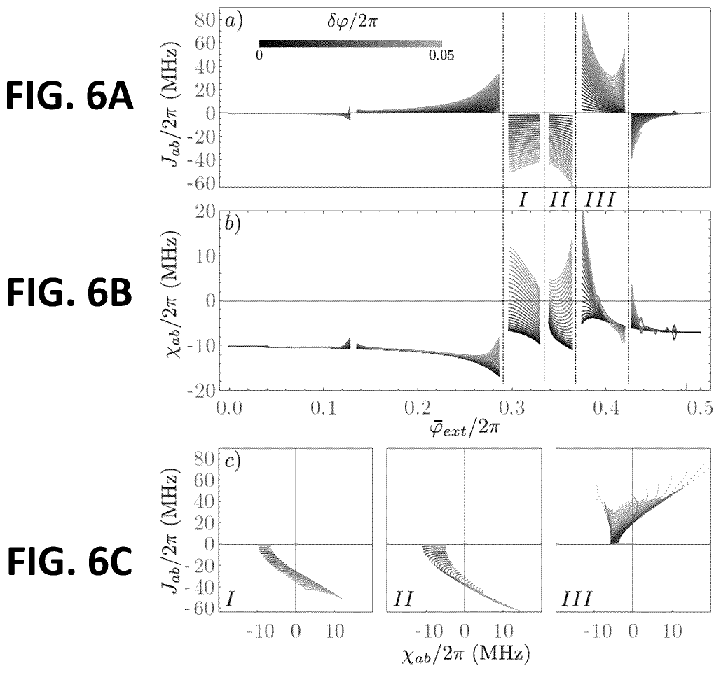

FIG. 6 shows the analogues of the plots in FIG. 5 for the gate amplitude J_{ab} (φ̅ₑₓₜ) and of the cross-Kerr χ_{ab} (φ̅ₑₓₜ) now for the full circuit Hamiltonian. State tracking is performed as described in the previous subsection. However, in the vicinity of avoided crossings, it is impossible to identify with certainty the states generated by the relatively large capacitive couplings considered here. Exclusion regions are introduced where state tracking is unreliable. Even though the tracking is expected to be complicated by the presence of counter-rotating terms coupling states with different photon numbers in the full device Hamiltonian of Sec. IV A, this is not a significant source of tracking error, as compared to errors due to large hybridization.

FIG. 6B represents χ_{ab} versus the DC-flux φ̅ₑₓₜt for different values of the flux drive amplitude. Unlike the toy model, χ_{ab} does not go to zero away from the qubit-coupler resonances. This is because the qubit-coupler detuning saturates as a function of φ̅ₑₓₜ, as opposed to the toy model where the detuning could be increased arbitrarily. In the undriven case (black), it is seen that for this set of device parameters there does not exist a flux value for which χ_{ab} vanishes. However, increasing the drive amplitude allows for an active cancellation of the dynamical χ_{ab} at some flux value. The corresponding behavior of J_{ab} is shown in FIG. 6A. In FIG. 6C, the numerical results are synthesized into three favorable regions of operation for the parametric gate, denoted I, II, and III, respectively [see FIG. 6A)]. These regions eliminate the external flux and plot directly the gate amplitude J_{ab} against the dynamical cross-Kerr interaction χ_{ab}. This allows determination of regimes of optimal \sqrt{iSWAP} gate operation. Accordingly, gate amplitudes as high as 40 MHz, corresponding to a gate time of 12.5 ns, can be achieved with vanishing cross-Kerr interaction for these parameter choices.

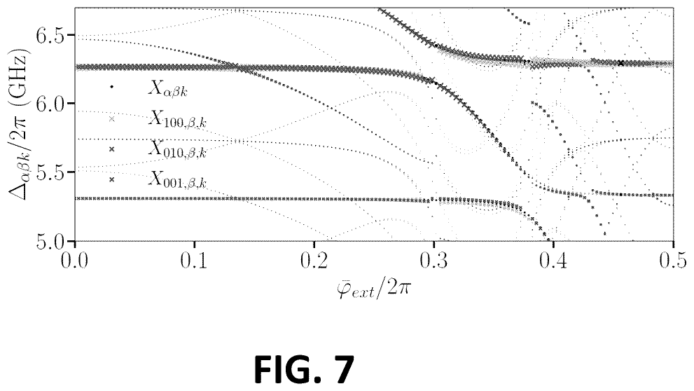

For both J_{ab} and χ_{ab} there exist peaks away from the qubit-coupler resonances, situated at φ̅ₑₓₜ/2π≈0.13, 0.42. These correspond to avoided crossings appearing in the driven Floquet spectrum, corresponding to the hybridization of Floquet levels involving distinct numbers of drive photons. For example, the Floquet level |100, k [symbol] _{F} can couple to the Floquet level |001, k−1 [symbol] _{F}. This can be seen by unfolding the Floquet spectrum in spectroscopy simulations (see FIG. 7).

To exemplify the full extent of the Floquet analysis, two-tone spectroscopy data from the simulations are generated according to Eqs. (F2) and (F3) in Additional Section F, by focusing on the experimentally relevant situation where the parametric drive is on, while the (second) probe tone acts on the bare charge operator \hat{n}ₐ. FIG. 7 represents the numerically computed spectrum close to the two qubit transition frequencies. The size of each point is proportional to the absolute value of the corresponding matrix element. The black dots correspond to transition frequencies in the undriven spectrum. As expected, the dot sizes are larger for the transitions involving the probed qubit a. The large, avoided crossings around φ̅ₑₓₜ/2π≈{0.32, 0.38} result from the capacitive couplings between the coupler and the qubits. Secondary avoided crossings appear between the coupler mode and the transmons near φ̅ₑₓₜ/2π≈{0.13, 0.42} in the driven spectrum, and are responsible for the secondary poles mentioned in the discussion of the coupling constants of the effective Hamiltonian, FIG. 6. Furthermore, as detailed in Additional Section G, counterrotating terms induce important corrections when attempting an accurate comparison with spectroscopic data from experiments.

In summary, two complementary methods are provided for the analysis of parametrically activated two-qubit gates, one based on analytical time-dependent Schrieffer-Wolff perturbation theory, and one based on numerical Floquet methods. Although the present disclosure has mostly focused on coupler-mediated parametric \sqrt{iSWAP} gates, a larger collection of gates can be generated in the same model Hamiltonian. The methods presented here allow efficient evaluation of the terms present in the effective gate Hamiltonian.

For the \sqrt{iSWAP} interaction, it has been shown that with experimentally accessible parameters, a gate frequency of ˜40 MHz corresponding to a gate time as short as 12.5 ns can be obtained with vanishing dynamical cross-Kerr interaction. This fast gate is achieved by working with large capacitive couplings between the qubits and the coupler, while cancelling the cross-Kerr interactions by setting the coupler anharmonicity to positive values, and choosing the right modulation amplitude. Optimization of realistic device parameters based on close agreements between the Floquet simulations and the experimental data will be published elsewhere [58].

The analytical method introduced here, which is based on a drive-dependent normal-mode expansion, is a computationally efficient strategy to organize the perturbation theory as compared to an energy eigenbasis calculation, since it allows to obtain the parameters of the effective Hamiltonian at lower orders in perturbation theory. Moreover, this strategy is suitable in the regime of comparatively large linear couplings, where the dispersive approximation breaks down. Nonetheless, higher orders in analytical perturbation theory are needed for full agreement with exact numerical results, especially for higher-order interactions, such as the dynamical cross-Kerr. Generating higher-order contributions efficiently using computer algebra techniques is the subject of future studies. On the other hand, this work indicates that Floquet numerical methods, as compared to full time-dynamics simulations, is a numerically efficient and exact method for minute optimization studies of parametric gates.

### Additional Section A: Time-Dependent Schrieffer-Wolff Transformation

To obtain equations for Ĝ₁(t), it is assumed that the generator can be expanded as a series in λ, that is

$${\hat{G}}_{I} ( t ) = λ {\hat{G}}_{I}^{( 1 )} ( t ) + {λ}^{2} {\hat{G}}_{I}^{( 2 )} ( t ) + … , \qquad ( A1 )$$

and collect powers of λ in the BCH expansion of Eq. (9)

$${e}^{- {\hat{G}}_{I}} ( {\hat{H}}_{I} - i {\partial }_{t} ) {e}^{{\hat{G}}_{I}} = λ {\hat{H}}_{I}^{( 1 )} - i λ {\dot{\hat{G}}}_{I}^{( 1 )} + [ λ {\hat{H}}_{I}^{( 1 )} , λ {G}_{I}^{( 1 )} ] - \frac{i}{2} [ i λ {\dot{\hat{G}}}_{I}^{( 1 )} , λ {G}_{I}^{( 1 )} ] - i {λ}^{2} {\dot{\hat{G}}}_{I}^{( 2 )} - i {\partial }_{t} + O ( {λ}^{3} ) \qquad ( A 2 )$$

The above expansion can be expressed compactly

$${e}^{- {\hat{G}}_{I}} ( {\hat{H}}_{I} - i {\partial }_{t} ) {e}^{{\hat{G}}_{I}} = {λ}^{k} {\sum }_{k = 1}^{∞} [ {\hat{H}}_{I}^{( 1 )} ( t ) - i {\dot{\hat{G}}}_{I}^{( k )} ] - i {\partial }_{t} . \qquad ( A3 )$$

Provided a prescription for λ^{k}Ĝₗ^{(k)}(t), the following is a recursive way of determining higher-order corrections to the interaction Hamiltonian: knowledge of λĤₗ⁽¹⁾(t) allows one to determine λ²Ĥₗ⁽²⁾, then λĤₗ⁽³⁾ etc.

The k^{th} order term in the generator, λ^{k}Ĝₗ^{(k)}(t), is determined by the condition that the Hamiltonian be free of oscillatory terms of order λ^{k} or less. This condition can be formulated explicitly if written as in Eq. (11),

$${λ}^{k} {\hat{H}}_{I}^{( k )} ( t ) = {λ}^{k} {\overline{\hat{H}}}_{I}^{( k )} + {λ}^{k} {\tilde{\hat{H}}}_{I}^{( k )} ( t ) \qquad ( A4 )$$

Then oscillatory terms λ\hat{\tilde{H}}ₗ^{(k)}I are canceled for every k if

$${λ}^{k} {\hat{G}}_{I}^{( k )} ( t ) = \frac{1}{i} {\int }_{0}^{t} {λ}^{k} {\tilde{\hat{H}}}_{I}^{( k )} ( t ) \qquad ( A5 )$$

Note that, in the above expression, the boundary condition Ĝₗ^{(k)}(0)=0 is imposed by specifying the lower limit of the integration. Noting that Eq. (A5) implies

$${λ}^{k} {\tilde{\hat{G}}}_{I}^{( k )} ( t ) = \frac{1}{i} {\int }^{t} {λ}^{k} {\tilde{\hat{H}}}_{I}^{( k )} ( t ) , \qquad ( A6 )$$

$${λ}^{k} {\overline{\hat{G}}}_{I}^{( k )} ( t ) = {\frac{1}{i} [ {\int }^{t} {λ}^{k} {\tilde{\hat{H}}}_{I}^{( k )} ( t ) ]}_{t = 0}$$

The DC part of the generator, λ^{k}\hat{G̅}₁^{(k)}, is non-vanishing here as a result of the boundary condition in Eq. (A5), as opposed to the zero time-average property of kick operators, to which the generator studied here is related[46].

With the above formalism in place, perturbative corrections can be computed. From Eq. (9) and the λ² correction identified to the interaction-picture Hamiltonian

$${λ}^{2} {\hat{H}}_{I}^{( 2 )} ( t ) = [ λ {\hat{H}}_{I}^{( 1 )} , λ {\hat{G}}_{I}^{( 1 )} ] - \frac{i}{2} [ λ {\dot{\hat{G}}}_{I}^{( 1 )} , λ {\hat{G}}_{I}^{( 1 )} ] . \qquad ( A7 )$$

Going ahead and solving the RWA condition in Eq. (A5) at order λ¹, the order-λ² RWA Hamiltonian is

$${λ}^{2} {\overline{\hat{H}}}_{I}^{( 2 )} = \frac{1}{i} \overline{[ {\overline{\hat{H}}}_{I}^{( 1 )} , {\int }_{0}^{t} λ {\tilde{\hat{H}}}_{I}^{( 1 )} ( t ) {dt}^{′} ]} + \frac{1}{2 i} \overline{[ {\overline{\hat{H}}}_{I}^{( 1 )} ( t ) , {\int }_{0}^{t} λ {\tilde{\hat{H}}}_{I}^{( 1 )} ( {t}^{′} ) {dt}^{′} ]} . \qquad ( A8 )$$

This procedure can be iterated to higher orders, with increasing complexity due to the proliferation of terms from nested commutators in the BCH expansion.

### Additional Section B: Circuit Quantization

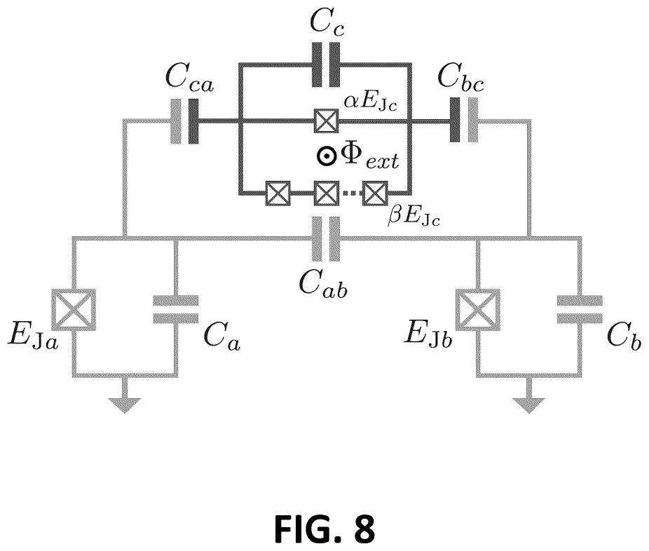

In this Additional Section, the model Hamiltonian of Eq. (1) can be derived from the circuit Lagrangian corresponding to FIG. 8. Assuming the individual modes of the junction array have small impedance, guaranteed by sufficiently large Josephson energy, the junction array can be de-scribed by an effective one-dimensional Lagrangian where the total phase difference across the array is spread evenly through the junctions. The effective one-dimensional Lagrangian associated with the bare coupler mode is

$${ℒ}_{c} = {\sum }_{k = α , β} \frac{{C}_{k}}{2} {\dot{ϕ}}_{k}^{2} + α {E}_{Jc} cos [ {φ}_{α} ] + β {NE}_{J c} cos [ \frac{{φ}_{β}}{N} ] , \qquad ( B1 )$$

where ϕ_{α} is the branch flux across the small junction and the shunt capacitor with total capacitance C_{α}ϕ_{β} is the branch flux across the junction array with effective capacitance C_{β}, and φₖ=2πϕₖ/Φ₀ are the associated reduced phase variables, and Φ₀ is the superconducting flux quantum. The phases φ_{α} and φ_{β} are constrained by the fluxoid quantization, φ_{α}+φ_{β}=φₑₓₜ. New coordinates can be defined as:

$${φ}_{α} = {φ}_{c} + {μ}_{α} {φ}_{ext} , \qquad ( B2 )$$

$${φ}_{β} = - {φ}_{c} - N {μ}_{β} {φ}_{ext} ,$$

with μ_{α}−Nμ_{β}=1, such that the capacitive energy in the Lagrangian is now purely quadratic in \dot{ϕ}_{c}. Therefore C_{α}μ_{α}+C_{β}Nμ_{β}=0 is required.

$${μ}_{α} = \frac{{C}_{β}}{{C}_{α} + {C}_{α}} , \qquad ( B3 )$$

$${μ}_{β} = - \frac{1}{N} \frac{{C}_{α}}{{C}_{α} + {C}_{β}} .$$

Up to time-dependent scalar terms,

$${ℒ}_{c} = \frac{{C}_{c}}{2} {\dot{ϕ}}_{c}^{2} + α {E}_{J c} cos [ {φ}_{c} + {μ}_{α} {φ}_{ext} ] + β {NE}_{Jc} cos [ \frac{{φ}_{c}}{N} + {μ}_{α} {φ}_{ext} ] \qquad ( B4 )$$

Moreover, for the two bare transmon modes j=a, b the Lagrangian reads

$${ℒ}_{c} = \frac{{C}_{c}}{2} {\dot{φ}}_{c}^{2} + {E}_{Jj} cos {φ}_{j} . \qquad ( B5 )$$

The total Lagrangian of the system then takes the form

$$ℒ = {ℒ}_{a} + {ℒ}_{b} + {ℒ}_{c} + {ℒ}_{g} , \qquad ( B6 )$$

where the capacitive coupling is introduced between the three bare modes

$${ℒ}_{g} = \frac{{C}_{ab}}{2} {\dot{ϕ}}_{a} {\dot{ϕ}}_{b} + \frac{{C}_{bc}}{2} {\dot{ϕ}}_{b} {\dot{ϕ}}_{c} + \frac{{C}_{ca}}{2} {\dot{ϕ}}_{c} {\dot{ϕ}}_{a} . \qquad ( B7 )$$

### Additional Section C: Perturbation Theory for the Toy Model

In this section, expressions for the cross-Kerr interaction obtained to reproduce second-order in perturbation theory for the toy model. The full expression of the second-order RWA correction to the cross-Kerr interaction in Sec. III B reads

$${χ}_{a , b , S ec . IIIB}^{( 2 )} = \frac{4 {( {\sum }_{j = a , b , c} {u}_{aj}^{2} {u}_{bj} {u}_{cj} {α}_{j} )}^{2}}{{ω}_{b} - {ω}_{c}} + \frac{4 {( {\sum }_{j = a , b , c} {u}_{aj} {u}_{bj}^{2} {u}_{cj} {α}_{j} )}^{2}}{{ω}_{a} - {ω}_{c}} + \frac{2 {( {\sum }_{j = a , b , c} {u}_{aj} {u}_{bj} {u}_{cj}^{2} {α}_{j} )}^{2}}{{ω}_{a} + {ω}_{b} - 2 {ω}_{c}} - \frac{2 {( {\sum }_{j = a , b , c} {u}_{aj}^{3} {u}_{bj} {α}_{j} )}^{2}}{{ω}_{a} - {ω}_{b}} + \frac{2 {( {\sum }_{j = a , b , c} {u}_{aj} {u}_{bj}^{3} {α}_{j} )}^{2}}{{ω}_{a} - {ω}_{b}} + \frac{{u}_{a c} {u}_{bc} {\sum }_{j = a , b , c} {u}_{aj} {u}_{bj} ( {u}_{aj}^{2} - {u}_{bj}^{2} )}{{ω}_{a} - {ω}_{b}} δ . \qquad ( C1 )$$

The second-order correction to the static cross-Kerr interaction as calculated in Sec. III C is:

$${χ}_{a , b , se c . IIIc}^{( 2 )} = \frac{4 {( {\sum }_{j = a , b , c} {u}_{aj}^{2} {u}_{bj} {u}_{cj} {α}_{j} )}^{2}}{{ω}_{b} - {ω}_{c} + {\sum }_{j = a , b , c} 2 {u}_{aj}^{2} ( {u}_{bj}^{2} - {u}_{cj}^{2} ) {α}_{j}} + \frac{4 {( {\sum }_{j = a , b , c} {u}_{aj} {u}_{bj}^{2} {u}_{cj} {α}_{j} )}^{2}}{{ω}_{a} - {ω}_{c} + {\sum }_{j = a , b , c} 2 {u}_{bj}^{2} ( {u}_{aj}^{2} - {u}_{cj}^{2} ) {α}_{j}} + \frac{2 {( {\sum }_{j = a , b , c} {u}_{aj} {u}_{bj} {c}_{cj}^{2} {α}_{j} )}^{2}}{{ω}_{a} + {ω}_{b} - 2 {ω}_{c} + ( 2 {u}_{aj}^{2} {u}_{bj}^{2} - {u}_{cj}^{4} ) {α}_{j}} - \frac{2 {( {\sum }_{j = a , b , c} {u}_{aj}^{3} {u}_{bj} {α}_{j} )}^{2}}{{ω}_{a} - {ω}_{b} {\sum }_{j = a , b , c} ( {u}_{aj}^{4} - 2 {u}_{aj}^{2} {u}_{bj}^{2} ) {α}_{j}} + \frac{2 {( {\sum }_{j = a , b , c} {u}_{aj} {u}_{bj}^{3} {α}_{j} )}^{2}}{{ω}_{a} - {ω}_{b} {\sum }_{j = a , b , c} ( 2 {u}_{aj}^{2} {u}_{bj}^{2} - {u}_{cj}^{4} ) {α}_{a}} . \qquad ( C2 )$$

The expression for the dynamical cross-Kerr interaction, χ_{a,b,Sec.IIIC}⁽²⁾ at δ≠0, is available from the formalism, but it is too lengthy to be reproduced here. In the main text, an evaluation of this expression is used in making direct comparisons to exact numerics.

### Additional Section D: Details for Full Circuit Hamiltonian

This Additional Section records a number of results used in Sec. IV, in particular the formulae used for normal-ordered expansions in Additional Section D 1, and the time-dependent terms in the coupler Hamiltonian in Additional Section D 2.

Normal-ordered expansions of trigonometric functions. Jacobi-Anger expansions Sine and cosine are expanded in normal order using the following two expressions [59] [recall that \hat{φ}ₐ=\sqrt{ηₐ/2}(â+â^{†})]

$$cos {\hat{φ}}_{a} = {e}^{- \frac{{η}_{a}}{4}} {{\sum }_{m , n \geq 0}}_{m + n = even} \frac{{( - \frac{{η}_{a}}{2} )}^{\frac{m + n}{2}} {\hat{a}}^{† m} {\hat{a}}^{n}}{m ! n !} , \qquad ( D1 )$$

$$sin {\hat{φ}}_{a} = {e}^{- \frac{{η}_{a}}{4}} \sqrt{\frac{{η}_{a}}{2}} {{\sum }_{m , n \geq 0}}_{m + n = odd} \frac{{( - \frac{{η}_{a}}{2} )}^{\frac{m + n + 1}{2}} {\hat{a}}^{† m} {\hat{a}}^{n}}{m ! n !} ,$$

with analogous expressions for the operators b and c.

### 2. Time-Dependent Terms in the Coupler Hamiltonian

Terms corresponding to the Jacobi-Anger expansion up to the second harmonic of the drive in the bare coupler Hamiltonian \hat{\tilde{H}}_{c}(t) in Sec. IV are listed in Table IIA-B. The operator monomial at the beginning of each row is to be multiplied by the sum of the two following columns, and then results from all rows are to be summed. The coefficients of the missing monomials ĉ, ĉ², ĉ³, ĉ^{†ĉ}², ĉ⁴, ĉ^{†}ĉ³ are obtained by Hermitian conjugation.

TABLE II-A
Time-dependent terms, up to quartics, in the bare coupler Hamiltonian.

| Monomial | J₁(δ) |
|---|---|
| ĉ^{†} | $\sqrt{2} αϵ {e}^{- \frac{{η}_{c}}{4}} \sqrt{{η}_{c}} {E}_{Jc} {J}_{1} ( {δμ}_{α} ) sin ( t {ω}_{d} ) cos ( {μ}_{α} {\overline{φ}}_{ext} ) + \sqrt{2} β {Ne}^{- \frac{{η}_{c}}{4 {N}^{2}}} \sqrt{\frac{{η}_{c}}{{N}^{2}}} {E}_{Jc} {J}_{1} ( {δμ}_{β} ) sin ( t {ω}_{d} ) cos ( {μ}_{β} {\overline{φ}}_{ext} )$ |
| ĉ^{†}ĉ^{†} | $- \frac{1}{2} αϵ {e}^{- \frac{{η}_{c}}{4}} {η}_{c} {E}_{Jc} {J}_{1} ( {δμ}_{α} ) sin ( t {ω}_{d} ) sin ( {μ}_{α} {\overline{φ}}_{ext} ) - \frac{{βη}_{c} {e}^{- \frac{{η}_{c}}{4 {N}^{2}}} {E}_{Jc} {J}_{1} ( {δμ}_{β} ) sin ( t {ω}_{d} ) sin ( {μ}_{β} {\overline{φ}}_{ext} )}{N}$ |
| ĉ^{†}ĉ | $- αϵ {e}^{- \frac{{η}_{c}}{4}} {η}_{c} {E}_{Jc} {J}_{1} ( {δμ}_{α} ) sin ( t {ω}_{d} ) sin ( {μ}_{α} {\overline{φ}}_{ext} ) - \frac{{βη}_{c} {e}^{- \frac{{η}_{c}}{4 {N}^{2}}} {E}_{Jc} {J}_{1} ( {δμ}_{β} ) sin ( t {ω}_{d} ) sin ( {μ}_{β} {\overline{φ}}_{ext} )}{N}$ |
| ĉ^{†}ĉ^{†}ĉ^{†} | $- \frac{αϵ {e}^{- \frac{{η}_{c}}{4}} {η}_{c}^{3 / 2} {E}_{Jc} {J}_{1} ( {δμ}_{α} ) sin ( t {ω}_{d} ) cos ( {μ}_{α} {\overline{φ}}_{ext} )}{6 \sqrt{2}} - \frac{{βη}_{c} {e}^{- \frac{{η}_{c}}{4 {N}^{2}}} \sqrt{\frac{{η}_{c}}{{N}^{2}}} {E}_{Jc} {J}_{1} ( {δμ}_{β} ) sin ( t {ω}_{d} ) cos ( {μ}_{β} {\overline{φ}}_{ext} )}{6 \sqrt{2} N}$ |
| ĉ^{†}ĉ^{†}ĉ | $- \frac{αϵ {e}^{- \frac{{η}_{c}}{4}} {η}_{c}^{3 / 2} {E}_{Jc} {J}_{1} ( {δμ}_{α} ) sin ( t {ω}_{d} ) cos ( {μ}_{α} {\overline{φ}}_{ext} )}{2 \sqrt{2}} - \frac{{βη}_{c} {e}^{- \frac{{η}_{c}}{4 {N}^{2}}} \sqrt{\frac{{η}_{c}}{{N}^{2}}} {E}_{Jc} {J}_{1} ( {δμ}_{β} ) sin ( t {ω}_{d} ) cos ( {μ}_{β} {\overline{φ}}_{ext} )}{2 \sqrt{2} N}$ |
| ĉ^{†}ĉ^{†}ĉ^{†}ĉ^{†} | $\frac{1}{48} αϵ {e}^{- \frac{{η}_{c}}{4}} {η}_{c}^{2} {E}_{Jc} {J}_{1} ( {δμ}_{α} ) sin ( t {ω}_{d} ) sin ( {μ}_{α} {\overline{φ}}_{ext} ) + \frac{{βη}_{c}^{2} {e}^{- \frac{{η}_{c}}{4 {N}^{2}}} {E}_{Jc} {J}_{1} ( {δμ}_{β} ) sin ( t {ω}_{d} ) sin ( {μ}_{β} {\overline{φ}}_{ext} )}{48 {N}^{3}}$ |
| ĉ^{†}ĉ^{†} [symbol] ĉ^{†} | $\frac{1}{12} αϵ {e}^{- \frac{{η}_{c}}{4}} {η}_{c}^{2} {E}_{Jc} {J}_{1} ( {δμ}_{α} ) sin ( t {ω}_{d} ) sin ( {μ}_{α} {\overline{φ}}_{ext} ) + \frac{{βη}_{c}^{2} {e}^{- \frac{{η}_{c}}{4 {N}^{2}}} {E}_{Jc} {J}_{1} ( {δμ}_{β} ) sin ( t {ω}_{d} ) sin ( {μ}_{β} {\overline{φ}}_{ext} )}{12 {N}^{3}}$ |
| ĉ^{†}ĉ^{†}ĉĉ | $+ \frac{1}{8} αϵ {e}^{- \frac{{η}_{c}}{4}} {η}_{c}^{2} {E}_{Jc} {J}_{1} ( {δμ}_{α} ) sin ( t {ω}_{d} ) sin ( {μ}_{α} {\overline{φ}}_{ext} ) + \frac{{βη}_{c}^{2} {e}^{- \frac{{η}_{c}}{4 {N}^{2}}} {E}_{Jc} {J}_{1} ( {δμ}_{β} ) sin ( t {ω}_{d} ) sin ( {μ}_{β} {\overline{φ}}_{ext} )}{8 {N}^{3}}$ |

TABLE II-B
Time-dependent terms, up to quartics, in the bare coupler Hamiltonian.

| Monomial | J₂(δ) |
|---|---|
| ĉ^{†} | $\sqrt{2} αϵ {e}^{- \frac{{η}_{c}}{4}} \sqrt{{η}_{c}} {E}_{Jc} {J}_{2} ( {δμ}_{α} ) cos ( 2 t {ω}_{d} ) sin ( {μ}_{α} {\overline{φ}}_{ext} ) + \sqrt{2} β {Ne}^{- \frac{{η}_{c}}{4 {N}^{2}}} \sqrt{\frac{{η}_{c}}{{N}^{2}}} {E}_{Jc} {J}_{2} ( {δμ}_{β} ) cos ( 2 t {ω}_{d} ) sin ( {μ}_{β} {\overline{φ}}_{ext} )$ |
| ĉ^{†}ĉ^{†} | $\frac{1}{2} αϵ {e}^{- \frac{{η}_{c}}{4}} {η}_{c} {E}_{Jc} {J}_{2} ( {δμ}_{α} ) cos ( 2 t {ω}_{d} ) cos ( {μ}_{α} {\overline{φ}}_{ext} ) + \frac{{βη}_{c} {e}^{- \frac{{η}_{c}}{4 {N}^{2}}} {E}_{Jc} {J}_{2} ( {δμ}_{β} ) cos ( 2 t {ω}_{d} ) cos ( {μ}_{β} {\overline{φ}}_{ext} )}{2 N}$ |
| ĉ^{†}ĉ | $+ αϵ {e}^{- \frac{{η}_{c}}{4}} {η}_{c} {E}_{Jc} {J}_{2} ( {δμ}_{α} ) cos ( 2 t {ω}_{d} ) cos ( {μ}_{α} {\overline{φ}}_{ext} ) + \frac{{βη}_{c} {e}^{- \frac{{η}_{c}}{4 {N}^{2}}} {E}_{Jc} {J}_{2} ( {δμ}_{β} ) cos ( 2 t {ω}_{d} ) cos ( {μ}_{β} {\overline{φ}}_{ext} )}{N}$ |
| ĉ^{†}ĉ^{†}ĉ^{†} | $- \frac{αϵ {e}^{- \frac{{η}_{c}}{4}} {η}_{c}^{3 / 2} {E}_{Jc} {J}_{2} ( {δμ}_{α} ) cos ( 2 t {ω}_{d} ) sin ( {μ}_{α} {\overline{φ}}_{ext} )}{6 \sqrt{2}} - \frac{{βη}_{c} {e}^{- \frac{{η}_{c}}{4 {N}^{2}}} \sqrt{\frac{{η}_{c}}{{N}^{2}}} {E}_{Jc} {J}_{2} ( {δμ}_{β} ) cos ( 2 t {ω}_{d} ) sin ( {μ}_{β} {\overline{φ}}_{ext} )}{6 \sqrt{2} N}$ |
| ĉ^{†}ĉ^{†}ĉ | $- \frac{α ϵ {e}^{- \frac{{η}_{c}}{4}} {η}_{c}^{3 / 2} {E}_{Jc} {J}_{2} ( {δμ}_{α} ) cos ( 2 t {ω}_{d} ) sin ( {μ}_{α} {\overline{φ}}_{ext} )}{2 \sqrt{2}} - \frac{{βη}_{c} {e}^{- \frac{{η}_{c}}{4 {N}^{2}}} \sqrt{\frac{{η}_{c}}{{N}^{2}}} {E}_{Jc} {J}_{2} ( {δμ}_{β} ) cos ( 2 t {ω}_{d} ) sin ( {μ}_{β} {\overline{φ}}_{ext} )}{2 \sqrt{2} N}$ |
| ĉ^{†}ĉ^{†}ĉ^{†}ĉ^{†} | $- \frac{1}{48} αϵ {e}^{- \frac{{η}_{c}}{4}} {η}_{c}^{2} {E}_{Jc} {J}_{2} ( {δμ}_{α} ) cos ( 2 t {ω}_{d} ) cos ( {μ}_{α} {\overline{φ}}_{ext} ) - \frac{{βη}_{c}^{2} {e}^{- \frac{{η}_{c}}{4 {N}^{2}}} {E}_{Jc} {J}_{2} ( {δμ}_{β} ) cos ( 2 t {ω}_{d} ) cos ( {μ}_{β} {\overline{φ}}_{ext} )}{48 {N}^{3}}$ |
| ĉ^{†}ĉ^{†} [symbol] ĉ^{†} | $- \frac{1}{12} αϵ {e}^{- \frac{{η}_{c}}{4}} {η}_{c}^{2} {E}_{Jc} {J}_{2} ( {δμ}_{α} ) cos ( 2 t {ω}_{d} ) cos ( {μ}_{α} {\overline{φ}}_{ext} ) - \frac{{βη}_{c}^{2} {e}^{- \frac{{η}_{c}}{4 {N}^{2}}} {E}_{Jc} {J}_{2} ( {δμ}_{β} ) cos ( 2 t {ω}_{d} ) cos ( {μ}_{β} {\overline{φ}}_{ext} )}{12 {N}^{3}}$ |
| ĉ^{†}ĉ^{†}ĉĉ | $- \frac{1}{8} αϵ {e}^{- \frac{{η}_{c}}{4}} {η}_{c}^{2} {E}_{Jc} {J}_{2} ( {δμ}_{α} ) cos ( 2 t {ω}_{d} ) cos ( {μ}_{α} {\overline{φ}}_{ext} ) - \frac{{βη}_{c}^{2} {e}^{- \frac{{η}_{c}}{4 {N}^{2}}} {E}_{Jc} {J}_{2} ( {δμ}_{β} ) cos ( 2 t {ω}_{d} ) cos ( {μ}_{β} {\overline{φ}}_{ext} )}{8 {N}^{3}}$ |

### Additional Section E: Normal-Mode Transformation

Sec. IV made use of a normal mode transformation that eliminates the off-diagonal capacitive coupling terms from the time-independent quadratic Hamiltonian. This section provides the steps to obtain the normal mode coefficients.

Consider the quadratic form (repeated indices are summed over):

$$\hat{H} = {A}_{αβ} {\hat{\overline{n}}}_{α} {\hat{\overline{n}}}_{β} + {B}_{αβ} {\hat{\overline{φ}}}_{α} {\hat{\overline{φ}}}_{β} . \qquad ( E1 )$$

A simplification can be made by assuming that there are no off-diagonal inductive terms, B_{αβ}∝δ_{αβ}, which is valid for the circuit studied here. The diagonalization involves three steps:

Step 1. Rescale the variables so that the diagonal part of the Hamiltonian, the inductive part, contains terms with the same inductive energy. For this, define the square root of the product of the inductive energies B=(Π_{α}B_{αα})^{1/2} and the dimensionless coefficients f_{α}=B/B_{αα}. Then new canonically-conjugate coordinates:

$${φ}_{α}^{′} = {f}_{α}^{- 1} {\hat{\overline{φ}}}_{α} , {\hat{n}}_{α}^{′} = {f}_{α}^{- 1} {\hat{\overline{n}}}_{α} . \qquad ( E2 )$$

In terms of the new coordinates, and letting A′_{αβ}=A_{αβ}/(f_{α}f_{β}) (no implicit summation),

$$\hat{H} = {A}_{αβ}^{′} {\hat{n}}_{α}^{′} {\hat{n}}_{β}^{′} + B {δ}_{αβ} {\hat{φ}}_{α}^{′} {\hat{φ}}_{β}^{′} . \qquad ( E3 )$$

Step 2. Diagonalize the capacitive coupling matrix A′. It is assumed here that this is possible and is achieved by an orthonormal matrix S, such that

$${A}_{αβ}^{′} = {( {S}^{T} )}_{αμ} {D}_{μ v} {S}_{v β} = {S}_{μα} {D}_{μ v} {S}_{v β} , \qquad ( E4 )$$

with D_{μv} a diagonal matrix. Rewriting the above as A′_{αβ}(S^{T})_{βγ}=(S^{T})_{αμ}D_{μv}S_{vβ}(S^{T})_{βγ}, or A′·S^{T}=S^{T}·D, then the matrix S contains the eigen-vectors of A′ on its rows. This diagonalization leads to

$$\hat{H} = {S}_{μα} {D}_{μ v} {S}_{v β} {\hat{n}}_{α}^{′} {\hat{n}}_{β}^{′} + B {δ}_{αβ} {\hat{φ}}_{α}^{′} {\hat{φ}}_{β}^{′} \qquad ( E5 )$$

Inspecting the first term, new coordinates are defined as

$${\hat{n}}_{μ}^{″} = {S}_{μα} {{\hat{n}}^{′}}_{α} , {\hat{φ}}_{μ}^{″} = {S}_{μ a} {\hat{φ}}_{α}^{′} \qquad ( E6 )$$

One can verify that the new double-primed coordinates are canonically conjugate because the transformation is orthonormal: [\hat{n}_{μ}″,\hat{φ}ᵥ″]=S_{μα}S_{vβ}[\hat{n}_{α}′,\hat{φ}_{β}′]=iS_{μα}S_{vβ}δ_{αβ}=iS_{μα}S_{vα}=iδ_{μv}. With this, obtain a diagonal form for the Hamiltonian

$$\hat{H} = {\hat{n}}_{α}^{″} {D}_{αβ} {\hat{n}}_{β}^{″} + B {δ}_{αβ} {\hat{φ}}_{α}^{″} {\hat{φ}}_{β}^{″} \qquad ( E7 )$$

wherein the second term used the fact that the orthogonal transformation preserves the inner product.

Step 3. Finally, undo the rescaling transformation of Step 1. That is, introduce a third and last pair of canonically conjugate coordinates, the normal-mode coordinates

$${\hat{φ}}_{α} = {f}_{α} {φ}_{α}^{″} , {\hat{n}}_{α} {f}_{α}^{- 1} {\hat{n}}_{α}^{″} . \qquad ( E8 )$$

At last the quadratic Hamiltonian reads

$$\hat{H} = {\hat{n}}_{α} {f}_{α} {f}_{β} {D}_{αβ} {\hat{n}}_{β} + \frac{B {δ}_{α β}}{{f}_{α} {f}_{β}} {\hat{φ}}_{α} {\hat{φ}}_{β} = {\hat{n}}_{α} {f}_{α} {f}_{β} {D}_{αβ} {\hat{n}}_{β} + {\hat{φ}}_{α} {B}_{αβ} {\hat{φ}}_{β} \qquad ( E9 )$$

This is the final normal-mode Hamiltonian.

Hybridization coefficients. It is helpful to summarize the normal mode transformation by skipping over the intermediate variables (primed, and double-primed). For this invert the definitions of the intermediate coordinates to obtain

$$\begin{matrix}{\hat{\overline{φ}}}_{α} = {\sum }_{β} {f}_{α} {S}_{βα} {f}_{β}^{- 1} {\hat{φ}}_{β} ≡ {\sum }_{β} {U}_{αβ} {\hat{φ}}_{β} , \\ {\hat{\overline{n}}}_{α} = {\sum }_{β} {f}_{α}^{- 1} {S}_{βα} {f}_{β} {\hat{n}}_{β} ≡ {\sum }_{β} {V}_{αβ} {\hat{n}}_{β} ,\end{matrix} \qquad ( E10 )$$

wherein \hat{φ}_{α}′=S_{μα}\hat{φ}_{μ}″ and \hat{n}_{α}′=S_{μα}\hat{n}_{μ}″. Note that U·V^{T}=1, i.e., the transformation from bare to normal modes is canonical.

Creation and annihilation operators. Lastly, consider the creation and annihilation operators. In order for squeezing terms to disappear in the Hamiltonian:

$$\begin{matrix}{\hat{\overline{φ}}}_{α} = {\sum }_{β = a , b , c} \frac{{u}_{α β}}{\sqrt{2}} ( \hat{β} + {\hat{β}}^{†} ) , \\ {\hat{\overline{n}}}_{α} = {\sum }_{β = a , b , c} \frac{{u}_{α β}}{\sqrt{2}} ( \hat{β} + {\hat{β}}^{†} ) ,\end{matrix} \qquad ( E11 )$$

$$where$$

$${u}_{αβ} = {U}_{αβ} \sqrt{{ϵ}_{β}} , {v}_{αβ} = \frac{{V}_{α β}}{\sqrt{{ϵ}_{β}}} . \qquad ( E12 )$$

Finally, obtain the hybridization coefficients entering Eq. (43) in the main text. The approach given in this Additional Section generalizes to an arbitrary number of modes with off-diagonal coupling in either the capacitive matrix, or in the inductive matrix.

### Additional Section F: Floquet Theory

This Additional Section provides a practical summary of Floquet theory. The spectrum of a monochromatically driven system can be obtained from the Floquet formalism [20], according to which the time-dependent Schrödinger equation for a periodically driven Hamiltonian Ĥ(t)=Ĥ(t+2π/ω_{d}) can be recast into a numerically solvable eigenproblem for the so-called Floquet Hamiltonian [19]

$$[ \hat{H} ( t ) - i {\partial }_{t} ] \vert {ϕ}_{α} ( t ) 〉 = {ϵ}_{α} \vert {ϕ}_{α} ( t ) 〉 \qquad ( F1 )$$

The eigenvalues are the quasienergies ∈_{α}, and whose eigenvectors are the Floquet modes which are periodic functions of time with |ϕ_{α}(t))=|ϕ_{α}(t+2π/ω_{d})

[symbol]

In terms of these, the solution to the time-dependent Schrödinger is |ψₐ(t))=e^{-ieαt}|ϕ_{α}(t)). Importantly, the solutions to Eq. (F1) are only defined up to an integer multiple k of the drive frequency ω_{d}, for if {∈_{α}, |ϕ_{α}(t) [symbol] } is a solution, then so is {∈_{αk}≡∈_{α}+kω_{d}|ϕ_{αk}(t) [symbol] =e^{-ωdt}|ϕ_{α}(t) [symbol] }, which is a consequence of the periodicity of the Floquet modes.

Information about the monochromatically driven system can be obtained from the quasienergy spectra. For example, two-tone spectroscopy experiments where a weak tone is used to probe the spectra of the driven system can be modeled in the linear response regime [23]. In such experiments, probe-tone-induced transitions occur at frequency differences

$${Δ}_{αβ k} = {ϵ}_{α} - {ϵ}_{β} + k {ω}_{d} , \qquad ( F2 )$$

provided that the operator corresponding to the probe tone, denoted generically as \hat{X}, has a nonzero matrix element between the corresponding Floquet modes. With the above notation, the corresponding matrix elements read

$${X}_{αβ k} = \frac{1}{T} {\int }_{0}^{T} d t {e}^{- i ( {ϵ}_{α} - {ϵ}_{β} + k {ω}_{d} ) t} 〈 {ϕ}_{β} ( t ) 〉 \vert \hat{X} \vert {ϕ}_{α} ( t ) 〉 \qquad ( F3 )$$

where T=2π/ω_{d} is the period of the drive. This takes the form of a Fourier series coefficient

$${f}_{k} = \frac{1}{T} {\int }_{0}^{T} {dt}^{′} {e}^{- ik \frac{2 π}{T} {t}^{′} f ( {t}^{′} )}$$

of the matrix element of the operator X between the two Floquet modes |ϕ_{αβ}(t) [symbol] .

Numerically, the Floquet spectrum is efficiently obtained from the time-evolution operator over one period of the drive, which has a compact expression in terms of the Floquet modes [20]

$$\hat{U} ( t + T , t ) = {𝒯e}^{- {\int }_{t}^{t + T \hat{H} ( {t}^{′} ) {dt}^{′}}} = {\sum }_{α} {e}^{- i {ϵ}_{α} T} \vert {ϕ}_{α} ( t ) 〉 〈 {ϕ}_{α} ( t ) \vert \qquad ( F4 )$$

where [symbol] is the time-ordering operator. According to the above expression, the Floquet modes at time t=0, ϕ_{α}(0) [symbol] |, are the eigenvectors of U(T, 0), whereas the quasienergies are obtained modulo an integer multiple of (od from the eigenvalues. The time-dependence over one period of the drive is obtained by propagating each mode |ϕ_{α}(0) [symbol] with the time-evolution operator Û(t, 0) in the interval 0<t≤T.

To summarize, the steady-state dynamics can be obtained from the propagator Û(t, 0) over a single period of the drive, which makes the Floquet method an efficient alternative to numerical simulation of the dynamics over the complete gate time. Indeed, the period of the drive, on the order of 1 ns is between two to three orders of magnitude shorter than the typical gate times. This work obtains the quantities above by using the QuTip implementation of the Floquet formalism [60]-[61], amended by a numerically efficient evaluation of the time-evolution operator developed by Shillito et al. [62].

### Additional Section G: Non-RWA Effects in Floquet Simulations of the Full Device

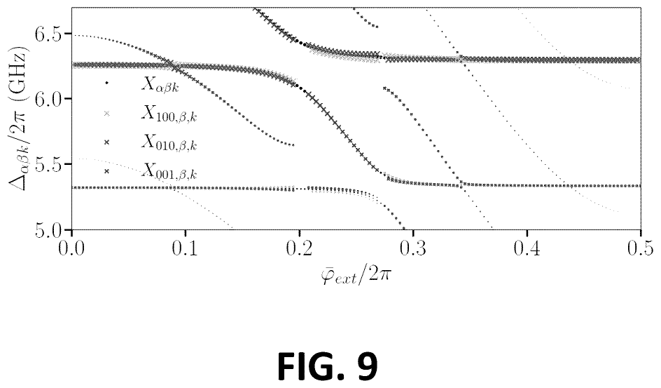

This section briefly discusses the role of counter-rotating terms in the Floquet simulations of the full device Hamiltonian. Counterrotating terms (among which the parity-breaking cubic terms play an important role) in the coupler Hamiltonian induce an important correction to the coupler frequency, as can be seen by comparing FIG. 9 to FIG. 7. This indicates, among other things, that a mere approximation of the coupler Hamiltonian as a Kerr nonlinear oscillator, as was done in the case of the toy model, would be insufficient for precise comparisons with experimental data. Moreover, the speedup obtained by using the Floquet method, together with the numerically efficient method for computing the time-evolution operator, enables study of non-RWA effects efficiently as compared to full time-dynamics.

### Experimental Implementations

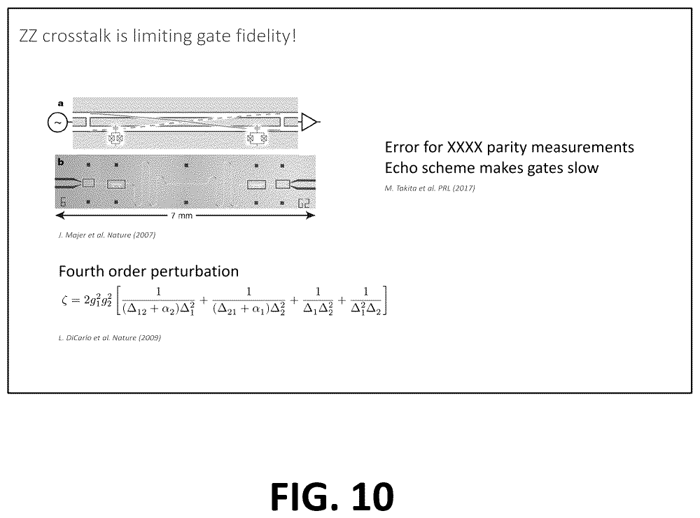

FIG. 10 illustrates a schematic of ZZ crosstalk and a fourth order perturbation equation. Coupling two qubits with a coupler often leads to a static ZZ term in the Hamiltonian, as discussed herein. The Hamiltonian can be calculated using fourth order perturbation theory. The “always-on” crosstalk leads to errors in X parity measurements, and X parity measurements are an important part of surface codes for fault tolerant quantum computing. In addition, echo pulse schemes can be used for mitigating this crosstalk, however such schemes lead to slower gates.

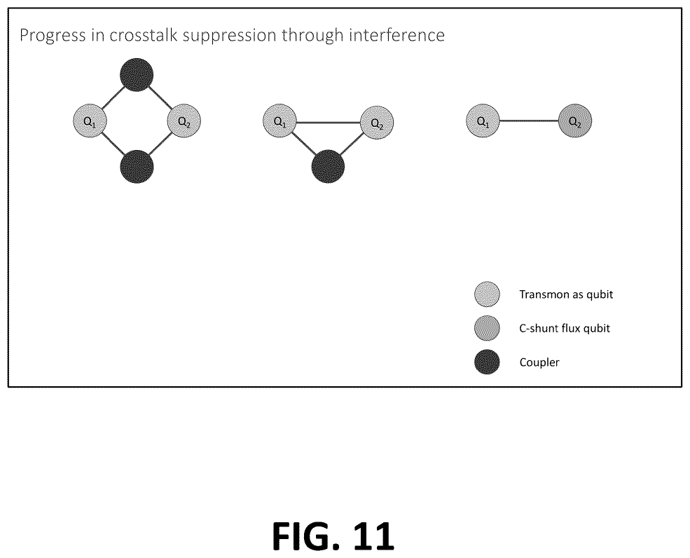

FIG. 11 illustrates progress in crosstalk suppression through interference. Embodiments illustrate a transmon, c-shunt flux qubit, and coupler in various configurations. A first configuration illustrates two transmon qubits, q1 and q1, each connected to two common couplers. A second configuration illustrates two transmon qubits connected to each other, as well as a single coupler. A third embodiment illustrates a transmon qubit directly connected to a c-shunt flux qubit.

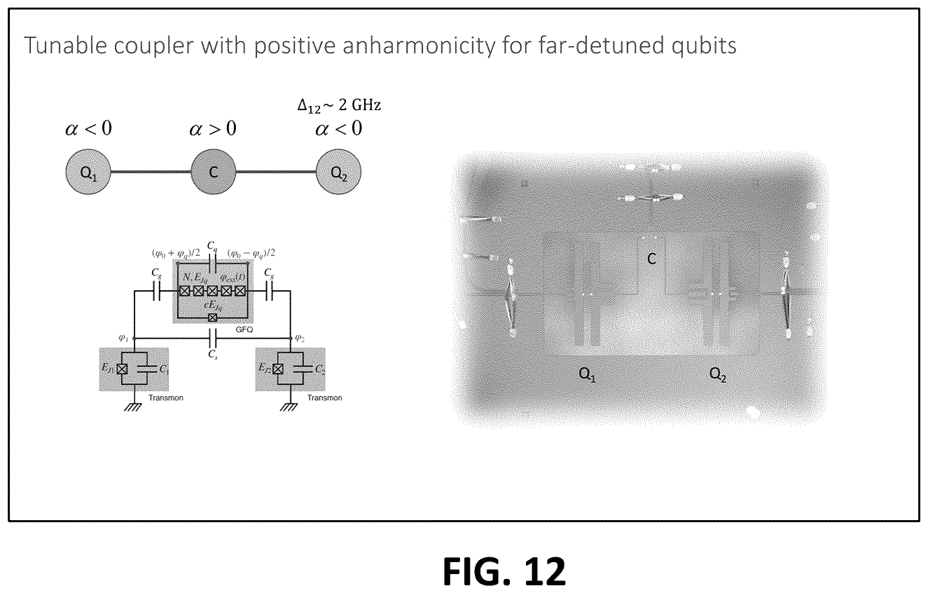

FIG. 12 illustrates a tunable coupler with a positive anharmonicity for far-detuned qubits. Two transmon qubits, q1 and q2, having α<0, are coupled with a single, common coupler, c, (e.g., a generalized flux qubit coupler) wherein α>0. FIG. 12 further provides various illustrates and applications of transmon qubit coupling via a common coupler, c.

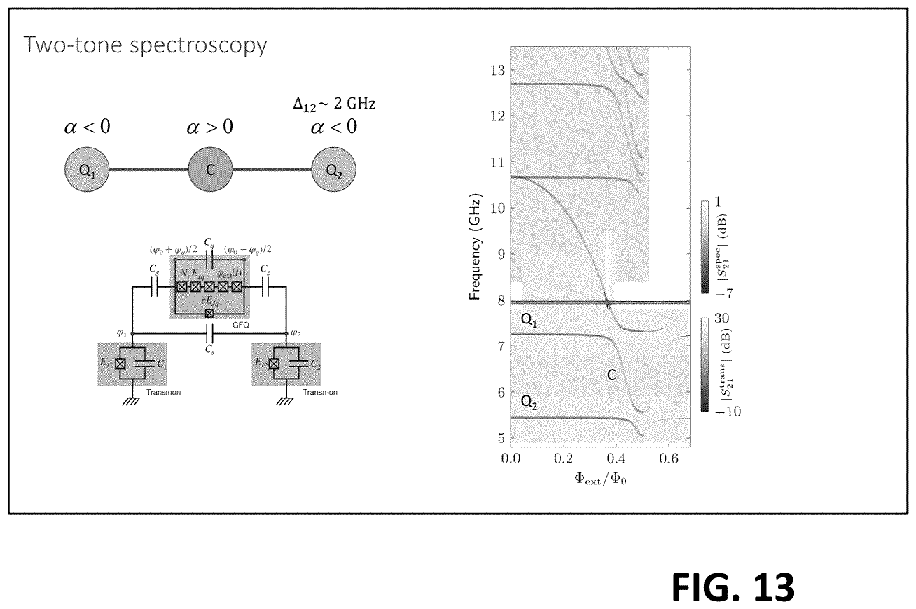

FIG. 13 illustrates an example of two-tone spectroscopy for Device 0, for a configuration similar to that of FIG. 12. The two-tone spectroscopy graph illustrates frequency (GHz) versus φₑₓₜ/φ₀.

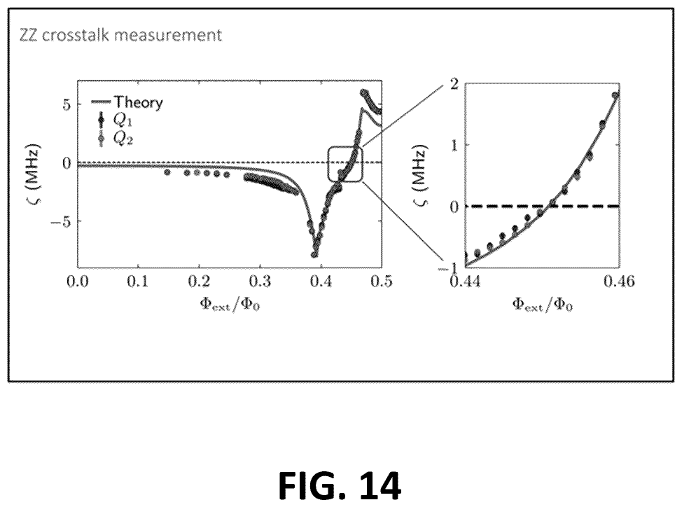

FIG. 14 graphically illustrates a ZZ crosstalk measurement for Device 0. A theoretical cross talk line provides a base line against qubit measurements, Q1, Q2. The graph further illustrates a close-up view of the section were ξ=0, thus indicating no ZZ crosstalk.

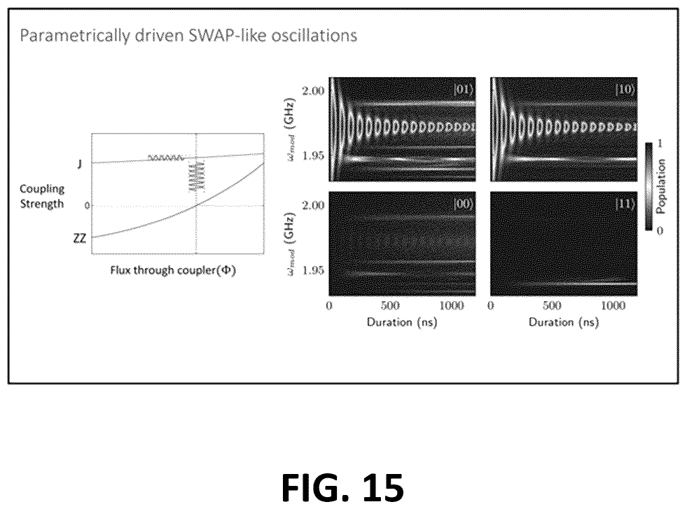

FIG. 15 illustrates parametrically drive SWAP-like oscillations for Device 0. The graphs represent coupling strength vs. flux through coupler, φ. The SAWP-like oscillations illustrate ω mod (GHz) measurements vs. duration (ns), with a scaled population indication representing 0 to 1.

A perfect entangler is a theoretical term for the non-local two-qubit operations that are capable of creating a maximally-entangled state out of some initial product state, i.e., it doesn't have to be separable. As discussed herein, transmon qubits, store data, transmon qubits or linear resonators can mediate gates, and transmon qubits can act as ancilla for error correction. Quantum computers therefore will ideally have high-coherence qubits, e.g., fixed frequency transmons which are far detuned from each other, low two-qubit gate error, e.g., zero crosstalk between qubits and fast gates, and a family of native gates (i.e., perfect entanglers) to compile to, which can enable flexible/simple entangling gate architecture.

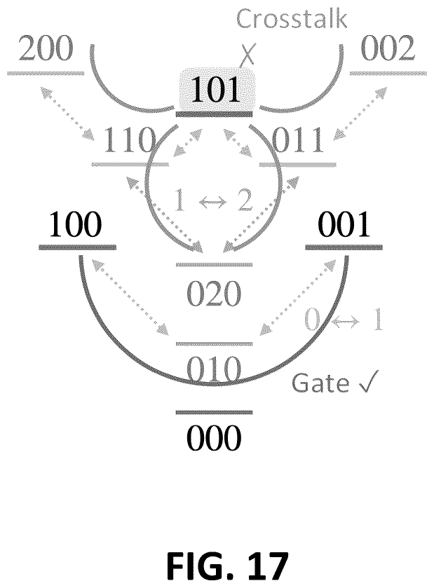

FIG. 17 illustrates crosstalk suppression via coupler levels. In embodiments, dynamical ZZ crosstalk has to be separately suppressed, by either adjusting the DC flux bias applied to the device or by driving the system off-resonantly. The static ZZ term in the Hamiltonian can be calculated using fourth order perturbation theory.

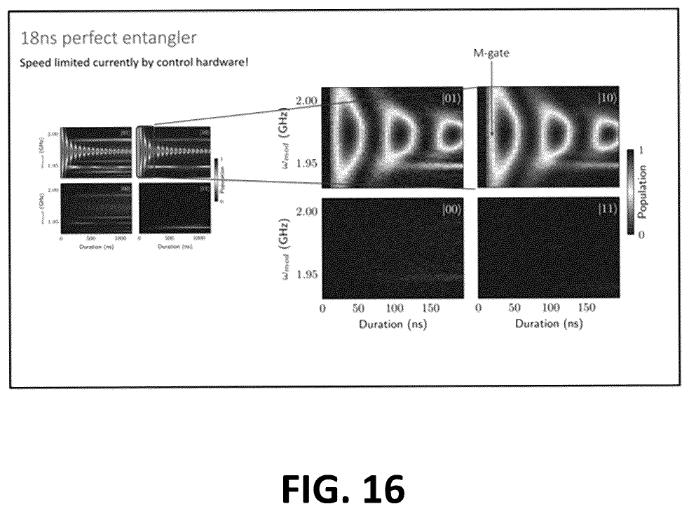

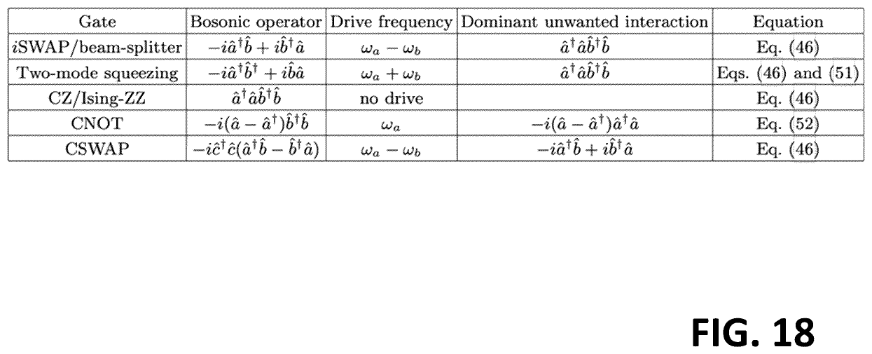

FIG. 18 illustrates a list of the most accessible gate Hamiltonians realizable with a parametric drive in the analyzed architecture. In an embodiment comprising two-mode squeezing: 1.3 us BSWAP has been observed, with leakage. BSWAP is an entangler that is locally equivalent to iSWAP. As noted in FIG. 16, a CZ relates to voluntarily generating a ZZ between the qubits and so the idea is to move the coupler's frequency to grow the ZZ (counterintuitively). Alternatively or additionally, a ZZ can exist with raman transitions. By driving off-resonantly, a ZZ shift can be accumulated in the qubits, and there are a few options for off-resonant transitions: (101-111), (101-201), and (101-102) among others. Here, ijk refers to qubit 1 in i, coupler in j, and qubit 2 in k. CSWAP is a controlled SWAP, so if the coupler is in its excited state, the qubits will SWAP (i.e., it is a 3 qubit gate). Normally this should not happen if the coupler stays in the ground state, otherwise we have an additional SWAP.

If the gate is not exactly identical to the standard unitary known as sqrt(iSWAP), e.g., it has a slight relative phase offset, one of two things are suggested: either a device/control imperfection, or that the theoretical model does not precisely describe the device behavior. Nevertheless, numerical and analytic methods have both been used to demonstrate that such non-standard native gates can be efficient to compile to. A first numerical approach can include designing calibration and expressivity-efficient instruction sets for quantum computing by Murali et al. (2021). The algorithm recursively checks for how many layers of the native gates the target unitary can be decomposed into. A second analytic approach can include two-Qubit Circuit Depth and the Monodromy Polytope by Peterson et al. (2021). This method describes a way to calculate if synthesis of one gate is possible from a specific sequence of others.

In some embodiments, these approaches can be used to find a bound on the best possible compilation, however continued work is being done about which non-standard gates are easy/hard to compile to, using the framework of Cartan coordinates. For instance, perfect entanglers are easier because they can be used to generate other entanglers. Similarly, finding the single-qubit gates that need to go between each use of a non-standard gate is hard in general and solved only for certain gates like CNOT/CZ, iSWAP, sqrt-iSWAP, and B.

FIG. 16 illustrates an 18 ns perfect entangler, which was shown can be speed limited by control hardware. FIG. 16 illustrates ω mod (GHz) measurements vs. duration (ns) graphs similar to FIG. 15, and focuses on the greatest oscillations corresponding to the M-gate. The graphs provide a visual representation of entanglers and embodiments in accordance with the present disclosure.

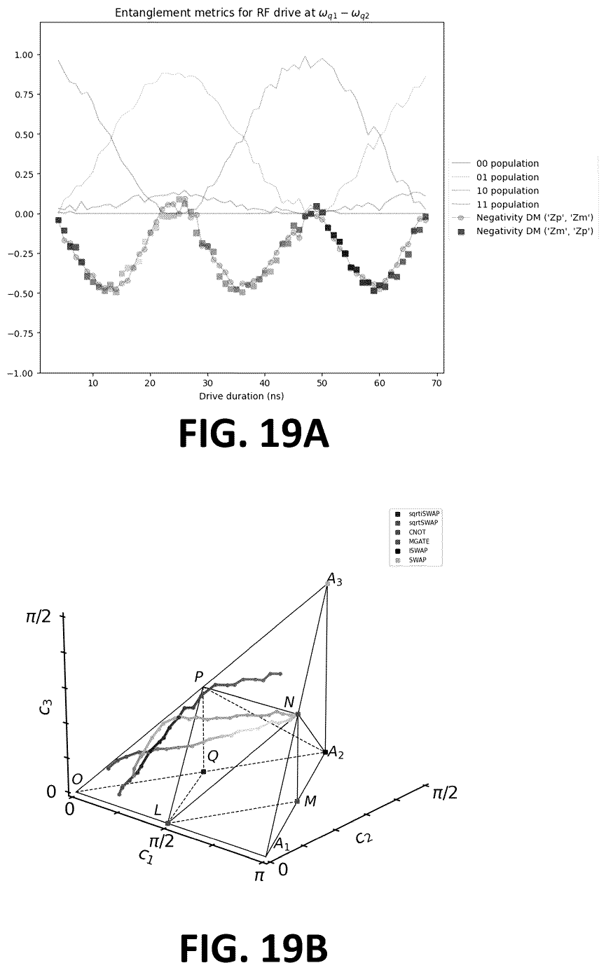

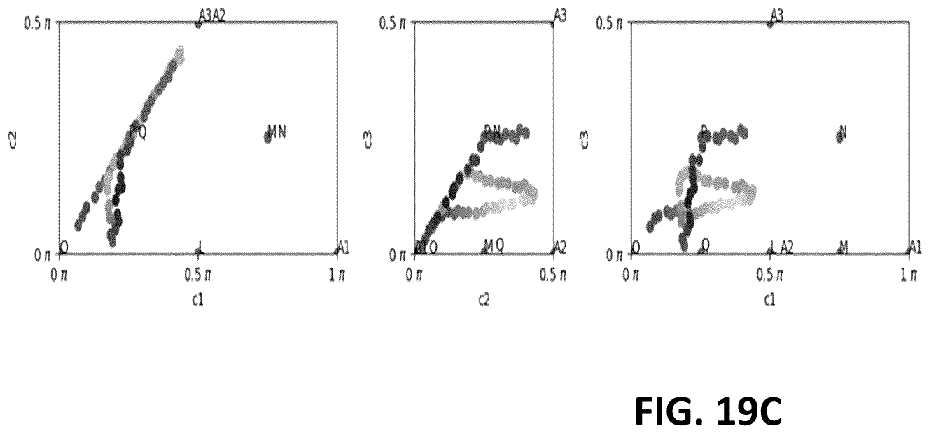

FIGS. 19A-C illustrate examples of a Cartan coordinate gate trajectory for Device 0. FIG. 19A illustrate entanglement metrics for RF drive, with a negativity of −0.5 for a perfect entangler. In embodiments, measurements are repeated, but with 4× the DAC resolution (DAC speed was effectively increased from 4 ns to 1 ns) and an additional 4 dB of entangling gate drive power, which speeds up the sqrt(iSWAP)-like entangling gate from 20 ns to 13 ns.

The fastest sqrt(iSWAP)-like entangling gate we have measured was 9 ns but the two-qubit purity dropped below 75% for entangling gate drive durations shorter than 13 ns in that case.

Preliminary benchmarking of the entangler in Device 0 suggests that the fidelity of this architecture is limited by qubit coherence (e.g., the transmon T1 and T2) rather than by the entangling gate design. Future devices (e.g., Device 1 and 2) were therefore optimized to enhance qubit coherence.

In embodiments, opposite anharmonicity qubits are promising as couplers, and an oppositive anharmonicity coupler (e.g., a generalized flux qubit coupler) can enable a 13 ns long entangling gate. Accordingly, these couplers can work with far-detuned fixed-frequency qubits (e.g., transmon qubits), and provide zero ZZ coupling.

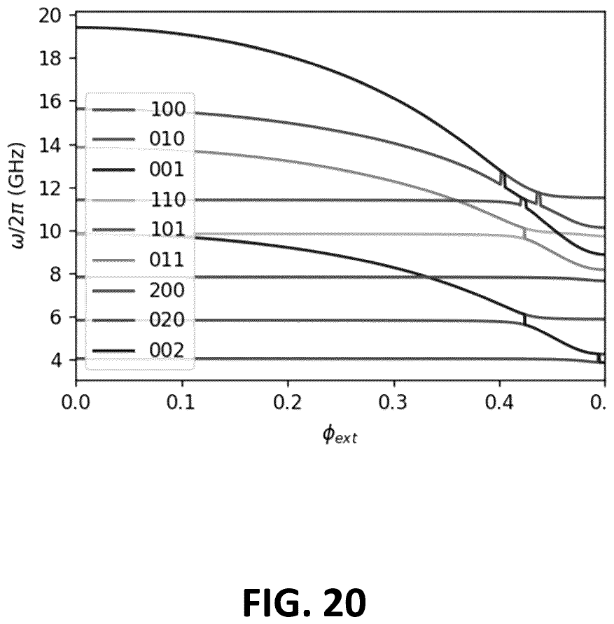

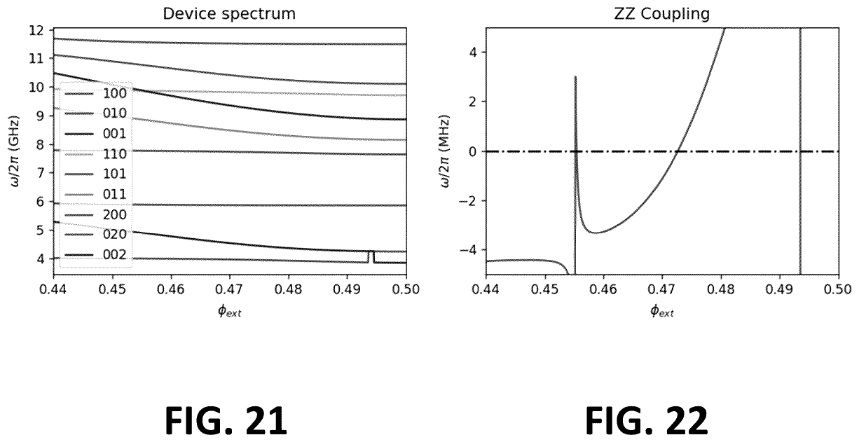

FIG. 20 illustrates an example device energy spectrum in accordance with embodiments of the present disclosure. FIG. 21 illustrates another example device spectrum in accordance with embodiments of the present disclosure. FIG. 22 illustrates a ZZ coupling corresponding to the device spectrum of FIG. 21. In embodiments ZZ can be represented by ZZ=ω₁₁₀−ω₁₀₀−ω_{010+ω000}. In such embodiments a crucial point from spectrum is to avoid crossings that are not near the zero ZZ point. Hybridizations (even small ones) give many MHz shifts in ZZ. Hybridization with ω110 also causes flux noise coupling.

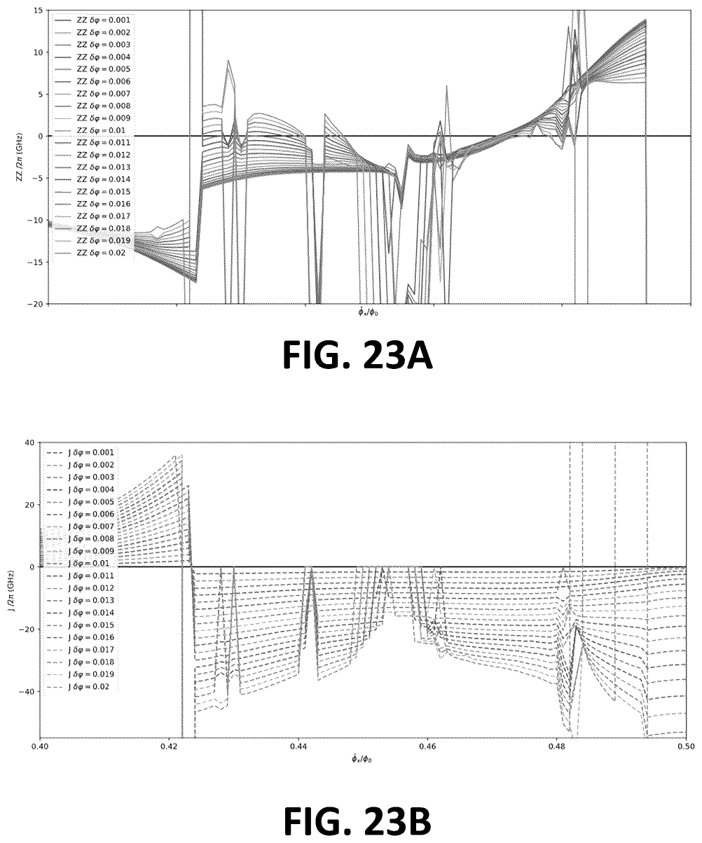

FIGS. 23A-B illustrate Floquet simulations in accordance with embodiments of the present disclosure. Static ZZ has been shown, however turning on drive can change the value of ZZ. Additional resonances can come from Floquet level crossings. As illustrated in FIGS. 23A-B, devices and apparatuses of the present disclosure can demonstrate minimal ZZ dependence on drive and minimal gate rate dependence on flux.

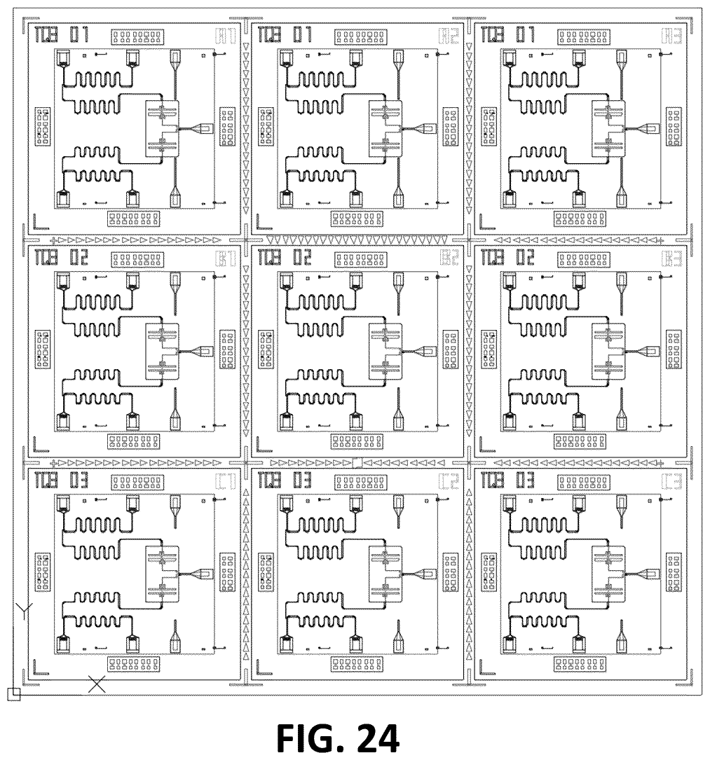

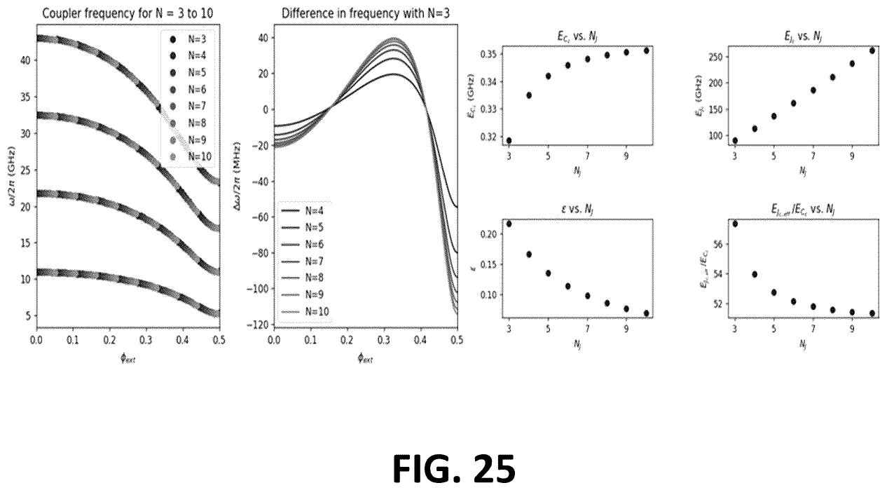

FIG. 24 illustrates an example device update, in accordance with embodiments of the present disclosure. FIG. 25 illustrates graphical schematics of a coupler frequency and difference for spectrally equivalent couplers, in accordance with embodiments of the present disclosure. In FIG. 25, spectrally equivalent couplers can be engineered for different NJ by adjusting EJs and EC.

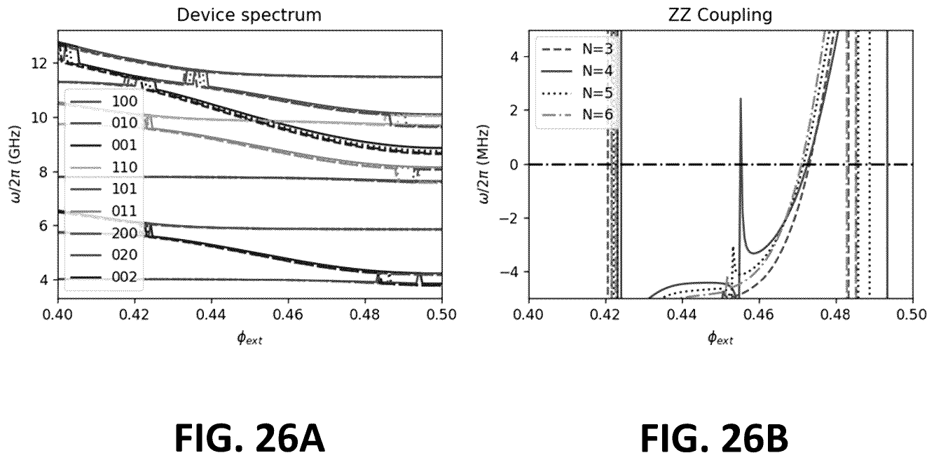

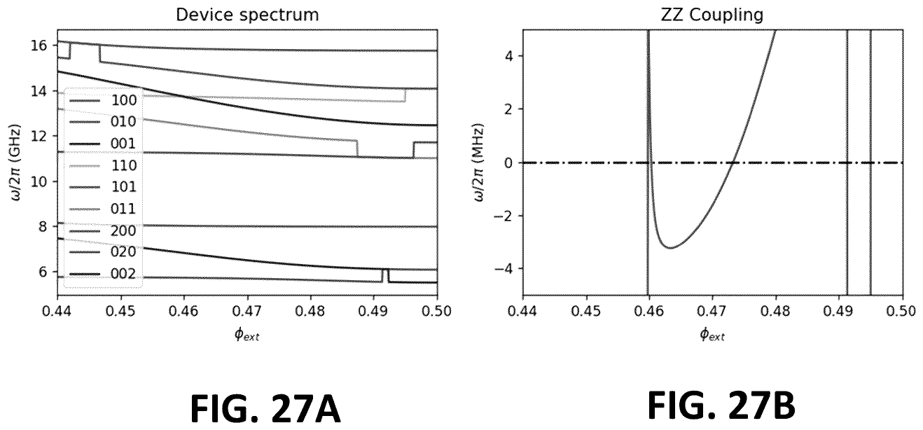

FIGS. 26A-B illustrate changing NJ, in accordance with embodiments of the present disclosure. FIGS. 27A-B illustrate a device design that is more robust to fabrication intolerances, in accordance with embodiments of the present disclosure.

FIG. 26A illustrates a device spectrum, and FIG. 26B illustrates ZZ coupling. In the illustrated examples, copies of a NJ=4 device with different NJ give similar results, highlighting a freedom in choosing parameters. FIG. 27A illustrates a device spectrum for an improved fabrication tolerance, and FIG. 27B illustrates the respective ZZ coupling. In these embodiments, the device puts qubits at 6 and 8 GHz instead of 4 and 6. This allows for approximately double junction widths for the transmon and the black sheep junctions, originally as low as 200 nm. Accordingly, the design significantly improves fab yield.

In various embodiments, for readout optimization several parameters should be considered. Such considerations include, but are not limited to: Qubits being detuned from each other by about 2 GHz, Purcell limited T1 is expected to be set by decay through the qubit charge line, Purcell filtered readout does not need to be higher than an order of magnitude more than this, and resonators should lie within a parametric amplifier band. Readout resonator and filter parameters should be chosen to give the fastest readout while resonator Purcell T1 is just large enough to not be a problem.

There are many simultaneous requirements for high fidelity operation of a quantum computer. First, gates must be fast with flexible control. Second, crosstalk should be minimized. Crosstalk can come in the form of control crosstalk such as microwave crosstalk between the control of two transmons close in frequency. There is also residual crosstalk through mechanisms like the cross-Kerr interaction which causes state-dependent frequency shifts in neighboring qubits. Lastly, the qubits should maintain a balance of being sufficiently decoupled from the environment to keep high coherence while maintaining full addressability.

FIGS. 14 and 19A-C illustrate a proof of principle, showcasing a first iteration of devices (e.g., Device 0) in accordance with embodiments of the present disclosure. In the illustrated example, a conditional Ramsey experiment confirmed the existence of a zero ZZ point. Parametric drive on the coupler, verified with quantum process tomography, resulted in entanglement as fast as 13 ns. With the principle of the device demonstrated in Device 0, disclosed herein are further techniques to optimize the design of the tunable coupler.

As explained above, disclosed is a new coupler architecture using a flux-tunable coupler, such as a generalized flux qubit (GFQ). This coupler may be designed to achieve two key things. First, positive coupler anharmonicity enables the device to be flux-biased to a point where there is zero residual ZZ crosstalk between two transmon data qubits. Secondly, the coupler enables a variety of two-qubit entangling gates while allowing the transmons to be far detuned and fixed frequency. Further described herein is a parametrically driven iSWAP-like gate. The disclosed techniques improves coherence properties of the transmons in comparison to their tunable counterparts and greatly reduces microwave crosstalk.

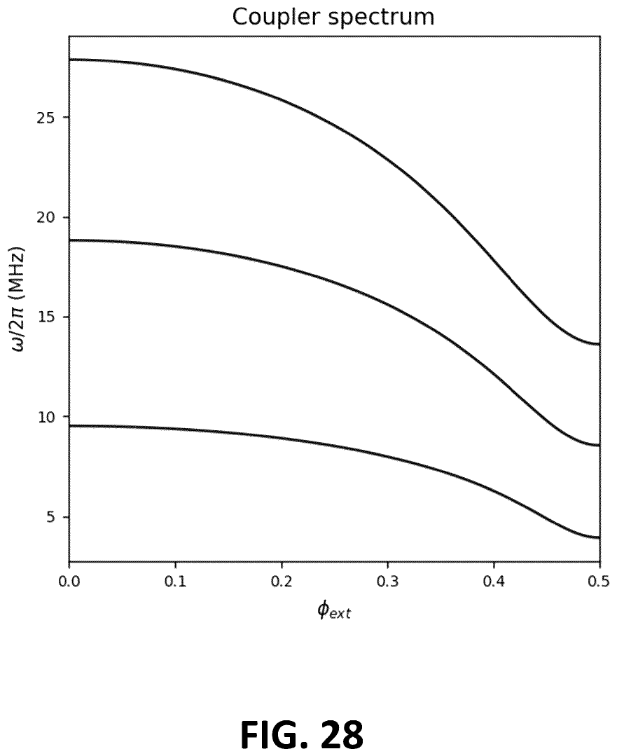

FIG. 28 illustrates a GFQ spectrum in accordance with embodiments of the present disclosure. The GFQ is parameterized by four quantities: the number of junctions in the array arm (N_{J}), the Josephson energies in the array arm (E_{Jc}) and the Josephson energies (E_{J}_{_{bs}}) in the single junction arm (e.g., called the black sheep), and the charging energy (E_{C}) determined by the shunt capacitance.

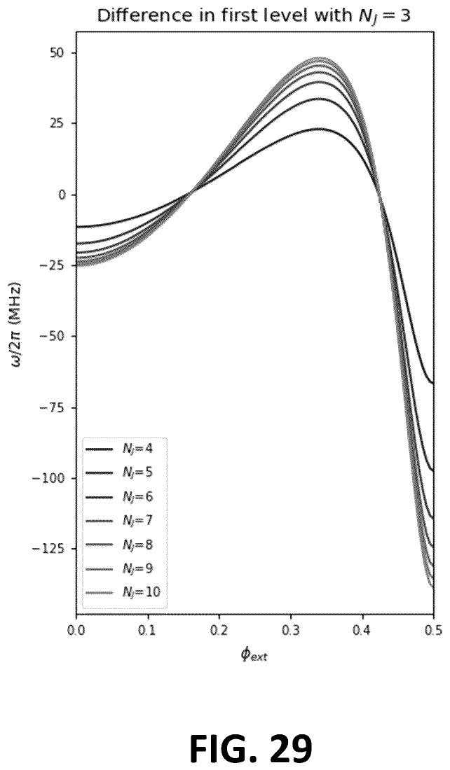

FIG. 29 illustrates a difference in first level with N_{J}=3, in accordance with embodiments of the present disclosure.

Embodiments found couplers with different numbers of junctions that were spectrally close. A Nelder-Mead algorithm minimized spectrum differences between N and N+1 junctions. By starting with a coupler with N=3 junctions, parameters on an N=4 junction coupler varied until the energy difference over the first 5 levels was minimized. The result of this study was families of spectrally close couplers with different numbers of junctions. The corrections are of order 10's of MHz which is much smaller than energy scales considered when optimizing spectrum properties.

In the illustrated examples, an equivalent coupler may be determined (e.g., optimized) with the following algorithm:
1. Solve coupler 1 for N_{J}=3.
   Energy levels E₃ₘ for m=0, 1, 2, . . .
2. Simulate coupler 2 for Nⱼ=4.
   Parameterized by {E_{JC}, E_{Jbk}, E_{C}}.
   Energy levels E₄ₘ(E_{JC}, E_{Jbk}, E_{C}).
3. Minimize Σₘ E₄ₘ(E_{JC}, E_{Jbk}, E_{C})-E₃ₘ over {E_{JC}, E_{Jbk}, E_{C}}.
4. Recursively solve for higher N_{J}.

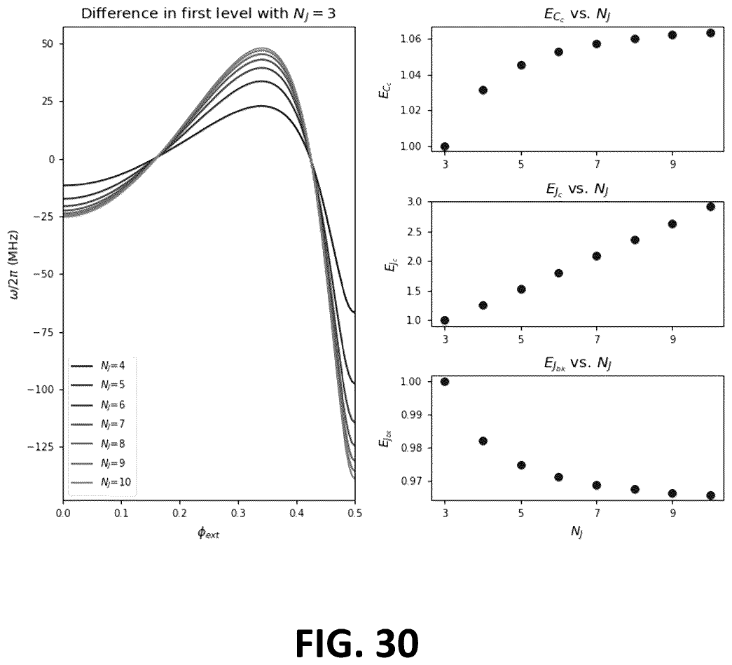

FIG. 30 illustrates the results of multiple junctions, in accordance with FIG. 29. In the illustrated example, array junction E_{J} is the only parameter that changes significantly. Within a family of spectrally equivalent couplers, the only parameter to change by more than a few percent was the E_{J} of the array arm junctions. In other words, to make an equivalent coupler one need only make that E_{J} larger when increasing N. This is fundamentally a fabrication constraint, and we chose N_{J}=4 as it was an easy size junction to fabricate. However, a different number may be chosen.

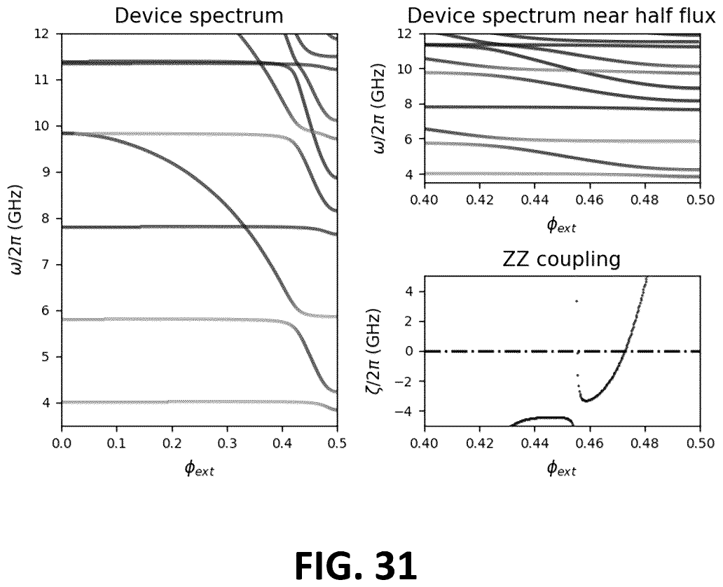

FIG. 31 illustrates an ideal device spectrum, a device spectrum near half flux, and a ZZ coupling for the ideal device spectrum. In such embodiments, the coupler can be chosen to avoid crossings that are away from the ξ=0 point. The illustrated embodiments refer to spectrum requirements for an optimized device. A zero-ZZ crossing can only exist close to half flux where the coupler anharmonicity is positive. In addition, the coupler must be between the two qubit frequencies for the parametric iSWAP-like gate to operate. The combination of these two requirements pins the coupler spectrum relative to the two qubits. Ideally, the coupler will split the qubit frequencies exactly to minimize qubit-coupler hybridization. To then operate at a zero ZZ point, the other levels in the spectrum must not have avoided crossings with the logical qubit levels near the operating point. With these requirements met, a device with a parametric iSWAP-like gate and a well-behaved ZZ spectrum can be achieved.

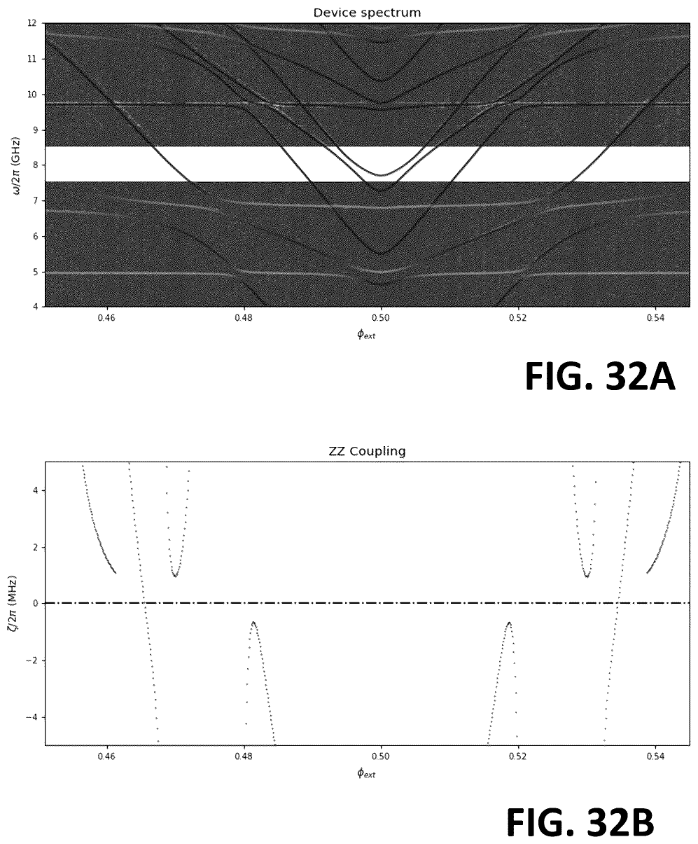

FIGS. 32A-B illustrate a Device 1 spectrum (FIG. 32A) and ZZ coupling (32B), in accordance with embodiments of the present disclosure. The embodiment, related to Device 1 spectroscopy, illustrate a coupler that was steeper than expected. The device was predicted at ξ=0 with ϕ˜0.465, and a strong hybridization of qubit 1 with a coupler near an ideal ZZ spot. In embodiments, the device had a systematic increase in Josephson energies with large consequences on the spectrum. This result confirms the importance of spectrum engineering for this device. Specifically, the coupler was steeper than expected resulting in a narrow region where the coupler was between the qubits. A zero ZZ point was predicted showcasing the robustness of its existence, but steep coupler slope plus strong coupler-qubit hybridization introduced large amounts of flux noise and inability to see one of the data qubits. Measurements were performed on the other qubit (qubit 2) near the coupler.

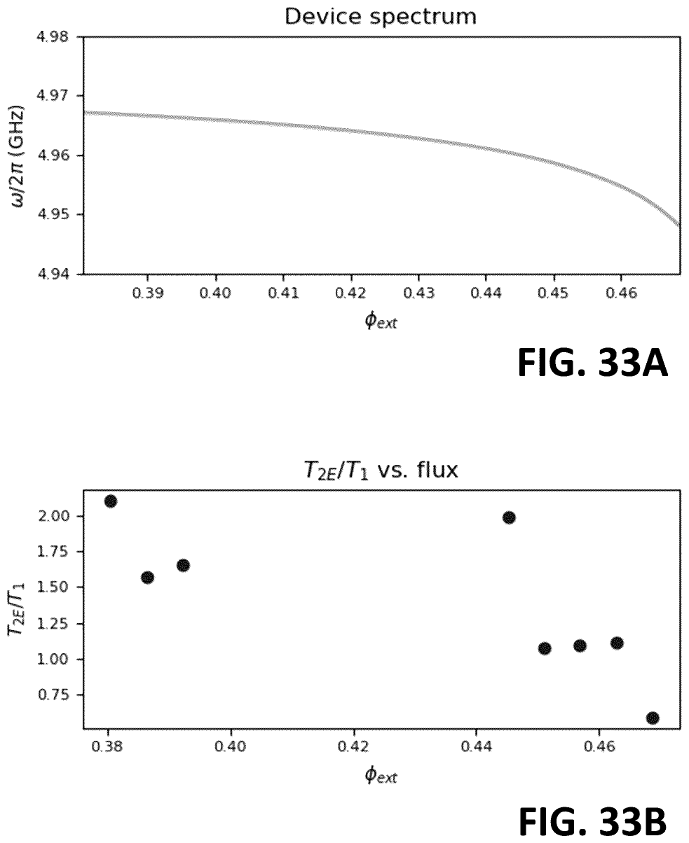

FIGS. 33A-B illustrate coherence and flux for a device in accordance with embodiments of the present disclosure. Even though the data qubits are fixed in frequency, hybridization with the coupler will inevitably result in coupling to flux noise. T2_{echo} and T₁ were measured and their ratio computed as a function of external flux. It was found that where the qubit is flux insensitive the T₂ is T₁ limited. As the qubit became flux sensitive the dephasing rate increased directly proportional to the slope of the qubit frequency with external flux.

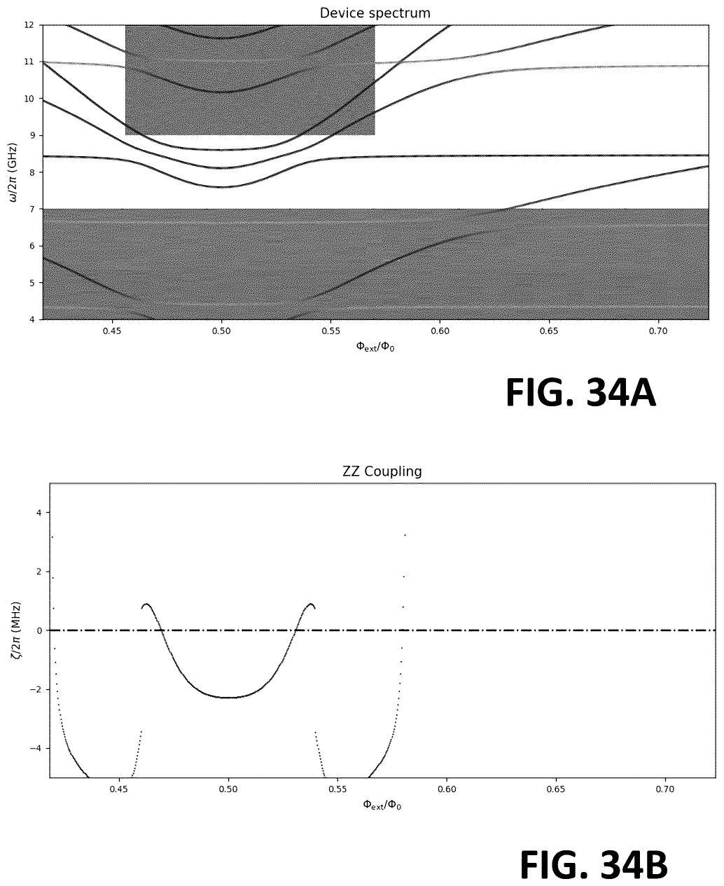

FIGS. 34A-B illustrate a Device 2 device spectrum (FIG. 34A) and ZZ coupling (34B), in accordance with embodiments of the present disclosure. In the illustrated example, Device 2 has parameters closer to the target that Device 1. The spectrum has a wide region with the coupler between the qubits and a predicted zero ZZ point at an appropriate coupler location.

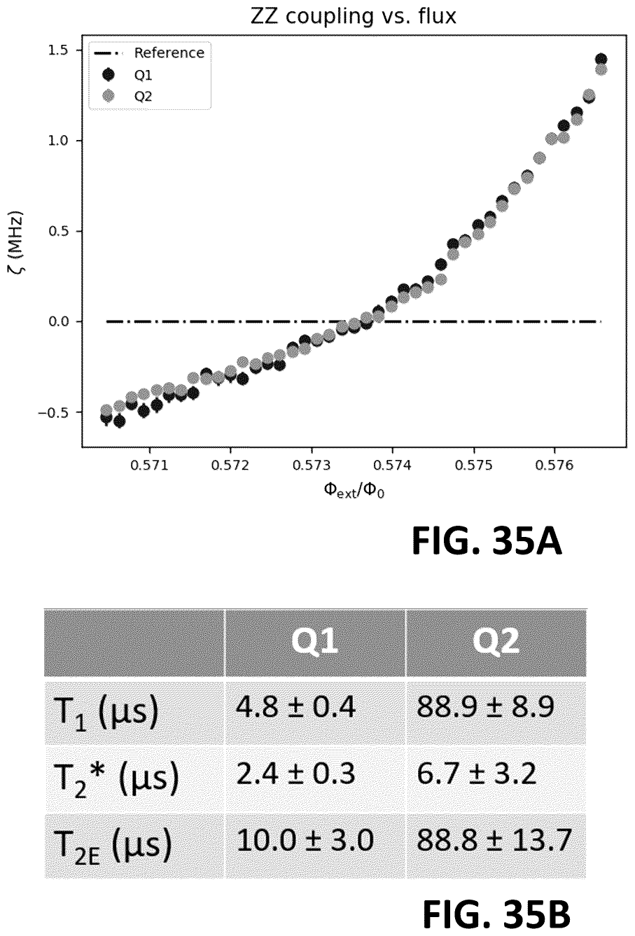

FIG. 35A illustrates a ZZ coupling vs. flux graph, in accordance with embodiments of the present disclosure. FIG. 35B illustrates the corresponding qubit, Q1, Q2, data to FIG. 35A. The example illustrates Zero-ZZ point for a conditional Ramsey experiment, achieved with a coupler between qubits, in accordance with examples and embodiments discussed herein. In the example, a zero ZZ point was found on Device 2 very close to the theoretical prediction. Coherences here imply flux noise limitation for qubit 2 while qubit 1 does not have high enough T1 to be limited by flux noise.

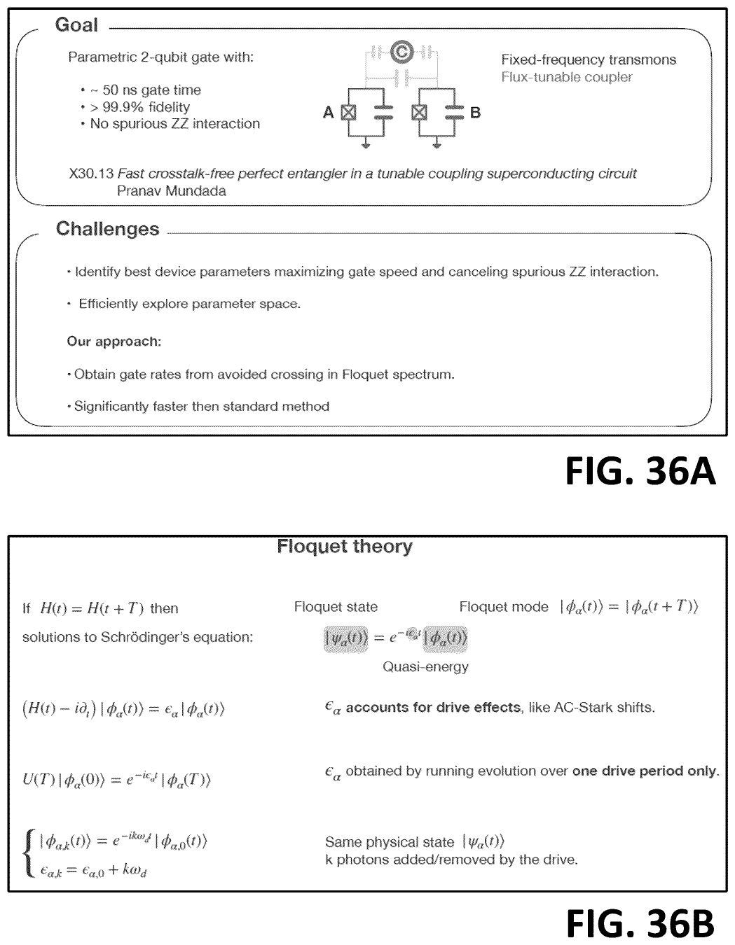

FIGS. 36A-B show goals, challenges, and Floquet theory details.

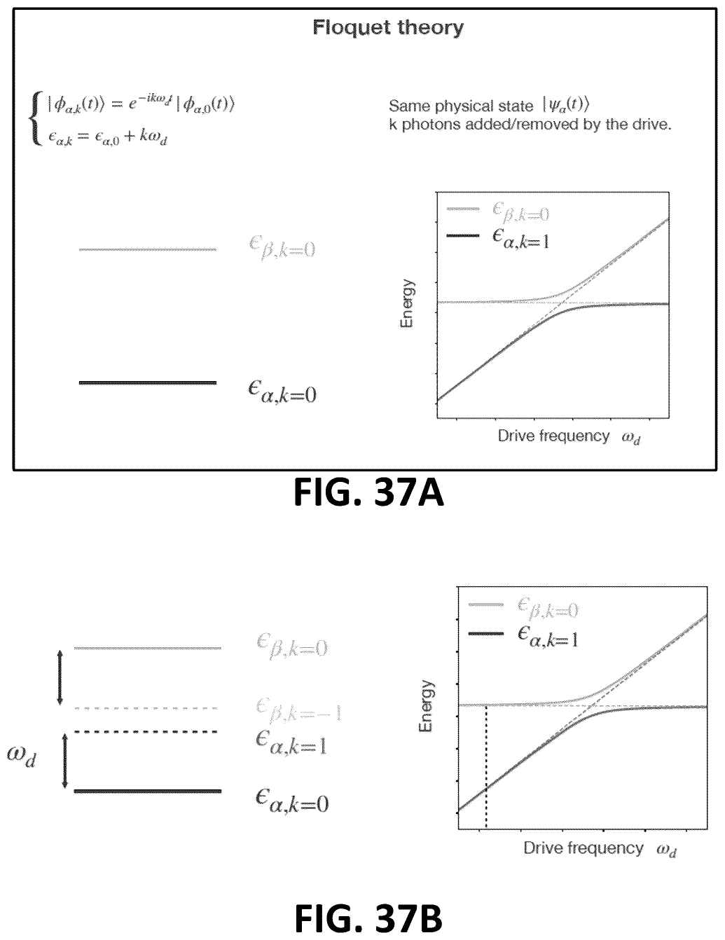

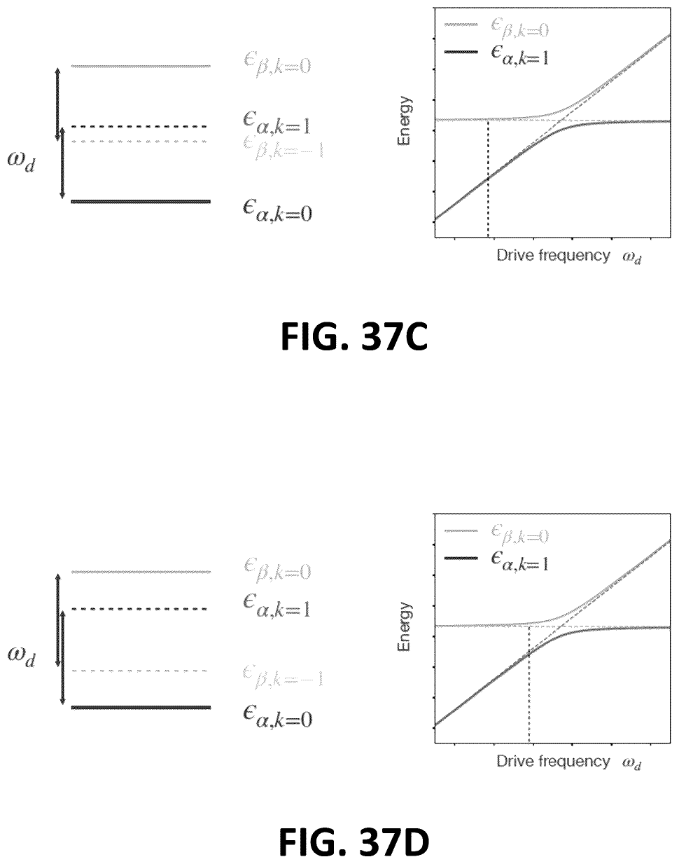

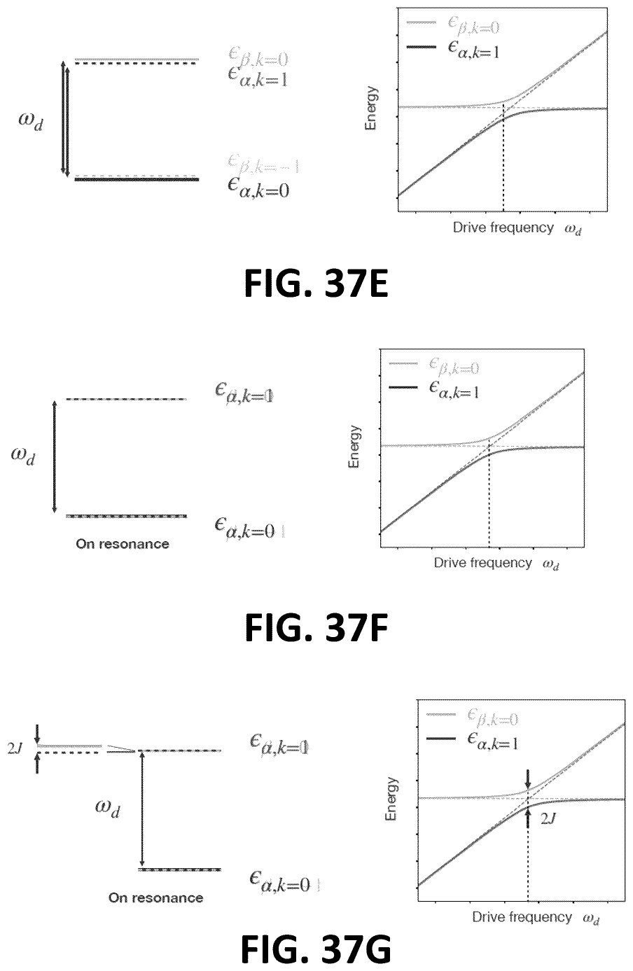

FIGS. 37A-G show graphs and other information illustrating application of Floquet theory to the present disclosure. As an example, the standard method may involve one or more of Perturbation theory, Run gate dynamics, or a combination thereof. As an example, the Floquet method may include:
Floquet spectrum by running evolution for 1 period of the drive, QuTiP [http://qutip.org] & Dysolve [Shillito et al., arXiv:2012.09282]
S33.9 Semi-Analytic Method for Rapid Simulation and Optimization of Driven Quantum Systems Ross Shillito
Significantly faster (1000× for MHz gate and GHz drive)
Accounts for drive effects

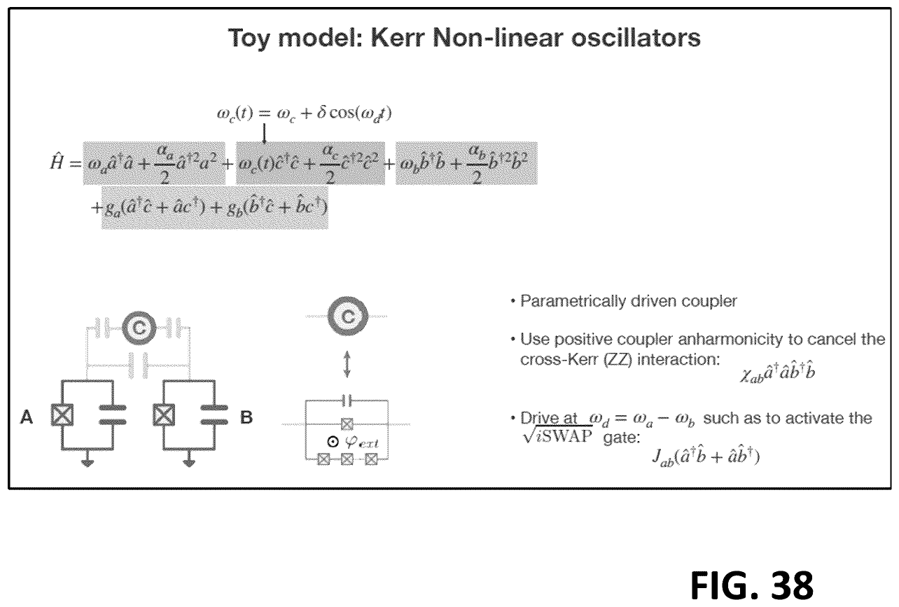

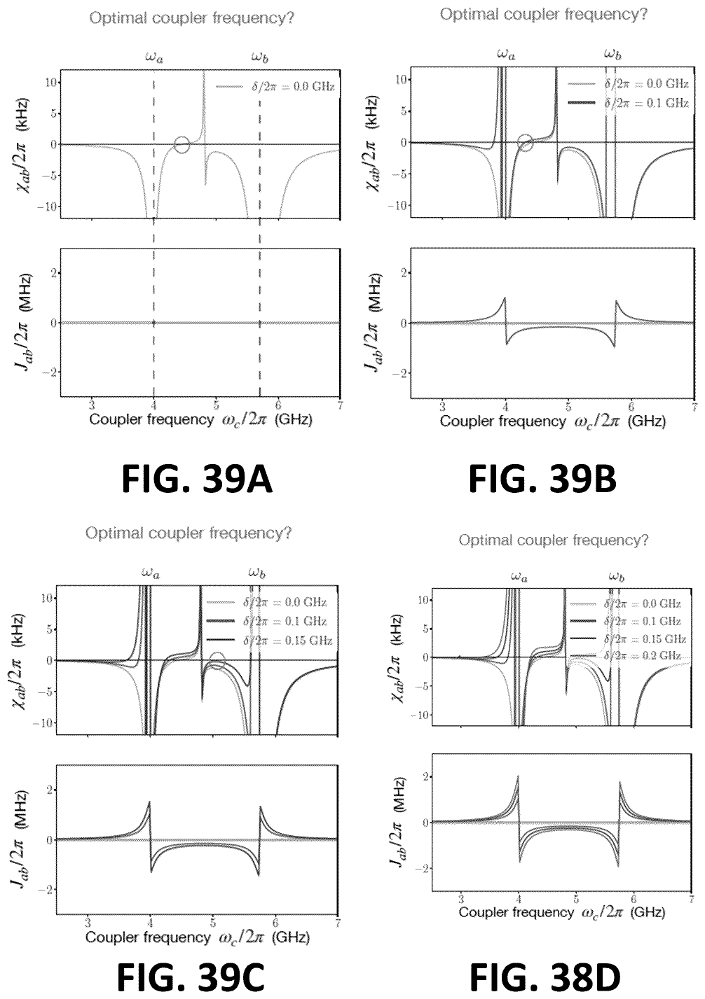

FIG. 38 shows details of an example toy model: Kerr Non-linear oscillators.

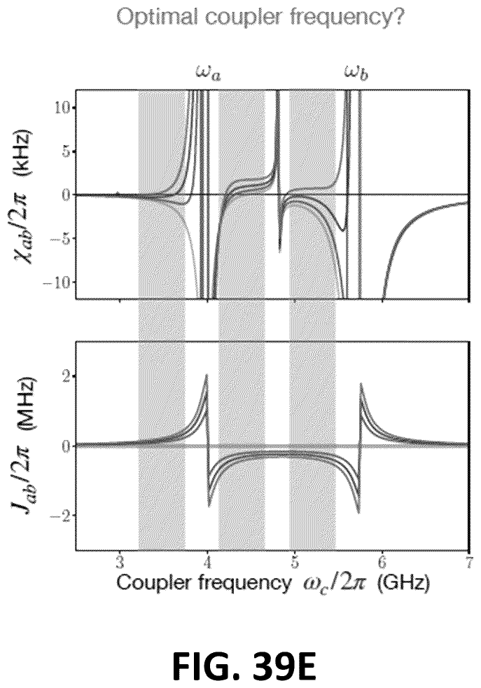

FIGS. 39A-E show details of the example toy model. These figures show canceling ZZ during idle time for some ω_{c} and cancellation of the static δ=0 and dynamical (δ≠0) ZZ interaction with parametric drive.

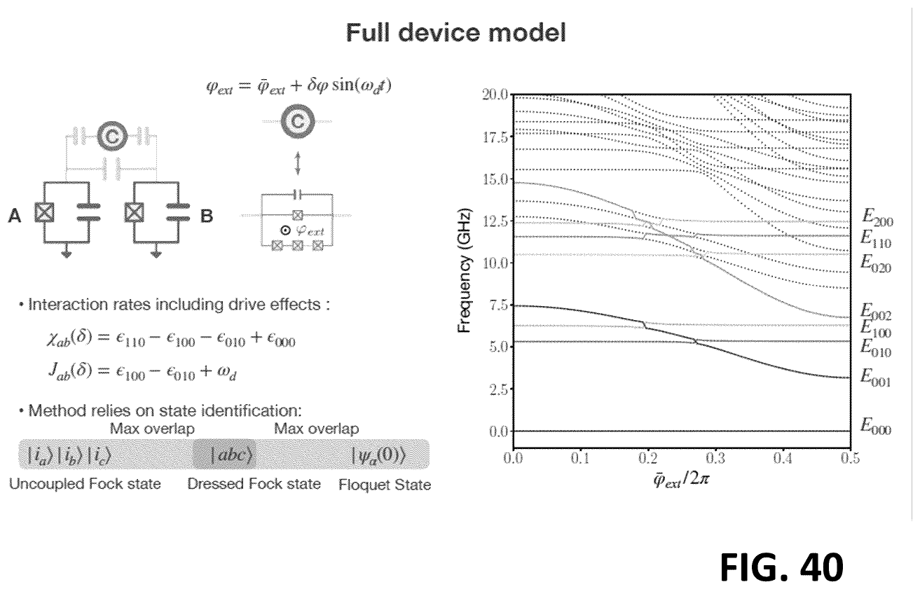

FIG. 40 shows details of a full device model.

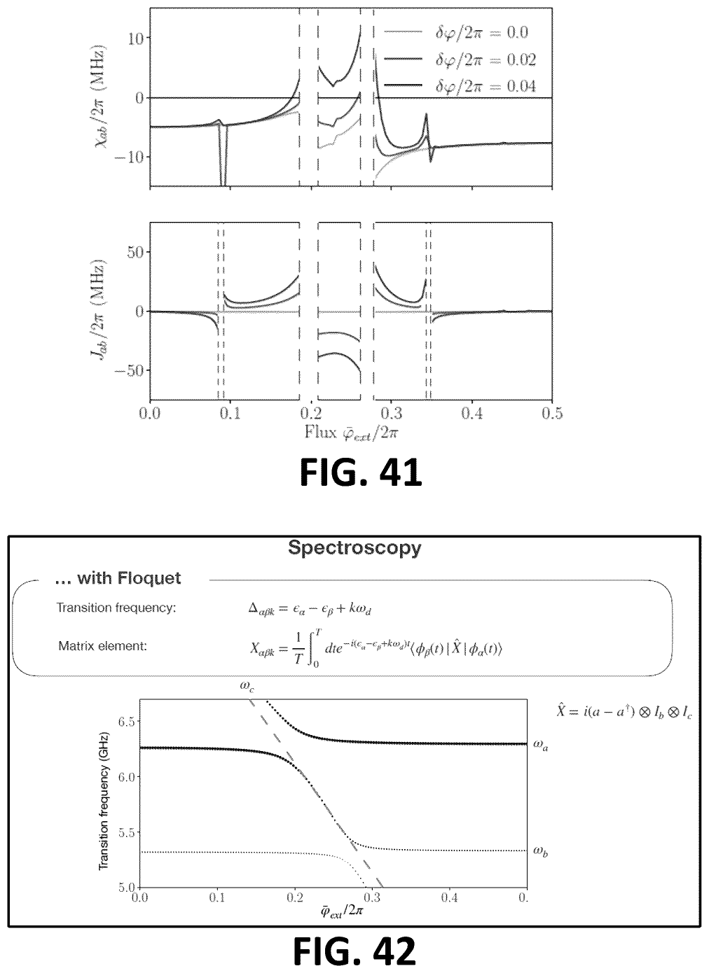

FIG. 41 shows graphs associated to the full device model. The graphs are related to the following equation φₑₓₜ=φ̅ₑₓₜ+δφ sin(ω_{d}t). These show that one cannot track at qubit-coupler resonances (strong hybridization) and also show observation of additional side peaks.

FIG. 42 shows details of Floquet theory and spectroscopy.

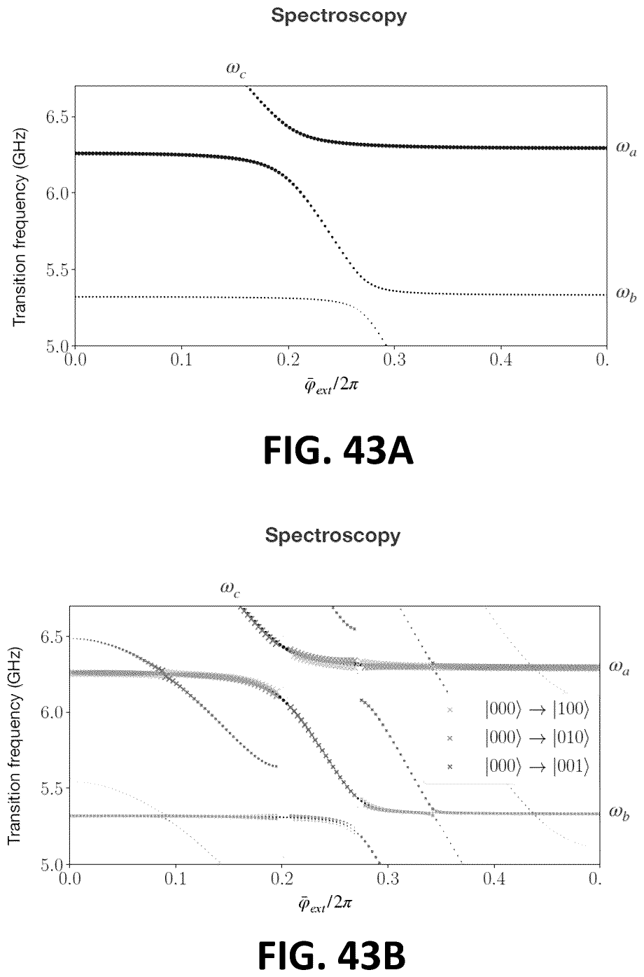

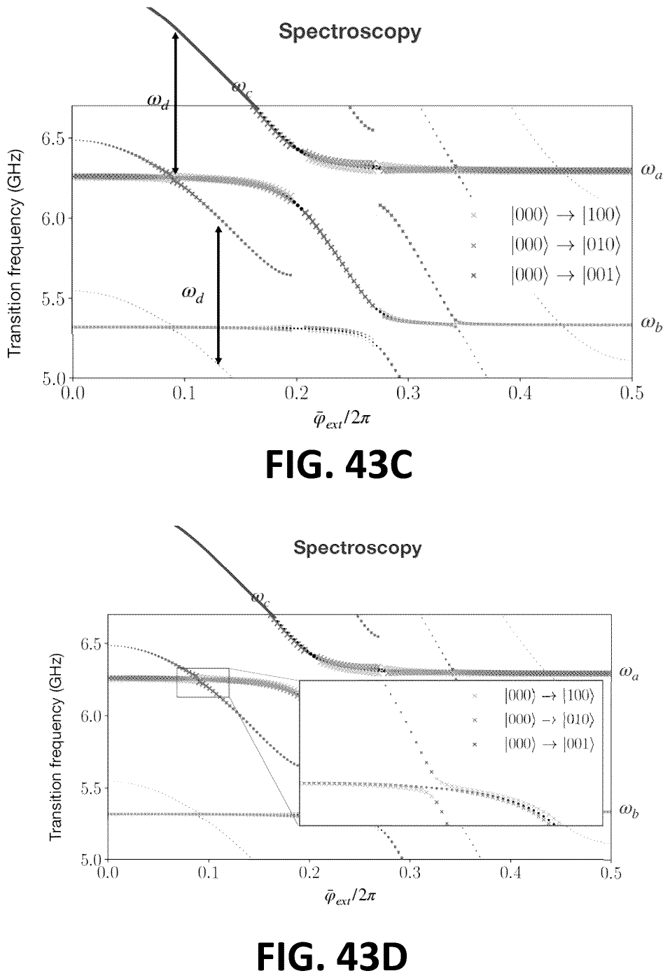

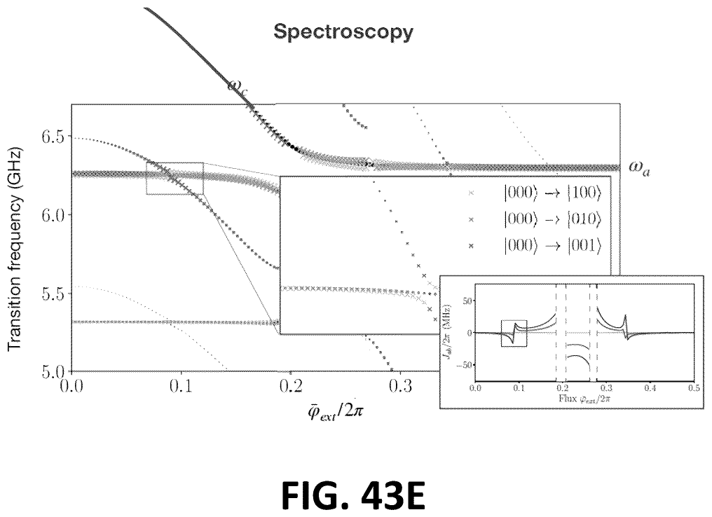

FIGS. 43A-G shows additional spectroscopy information.

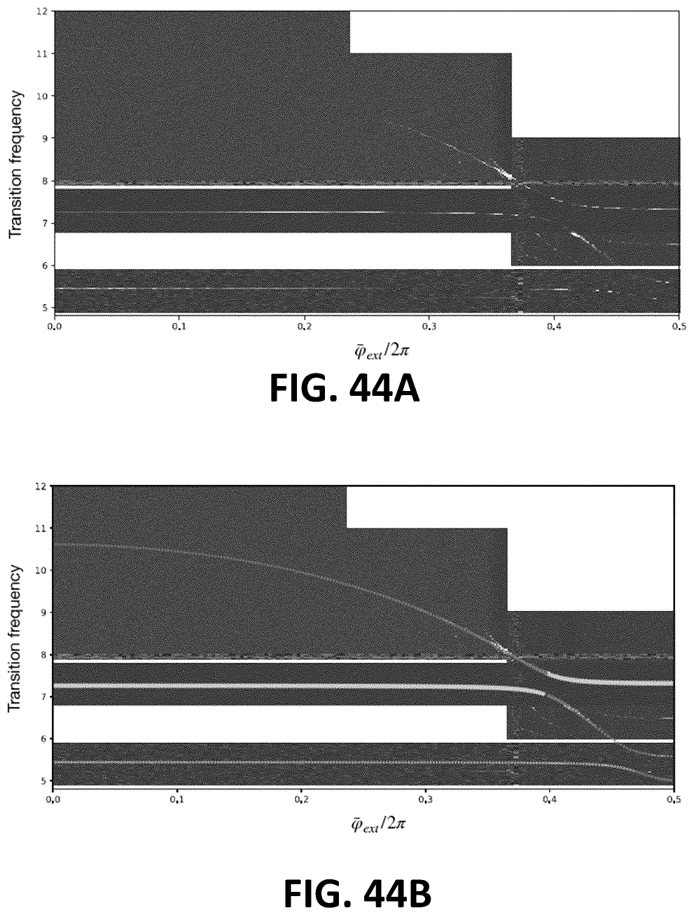

FIGS. 44A-B illustrations additional spectroscopy information. The graphs shows two-tone spectroscopy experiments and learn about dominant transitions and leakage.

This information shows fast extraction of interaction rates using Floquet theory. The approach using Floquet theory captures effects of drive. The approach using Floquet theory can be faster & more precise using Dysolve. The approach using Floquet theory allows for determination of cancellation of static and dynamical ZZ. There is also the possibility of using Floquet spectroscopy to characterize the device

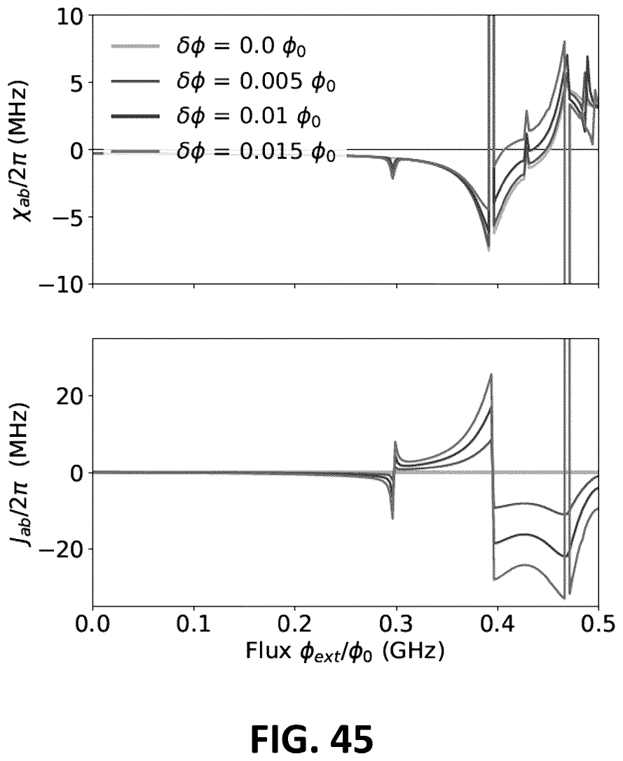

FIG. 45 shows graphs illustrating optical flux value based on a full device model with experimental parameters and without the rotating wave approximation. The interaction rates without drive are as follows:

$$\begin{matrix}{X}_{ab} ( δφ ) = {ϵ}_{110} - {ϵ}_{100} - {ϵ}_{010} + {ϵ}_{000} \\ {J}_{ab} ( δφ ) = {ϵ}_{100} - {ϵ}_{010} + {ω}_{d}\end{matrix}$$

Cancellation of the static (δφ=0) and the dynamical (δφ≠0) ZZ interaction with parametric drive is shown. The gate is run at flux bias where dynamical ZZ is zero. The gate is also run between the qubit frequencies. Experimental results indicate that the coupler can be operated at zero static ZZ. The sqrt(iSWAP) gate indicates t is about 13 ns with F=99.8%.

FIGS. 46A-I illustrate spectator qubit effects. A scenario is shown in which three qubits are coupled using two couplers. A first coupler (C₁) is coupled (e.g., quantumly coupled, capacitively coupled) between a first qubit (Qₐ) and a second qubit (Q_{b}). A second coupler (C₂) is coupled (e.g., quantumly coupled, capacitively coupled) between the second qubit (Q_{b}) and a third qubit (Q_{d}). The first coupler and/or the second coupler may have opposite anharmonicity to the qubits. The first coupler and/or second coupler may have any of the properties of the couplers described elsewhere herein. During idle time the condition to achieve is X_{ab}=X_{bd}=0. One observation is that the operating point of C₁ (s.t. X_{ab}=0) can be shifted depending on C₂. Calibration may be complicated due to this relationship. FIG. 461 shows what happens if iSWAP is activated between A and B.

### Aspects

The disclosure may comprise any combination of at least the following aspects.

Aspect 1. A device comprising:
at least two qubit structures for storing quantum states; and
a coupler having opposite anharmonicity to the at least two qubit structures and configured to couple the at least two qubit structures.

Aspect 2. The device of Aspect 1, wherein opposite anharmonicity comprises coupler having an anharmonicity of an opposite sign than a sign of an anharmonicity of the at least two qubits.

Aspect 3. The device of any one of Aspects 1-2, wherein the coupler comprises a flux tunable parametric coupler.

Aspect 4. The device of any one of Aspects 1-3, wherein the coupler suppresses crosstalk based on controlling one or more of a flux bias or DC flux bias applied to the coupler.

Aspect 5. The device of any one of Aspects 1-4, wherein the coupler is one or more of tunable or tuned to achieve zero ZZ crosstalk or substantially zero ZZ crosstalk between the at least two qubit structures.

Aspect 6. The device of claim 1, wherein the coupler is tuned using a magnetic field to achieve zero ZZ crosstalk or substantially zero ZZ crosstalk.

Aspect 7. The device of any one of Aspects 1-6, wherein the coupler comprises an asymmetric loop having components in a first portion of the asymmetric loop that are asymmetric to components in a second portion of the asymmetric loop opposite the first portion.

Aspect 8. The device of Aspect 7, wherein a ratio between energies of the components of the first portion and energies of the components of the second portion and a relation between the number of components of the first portion and a number of components of the second portion match a condition that enables tuning to achieve zero ZZ crosstalk or substantially zero ZZ crosstalk.

Aspect 9. The device of any one of Aspects 7-8, wherein the asymmetric loop comprises a Superconducting Quantum Interference Device (SQUID) loop and the components comprise Josephson junctions.

Aspect 10. The device of any one of Aspects 1-9, wherein the coupler comprises a first circuit portion electrically in parallel with a second circuit portion, wherein the first circuit portion comprises a first number of Josephson junctions and the second circuit portion comprises a second number of Josephson junctions different from the first number.

Aspect 11. The device of any one of Aspects 1-10, wherein the at least two qubit structures have fixed frequencies.

Aspect 12. The device of any one of Aspects 1-11, wherein the coupler enables gates that are less than 20 ns in duration.

Aspect 13. The device of any one of Aspects 1-12, wherein the at least two qubit structures are detuned from each other in frequency by one or more of: at least about 1 GHz, in a range of about 0.5 GHZ to about 3 GHz, or in a range of about 1 GHz to about 2 GHz.

Aspect 14. The device of any one of Aspects 1-13, wherein the at least two qubit structures enable gates that are less than 20 ns in duration and are detuned from each other in frequency by one or more of: at least about 1 GHz, or in a range of about 1 GHz to about 2 GHz.

Aspect 15. The device of any one of Aspects 1-14, wherein the coupler is controlled by one or more of parametric modulation, modulation, or a time-dependent control protocol to provide gate operations based on quantum entanglement between the at least two qubit structures.

Aspect 16. The device of any one of Aspects 1-15, further comprising a readout cavity and qubits to maximize coherence and minimize state preparation and measurement errors.

Aspect 17. The device of any one of Aspects 1-16, wherein one or more of at least two qubit structures comprise a transmon qubit structure.

Aspect 18. The device of any one of Aspects 1-17, wherein the at least two qubit structures and the coupler are coupled together via mutual capacitive couplings.

Aspect 19. The device of any one of Aspects 1-18, wherein the coupler comprises a capacitively shunted flux qubit.

Aspect 20. The device of any one of Aspects 1-19, further comprising an additional coupler having the opposite anharmonicity to the at least two qubit structures, wherein the at least two qubit structures for storing quantum states comprise a first qubit structure, a second qubit structure, and a third qubit structure.

Aspect 21. The device of Aspect 20, wherein the coupler is coupled between the first qubit structure and the second qubit structure, and wherein the additional coupler is coupled between the second qubit structure and the third qubit structure.

Aspect 22. A system comprising: a plurality of quantum logic gates, wherein at least a portion of the plurality of quantum logic gates comprise the device of any one of claims 1-21.

Aspect 23. A method comprising: tuning, by applying a flux bias, a coupler to suppress ZZ crosstalk between at least two qubit structures, wherein the coupler has opposite anharmonicity to the at least two qubit structures and is configured to couple the at least two qubit structures; and varying in time an external flux applied to the tuned coupler to cause gate operations based on quantum entanglement between the at least two qubit structures.

Aspect 24. The method of Aspect 23, wherein the coupler and the at least two qubit structures comprise the coupler and the at least two qubit structures of any one of claims 1-19.

Aspect 25. The method of any one of Aspects 23-24, wherein the gate operations comprise one or more of iSWAP operations, bSWAP operations, sqrt(iSWAP) operations, sqrt(bSWAP) operations, controlled-Z operations, or CNOT operations.

Aspect 26. The method of any one of Aspects 23-25, further comprising determining one or more modulation parameters, wherein the tuned coupler is modulated based on the one or more modulation parameters.

Aspect 27. The method of Aspect 26, wherein determining the one or more modulation parameters is based on Floquet computations.

Aspect 28. The method of any one of Aspects 26-27, wherein the one or more modulation parameters comprise one or more of drive frequency or drive amplitude.

Aspect 29. The method of any one of Aspects 26-28, wherein the one or more modulation parameters comprise one or more parameters that define a range of operation in which ZZ crosstalk is canceled.

Aspect 30. The method of any one of Aspects 23-29, wherein determining the one or more modulation parameters is based on a full circuit Hamiltonian model.

Aspect 31. The method of any one of Aspects 23-30, wherein varying in time the external flux comprises one or more of modulating, parametrically modulating, or controlling using a protocol the tuned coupler to activate interactions between the at least two qubit structures.

Aspect 32. The method of any one of Aspects 23-31, further comprising determining one or more design parameters for fabricating the coupler.

Aspect 33. The method of Aspect 32, wherein the one or more design parameters comprise a number of junctions to provide in one or more parallel circuit portions of the coupler.

Aspect 34. The method of any one of Aspects 32-33, wherein determining the one or more design parameters comprises minimizing an energy difference between two simulated couplers by varying one or more parameters of at least one of the simulated couplers.

Aspect 35. A device comprising: one or more processors; and a memory storing instructions that, when executed by the one or more processors, cause the device (e.g., and/or the device of any one of Aspects 1-21) to perform the methods of any one of Aspects 23-34.

Aspect 36. A non-transitory computer-readable medium storing instructions that, when executed by one or more processors, cause a device (e.g., a computing device, the device of any one of Aspects 1-21) to perform the methods of any one of Aspects 23-34.

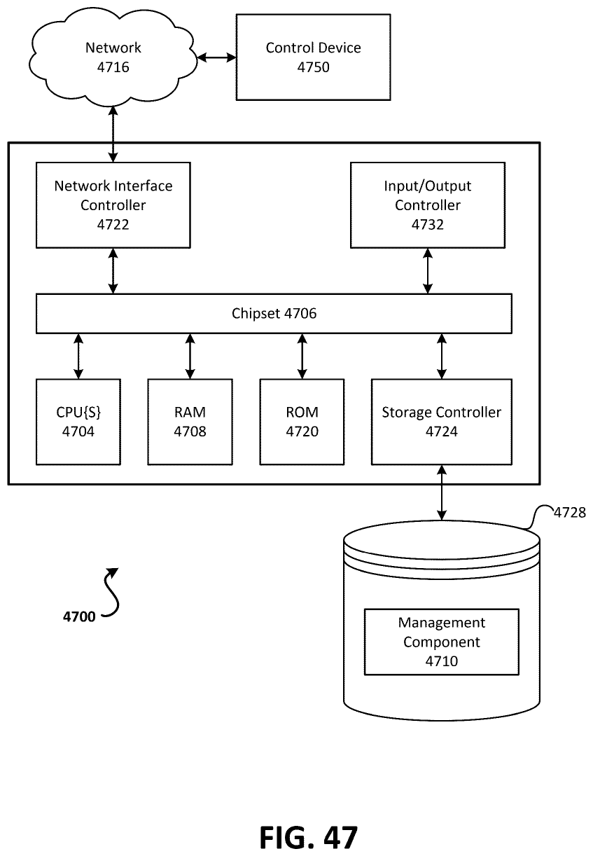

FIG. 47 depicts a computing device that may be used in various aspects, such as the systems and/or devices depicted in FIG. 1A and FIG. 1B. The quantum devices herein may be implemented as a component of the computing device of FIG. 47, such as a component of the CPU 4707, the RAM 4708, the ROM 4720, or a combination thereof. The computing device of FIG. 47 may be used to control a quantum computing device, such as by providing instructions to a control device 4750, to vary magnetic flux applied to the coupler 140 of FIG. 1B, to magnetically bias the coupler 140, or a combination thereof. The computing device of FIG. 47 may be used to determine fabrication/design parameters for the quantum devices disclosed herein. The computer architecture shown in FIG. 47 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 4700 may include a baseboard, or “motherboard,” which is a printed circuit board to which a multitude of components or devices may be connected by way of a system bus or other electrical communication paths. One or more central processing units (CPUs) 4704 may operate in conjunction with a chipset 4706. The CPU(s) 4704 may be standard programmable processors that perform arithmetic and logical operations necessary for the operation of the computing device 4700.

The CPU(s) 4704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 4704 may be augmented with or replaced by other processing units, such as GPU(s) 4705. The GPU(s) 4705 may comprise processing units specialized for but not necessarily limited to highly parallel computations, such as graphics and other visualization-related processing.

A chipset 4706 may provide an interface between the CPU(s) 4704 and the remainder of the components and devices on the baseboard. The chipset 4706 may provide an interface to a random access memory (RAM) 4708 used as the main memory in the computing device 4700. The chipset 4706 may further provide an interface to a computer-readable storage medium, such as a read-only memory (ROM) 4720 or non-volatile RAM (NVRAM) (not shown), for storing basic routines that may help to start up the computing device 4700 and to transfer information between the various components and devices. ROM 4720 or NVRAM may also store other software components necessary for the operation of the computing device 4700 in accordance with the aspects described herein.

The computing device 4700 may operate in a networked environment using logical connections to remote computing nodes and computer systems through local area network (LAN) 4716. The chipset 4706 may include functionality for providing network connectivity through a network interface controller (NIC) 4722, such as a gigabit Ethernet adapter. A NIC 4722 may be capable of connecting the computing device 4700 to other computing nodes over a network 4716. It should be appreciated that multiple NICs 4722 may be present in the computing device 4700, connecting the computing device to other types of networks and remote computer systems.

The computing device 4700 may be connected to a mass storage device 4728 that provides non-volatile storage for the computer. The mass storage device 4728 may store system programs, application programs, other program modules, and data, which have been described in greater detail herein. The mass storage device 4728 may be connected to the computing device 4700 through a storage controller 4724 connected to the chipset 4706. The mass storage device 4728 may consist of one or more physical storage units. A storage controller 4724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 4700 may store data on a mass storage device 4728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 4728 is characterized as primary or secondary storage and the like.

For example, the computing device 4700 may store information to the mass storage device 4728 by issuing instructions through a storage controller 4724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 4700 may further read information from the mass storage device 4728 by detecting the physical states or characteristics of one or more particular locations within the physical storage units.

In addition to the mass storage device 4728 described above, the computing device 4700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 4700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 4728 depicted in FIG. 47, may store an operating system utilized to control the operation of the computing device 4700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 4728 may store other system or application programs and data utilized by the computing device 4700.

The mass storage device 4728 or other computer-readable storage media may also be encoded with computer-executable instructions, which, when loaded into the computing device 4700, transforms the computing device from a general-purpose computing system into a special-purpose computer capable of implementing the aspects described herein. These computer-executable instructions transform the computing device 4700 by specifying how the CPU(s) 4704 transition between states, as described above. The computing device 4700 may have access to computer-readable storage media storing computer-executable instructions, which, when executed by the computing device 4700, may perform the methods described herein.

A computing device, such as the computing device 4700 depicted in FIG. 47, may also include an input/output controller 4732 for receiving and processing input from a number of input devices, such as a keyboard, a mouse, a touchpad, a touch screen, an electronic stylus, or other type of input device. Similarly, an input/output controller 4732 may provide output to a display, such as a computer monitor, a flat-panel display, a digital projector, a printer, a plotter, or other type of output device. It will be appreciated that the computing device 4700 may not include all of the components shown in FIG. 47, may include other components that are not explicitly shown in FIG. 47, or may utilize an architecture completely different than that shown in FIG. 47.

As described herein, a computing device may be a physical computing device, such as the computing device 4700 of FIG. 47. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise. The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions (e.g., computer readable instructions). Additionally, any method, process, algorithm described herein without a flowchart and/or figure may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

### REFERENCES

The following papers discuss crosstalk suppression. These papers use multiple coupling elements that interfere with one another, or direct interactions between two different kinds of qubits, including qubits with opposite anharmonicity. No papers discuss using an opposite anharmonicity device as a coupler.
Zhao et al. PRL 125, 200503 (2020)
Ku et al. PRL 125, 200504 (2020)
Noguchi et al. PRA 102, 062408 (2020)
Zhao et al. PRApplied 14, 064016 (2020)
Krinner et al. PRApplied 14, 044039 (2020)
Collodo et al. PRL 125, 240502 (2020)
Yan et al. PRAppl 10, 054062 (2018)
[1] M. Kjaergaard, M. E. Schwartz, J. Braumuller, P. Krantz, J. I.-J. Wang, S. Gustavsson, and W. D. Oliver, Annual Review of Condensed Matter Physics 11, 369 (2020).
[2] P. Krantz, M. Kjaergaard, F. Yan, T. P. Orlando, S. Gus-tavsson, and W. D. Oliver, Applied Physics Reviews 6, 021318 (2019).
[3] A. Blais, A. L. Grimsmo, S. M. Girvin, and A. Wallraff, Rev. Mod. Phys. 93, 025005 (2021).
[4] R. Versluis, S. Poletto, N. Khammassi, B. Tarasinski, N. Haider, D. J. Michalak, A. Bruno, K. Bertels, and L. DiCarlo, Phys. Rev. Applied 8, 034021 (2017).
[5] F. Arute, K. Arya, R. Babbush, D. Bacon, J. C. Bardin, R. Barends, R. Biswas, S. Boixo, F. G. S. L. Brandao, D. A. Buell, B. Burkett, Y. Chen, Z. Chen, B. Chiaro, R. Collins, W. Courtney, A. Dunsworth, E. Farhi, B. Foxen, A. Fowler, C. Gidney, M. Giustina, R. Graff, K. Guerin, S. Habegger, M. P. Harrigan, M. J. Hartmann, A. Ho, M. Hoffmann, T. Huang, T. S. Humble, S. V. Isakov, E. Jeffrey, Z. Jiang, D. Kafri, K. Kechedzhi, J. Kelly, P. V. Klimov, S. Knysh, A. Korotkov, F. Kostritsa, D. Landhuis, M. Lind-mark, E. Lucero, D. Lyakh, S. Mandri, J. R. McClean, M. McEwen, A. Megrant, X. Mi, K. Michielsen, M. Mohseni, J. Mutus, O. Naaman, M. Neeley, C. Neill, M. Y. Niu, E. Ostby, A. Petukhov, J. C. Platt, C. Quintana, E. G. Rieffel, P. Roushan, N. C. Rubin, D. Sank, K. J. Satzinger, V. Smelyanskiy, K. J. Sung, M. D. Trevithick, A. Vainsencher, B. Villalonga, T. White, Z. J. Yao, P. Yeh, A. Zalcman, H. Neven, and J. M. Martinis, Nature 574, 505 (2019).
[6] A. D. Corcoles, A. Kandala, A. Javadi-Abhari, D. T. Mc-Clure, A. W. Cross, K. Temme, P. D. Nation, M. Steffen, and J. M. Gambetta, Proceedings of the IEEE 108, 1338 (2020).
[7] D. Gottesman, arXiv preprint quant-ph/9705052 (1997).
[8] D. Aharonov and M. Ben-Or, SIAM J. Comput. 38, 1207 (2008).
[9] P. Mundada, G. Zhang, T. Hazard, and A. Houck, Phys. Rev. Applied 12, 054023 (2019).
[10] J. Ku, X. Xu, M. Brink, D. C. McKay, J. B. Hertzberg, M. H. Ansari, and B. L. T. Plourde, Phys. Rev. Lett. 125, 200504 (2020).
[11] Y. Sung, L. Ding, J. Braum\ddot{ } uller, A. Veps\ddot{ } al\ddot{ } ainen, B. Kan-nan, M. Kjaergaard, A. Greene, G. O. Samach, C. McNally, D. Kim, A. Melville, B. M. Niedzielski, M. E. Schwartz, J. L. Yoder, T. P. Orlando, S. Gustavsson, and W. D. Oliver, “Realization of high-fidelity cz and zz-free iswap gates with a tunable coupler,” (2020), arXiv:2011.01261 [quant-ph].
[12] A. Noguchi, A. Osada, S. Masuda, S. Kono, K. Heya, S. P. Wolski, H. Takahashi, T. Sugiyama, D. Lachance-Quirion, and Y. Nakamura, “Fast parametric two-qubit gates with suppressed residual interaction using a parity-violated superconducting qubit,” (2020), arXiv:2005.02630 [quant-ph].
[13] A. Kandala, K. X. Wei, S. Srinivasan, E. Magesan, S. Camevale, G. A. Keefe, D. Klaus, O. Dial, and D. C. McKay, “Demonstration of a high-fidelity cnot for fixed-frequency transmons with engineered zz suppression,” (2020), arXiv:2011.07050 [quant-ph].
[14] P. Zhao, D. Lan, P. Xu, G. Xue, M. Blank, X. Tan, H. Yu, and Y. Yu, “Suppression of static zz interaction in an all-transmon quantum processor,” (2020), arXiv:2011.03976 [quant-ph].
[15] C. Berke, E. Varvelis, S. Trebst, A. Altland, and D. P. DiVincenzo, “Transmon platform for quantum computing challenged by chaotic fluctuations,” (2020), arXiv:2012.05923 [quant-ph].
[16] D. C. McKay, S. Filipp, A. Mezzacapo, E. Magesan, J. M. Chow, and J. M. Gambetta, Phys. Rev. Applied 6, 064007 (2016).
[17] M. C. Collodo, J. Herrmann, N. Lacroix, C. K. Andersen,
A. Remm, S. Lazar, J.-C. Besse, T. Walter, A. Wall-raff, and C. Eichler, “Implementation of conditional-phase gates based on tunable zz-interactions,” (2020), arXiv:2005.08863 [quant-ph].
[18] J. H. Shirley, Phys. Rev. 138, B979 (1965).
[19] H. Sambe, Phys. Rev. A 7, 2203 (1973).
[20] M. Grifoni and P. H\ddot{ } anggi, Physics Reports 304, 229 (1998).
[21] S. E. Nigg, H. Paik, B. Vlastakis, G. Kirchmair, S. Shankar, L. Frunzio, M. H. Devoret, R. J. Schoelkopf, and S. M. Girvin, Physical Review Letters 108 (2012), 10.1103/physrevlett.108.240502.
[22] Z. K. Minev, Z. Leghtas, S. O. Mundhada, L. Christakis, I. M. Pop, and M. H. Devoret, “Energy participation quantization of josephson circuits,” (2020), arXiv:2010.00620 [quant-ph].
[23] L. Verney, R. Lescanne, M. H. Devoret, Z. Leghtas, andM. Mirrahimi, Phys. Rev. Applied 11, 024003 (2019).
[24] A. Petrescu, B. Royer, and A. Blais, in preparation.
[25] L. S. Theis and F. K. Wilhelm, Physical Review A 95 (2017), 10.1103/physreva.95.022314.
[26] A. Petrescu, M. Malekakhlagh, and H. E. T\ddot{ } ureci, Physical Review B 101 (2020), 10.1103/physrevb.101.134510.
[27] M. Malekakhlagh, E. Magesan, and D. C. McKay, Physical Review A 102 (2020), 10.1103/physreva.102.042605.
[28] M. Malekakhlagh, A. Petrescu, and H. E. Tureci, Physical Review B 101 (2020), 10.1103/physrevb.101.134509.
[29] J. Koch, T. M. Yu, J. Gambetta, A. A. Houck, D. I. Schuster, J. Majer, A. Blais, M. H. Devoret, S. M. Girvin, and R. J. Schoelkopf, Phys. Rev. A 76, 042319 (2007).
[30] C. Rigetti and M. Devoret, Physical Review B 81, 134507 (2010).
[31] J. M. Chow, A. D. C'orcoles, J. M. Gambetta, C. Rigetti, B. R. Johnson, J. A. Smolin, J. R. Rozen, G. A. Keefe, M. B. Rothwell, M. B. Ketchen, and M. Steffen, Phys. Rev. Lett. 107, 080502 (2011).
[32] S. Sheldon, E. Magesan, J. M. Chow, and J. M. Gambetta, Physical Review A 93 (2016), 10.1103/phys-reva.93.060302.
[33] Y. Zhang, B. J. Lester, Y. Y. Gao, L. Jiang, R. J. Schoelkopf, and S. M. Girvin, Phys. Rev. A 99, 012314 (2019).
[34] S. Krinner, P. Kurpiers, B. Royer, P. Magnard, I. Tsitsilin, J. C. Besse, A. Remm, A. Blais, and A. Wall-raff, “Demonstration of an all-microwave controlled phase gate between far detuned qubits,” (2020), arXiv:2006.10639 [quant-ph].
[35] P. S. Mundada, A. Gyenis, Z. Huang, J. Koch, and A. A. Houck, Phys. Rev. Applied 14, 054033 (2020).
[36] Z. Huang, P. S. Mundada, A. Gyenis, D. I. Schuster, A. A. Houck, and J. Koch, Phys. Rev. Applied 15, 034065 (2021).
[37] J. Q. You, X. Hu, S. Ashhab, and F. Nori, Phys. Rev. B 75, 140515 (2007).
[38] M. Steffen, F. Brito, D. DiVincenzo, M. Farinelli, G. Keefe, M. Ketchen, S. Kumar, F. Milliken, M. B. Rothwell, J. Rozen, and R. H. Koch, Journal of Physics: Condensed Matter 22, 053201 (2010).
[39] F. Yan, S. Gustavsson, A. Kamal, J. Birenbaum, A. P. Sears, D. Hover, T. J. Gudmundsen, D. Rosenberg, G. Samach, S. Weber, J. L. Yoder, T. P. Orlando, J. Clarke, A. J. Kerman, and W. D. Oliver, Nature Communications 7, 12964 (2016).
[40] X. Xu and M. H. Ansari, “Zz freedom in two qubit gates,” (2020), arXiv:2009.00485 [quant-ph].
[41] P. Zhao, P. Xu, D. Lan, X. Tan, H. Yu, and Y. Yu, Phys. Rev. Applied 14, 064016 (2020).
[42] S. Reynaud, E. Giacobino, and J. Zinn-Justin, eds., Fluctuations quantiques: Les Houches, Session LXIII, 27 juin-28 juillet 1995 (Elsevier Amsterdam, New York, https://www.worldcat.org/title/fluctuations-quantiques-les-houches-session-lxiii-27-juin-28-juillet-1995-quantum-fluctuations/oclc/36407840, 1997).
[43] U. Vool and M. Devoret, International Journal of Circuit Theory and Applications 45, 897 (2017).
[44] X. You, J. A. Sauls, and J. Koch, Phys. Rev. B 99, 174512 (2019).
[45] M. Mirrahimi and P. Rouchon, (2015).
[46] N. Goldman and J. Dalibard, Phys. Rev. X 4, 031027 (2014).
[47] S. Krinner, S. Lazar, A. Remm, C. Andersen, N. Lacroix, G. Norris, C. Hellings, M. Gabureac, C. Eichler, and A. Wallraff, Phys. Rev. Applied 14, 024042 (2020).
[48] E. A. Sete, A. Q. Chen, R. Manenti, S. Kulshreshtha, and S. Poletto, “Floating tunable coupler for scalable quantum computing architectures,” (2021), arXiv:2103.07030 [quant-ph].
[49] M. Abramowitz and I. A. Stegun, Handbook of mathematical functions: with formulas, graphs, and mathematical tables, Vol. 55 (Courier Corporation, 1964).
[50] R. Zitko, Computer Physics Communications 182, 2259 (2011).
[51] P. Bertet, C. J. P. M. Harmans, and J. E. Mooij, Phys. Rev. B 73, 064512 (2006).
[52] A. O. Niskanen, Y. Nakamura, and J.-S. Tsai, Phys. Rev. B 73, 094506 (2006).
[53] A. Niskanen, K. Harrabi, F. Yoshihara, Y. Nakamura, S. Lloyd, and J. S. Tsai, Science 316, 723 (2007).
[54] F. Beaudoin, M. P. da Silva, Z. Dutton, and A. Blais, Phys. Rev. A 86, 022305 (2012).
[55] M. Reagor, C. B. Osborn, N. Tezak, A. Staley, G. Prawiroatmodjo, M. Scheer, N. Alidoust, E. A. Sete, N. Didier, M. P. da Silva, and et al., Science Advances 4, eaao3603 (2018).
[56] S. A. Caldwell, N. Didier, C. A. Ryan, E. A. Sete, A. Hudson, P. Karalekas, R. Manenti, M. P. da Silva, R. Sinclair, E. Acala, N. Alidoust, J. Angeles, A. Bestwick, M. Block, B. Bloom, A. Bradley, C. Bui, L. Capelluto, R. Chilcott, J. Cordova, G. Crossman, M. Curtis, S. Deshpande, T. E. Bouayadi, D. Girshovich, S. Hong, K. Kuang, M. Lenihan, T. Manning, A. Marchenkov, J. Marshall, R. Maydra, Y. Mohan, W. O'Brien, C. Osborn, J. Ot-terbach, A. Papageorge, J.-P. Paquette, M. Pelstring, A. Polloreno, G. Prawiroatmodjo, V. Rawat, M. Reagor, R. Renzas, N. Rubin, D. Russell, M. Rust, D. Scarabelli, M. Scheer, M. Selvanayagam, R. Smith, A. Staley, M. Suska, N. Tezak, D. C. Thompson, T.-W. To, M. Vahidpour, N. Vodrahalli, T. Whyland, K. Yadav, W. Zeng, and C. Rigetti, Phys. Rev. Applied 10, 034050 (2018).
[57] N. Didier, E. A. Sete, M. P. da Silva, and C. Rigetti, Phys. Rev. A 97, 022330 (2018).
[58] Pranav S. Mundada, Sara Sussman et al., in preparation (2021).
[59] D. Marcos, P. Rabl, E. Rico, and P. Zoller, Phys. Rev. Lett. 111, 110504 (2013).
[60] J. Johansson, P. Nation, and F. Nori, Computer Physics Communications 184, 1234 (2013).
[61] https://github.com/qutip/qutip/pull/1248 (2020).
[62] R. Shillito, J. A. Gross, A. D. Paolo, E. Genois, and A. Blais, “Fast and differentiable simulation of driven quantum systems,” (2020), arXiv:2012.09282 [quant-ph].

1. A device comprising:
at least two qubit structures for storing quantum states; and
a coupler having opposite anharmonicity to the at least two qubit structures and configured to couple the at least two qubit structures.

2. (canceled)

3. The device of claim 1, wherein the coupler comprises a flux tunable parametric coupler.

4. (canceled)

5. (canceled)

6. The device of claim 1, wherein the coupler is tuned using a magnetic field to achieve zero ZZ crosstalk or substantially zero ZZ crosstalk.

7. The device of claim 1, wherein the coupler comprises an asymmetric loop having components in a first portion of the asymmetric loop that are asymmetric to components in a second portion of the asymmetric loop opposite the first portion, wherein the coupler comprises a shunting capacitor in parallel with the asymmetric loop.

8. The device of claim 7, wherein a ratio between energies of the components of the first portion and energies of the components of the second portion and a relation between the number of components of the first portion and a number of components of the second portion match a condition that enables tuning to achieve zero ZZ crosstalk or substantially zero ZZ crosstalk.

9. The device of claim 7, wherein the asymmetric loop comprises a Superconducting Quantum Interference Device (SQUID) loop and the components comprise Josephson junctions.

10. The device of claim 1, wherein the coupler comprises a first circuit portion electrically in parallel with a second circuit portion, wherein the first circuit portion comprises a first number of Josephson junctions and the second circuit portion comprises a second number of Josephson junctions different from the first number.

11. (canceled)

12. The device of claim 1, wherein the coupler enables gates that are less than 20 ns in duration.

13. The device of claim 1, wherein the at least two qubit structures are detuned from each other in frequency by one or more of: at least about 1 GHz, in a range of about 0.5 GHZ to about 3 GHz, or in a range of about 1 GHz to about 2 GHz.

14. (canceled)

15. The device of claim 1, wherein the coupler is controlled by one or more of parametric modulation, modulation, or a time-dependent control protocol to provide gate operations based on quantum entanglement between the at least two qubit structures.

16. (canceled)

17. The device of claim 1, wherein one or more of at least two qubit structures comprise a transmon qubit structure.

18. The device of claim 1, wherein the at least two qubit structures and the coupler are coupled together via mutual capacitive couplings.

19. (canceled)

20. The device of claim 1, further comprising an additional coupler having the opposite anharmonicity to the at least two qubit structures, wherein the at least two qubit structures for storing quantum states comprise a first qubit structure, a second qubit structure, and a third qubit structure.

21. The device of claim 20, wherein the coupler is coupled between the first qubit structure and the second qubit structure, and wherein the additional coupler is coupled between the second qubit structure and the third qubit structure.

22. A system comprising:
a plurality of quantum logic gates, wherein at least a portion of the plurality of quantum logic gates comprise:
at least two qubit structures for storing quantum states; and
a coupler having opposite anharmonicity to the at least two qubit structures and configured to couple the at least two qubit structures.

23. A method comprising:
tuning, by applying a flux bias, a coupler to suppress ZZ crosstalk between at least two qubit structures, wherein the coupler has opposite anharmonicity to the at least two qubit structures and is configured to couple the at least two qubit structures; and
varying in time an external flux applied to the tuned coupler to cause gate operations based on quantum entanglement between the at least two qubit structures.

24. (canceled)

25. (canceled)

26. The method of claim 23, further comprising determining one or more modulation parameters, wherein the tuned coupler is modulated based on the one or more modulation parameters, wherein the one or more modulation parameters comprise one or more of drive frequency or drive amplitude.

27. (canceled)

28. (canceled)

29. The method of claim 26, wherein determining the one or more modulation parameters is based on a full circuit Hamiltonian model.

30. The method of claim 23, wherein varying in time the external flux comprises one or more of modulating, parametrically modulating, or controlling using a protocol the tuned coupler to activate interactions between the at least two qubit structures.

31. The method of claim 23, further comprising determining one or more design parameters for fabricating the coupler, wherein the one or more design parameters comprise a number of junctions to provide in one or more parallel circuit portions of the coupler.

32-35. (canceled)
